(19) United States
(12) Patent Application Publication
(10) Pub. No.: US 2022/0140878 A1
(43) Pub. Date: May 5, 2022

(54) METHOD AND APPARATUS FOR BEAM MEASUREMENT AND REPORTING IN A WIRELESS COMMUNICATION SYSTEM

(71) Applicant: Samsung Electronics Co., Ltd., Suwon-si (KR)

(72) Inventors: Dalin Zhu, Richardson, TX (US); Md. Saifur Rahman, Plano, TX (US); Emad N. Farag, Flanders, NJ (US); Eko Onggosanusi, Coppell, TX (US)

(21) Appl. No.: 17/452,981

(22) Filed: Oct. 29, 2021

Related U.S. Application Data
(60) Provisional application No. 63/108,723, filed on Nov. 2, 2020.
(60) Provisional application No. 63/117,276, filed on Nov. 23, 2020.
(60) Provisional application No. 63/138,224, filed on Jan. 15, 2021.
(60) Provisional application No. 63/169,444, filed on Apr. 1, 2021.
(60) Provisional application No. 63/271,569, filed on Oct. 25, 2021.

(51) Int. Cl. H04B 7/06; H04L 5/00

(52) U.S. Cl. CPC H04B 7/0626; H04B 7/0617; H04L 5/0048

(57) ABSTRACT

Methods and apparatuses for beam measurement and reporting in a wireless communication system. A method for operating a UE includes receiving a parameter indicating whether to report a group of two resource indicators in a same reporting instance, receiving a first set of reference signals (RSs) through a first set of RS resources for determining a first of the two resource indicators, and receiving a second set of RSs through a second set of RS resources for determining a second of the two resource indicators. The method further includes measuring at least one RS in the first and second sets of RSs, determining, based on the measured at least one RS in the first and second sets of RSs, the first and second resource indicators, respectively, and transmitting, in the same reporting instance, the group of two resource indicators including the determined first and second resource indicators.

### CROSS-REFERENCE TO RELATED APPLICATIONS AND CLAIM OF PRIORITY

The present application claims priority to U.S. Provisional Patent Application No. 63/108,723, filed on Nov. 2, 2020; U.S. Provisional Patent Application No. 63/117,276, filed on Nov. 23, 2020; U.S. Provisional Patent Application No. 63/138,224, filed on Jan. 15, 2021; U.S. Provisional Patent Application No. 63/169,444, filed on Apr. 1, 2021; and U.S. Provisional Patent Application No. 63/271,569, filed on Oct. 25, 2021. The contents of the above-identified patent applications are incorporated herein by reference.

### TECHNICAL FIELD

The present disclosure relates generally to wireless communication systems and, more specifically, the present disclosure relates to a beam measurement and reporting in a wireless communication system.

### BACKGROUND

5th generation (5G) or new radio (NR) mobile communications is recently gathering increased momentum with the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a beam measurement and reporting in a wireless communication system.

In one embodiment, a user equipment (UE) is provided. The UE includes a transceiver configured to receive a parameter indicating whether to report a group of two resource indicators in a same reporting instance, receive a first set of reference signals (RSs) through a first set of RS resources for determining a first of the two resource indicators, and receive a second set of RSs through a second set of RS resources for determining a second of the two resource indicators. The UE further includes a processor operably coupled to the transceiver. The processor is configured to measure at least one RS in the first and second sets of RSs and determine, based on the measured at least one RS in the first and second sets of RSs, the first and second resource indicators, respectively. The transceiver is further configured to transmit, in the same reporting instance, the group of two resource indicators including the determined first and second resource indicators. The first and second sets of RSs are a synchronization signal blocks (SSBs) or non-zero power channel state information RSs (NZP CSI-RSs). The first and second resource indicators are SSB resource indicators (SSBRIs) or CSI-RS resource indicators (CRIs).

In another embodiment, a base station (BS) is provided. The BS includes a transceiver configured to transmit a parameter indicating whether to report a group of two resource indicators in a same reporting instance, transmit a first set of RSs through a first set of RS resources for determination of a first of the two resource indicators or a second set of RSs through a second set of RS resources for determination of a second of the two resource indicators, and receive, in the same reporting instance, the group of two resource indicators including the first and second resource indicators. The first and second sets of RSs are a SSBs or NZP CSI-RSs. The first and second resource indicators are SSBRIs or CRIs.

In yet another embodiment, a method for operating a UE is provided. The method includes receiving a parameter indicating whether to report a group of two resource indicators in a same reporting instance, receiving a first set of RSs through a first set of RS resources for determining a first of the two resource indicators, and receiving a second set of RSs through a second set of RS resources for determining a second of the two resource indicators. The method further includes measuring at least one RS in the first and second sets of RSs, determining, based on the measured at least one RS in the first and second sets of RSs, the first and second resource indicators, respectively, and transmitting, in the same reporting instance, the group of two resource indicators including the determined first and second resource indicators. The first and second sets of RSs are a SSBs or NZP CSI-RSs. The first and second resource indicators are SSBRIs or CRIs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to this disclosure;

FIG. 6A illustrate an example wireless system beam according to embodiments of the present disclosure;

FIG. 6B illustrate an example multi-beam operation according to embodiments of the present disclosure;

FIG. 7 illustrate an example antenna structure according to embodiments of the present disclosure;

FIG. 8 illustrates an example two-stage beam acquisition and refinement according to embodiments of the present disclosure;

FIG. 9 illustrates an example spatial relationship between first-stage SSB resources/beams and second-stage CSI-RS resources/beams according to embodiments of the present disclosure;

FIG. 10 illustrates a flowchart of a method for UE procedure according to embodiments of the present disclosure;

FIG. 11 illustrates another flowchart of a method for UE procedure according to embodiments of the present disclosure;

FIG. 12 illustrates an example beam measurement according to embodiments of the present disclosure;

FIG. 13 illustrates an example multi-RX beam sweeping and measurement according to embodiments of the present disclosure;

FIG. 14 illustrates an example multi-TRP system according to embodiments of the present disclosure;

FIG. 15A illustrates an example bitmap indication for candidate RS resources selection according to embodiments of the present disclosure;

FIG. 15B illustrates an example configuring candidate groups/pairs of channel measurement resources (CMRs) according to embodiments of the present disclosure;

FIG. 16 illustrates a signaling flow between a UE and gNB for beam measurement and reporting according to embodiments of the present disclosure;

FIG. 17 illustrates an example beam measurement using different RX panels according to embodiments of the present disclosure;

FIG. 18 illustrates a signaling flow between a UE and gNB for reporting RX panel condition according to embodiments of the present disclosure;

FIG. 19 illustrates a signaling flow between a UE and gNB for indicating a group of RS resources according to embodiments of the present disclosure;

FIG. 20 illustrates an example beam measurement using two RX panels according to embodiments of the present disclosure;

FIG. 21 illustrates a signaling flow between a UE and gNB for indicating one or more beam reporting formats according to embodiments of the present disclosure;

FIG. 22 illustrates an example beam measurement and reporting according to embodiments of the present disclosure;

FIG. 23 illustrates another example beam measurement and reporting according to embodiments of the present disclosure; and

FIG. 24 illustrates a signaling flow between a UE and gNB for indicating one or more beam reporting formats according to embodiments of the present disclosure.

### DETAILED DESCRIPTION

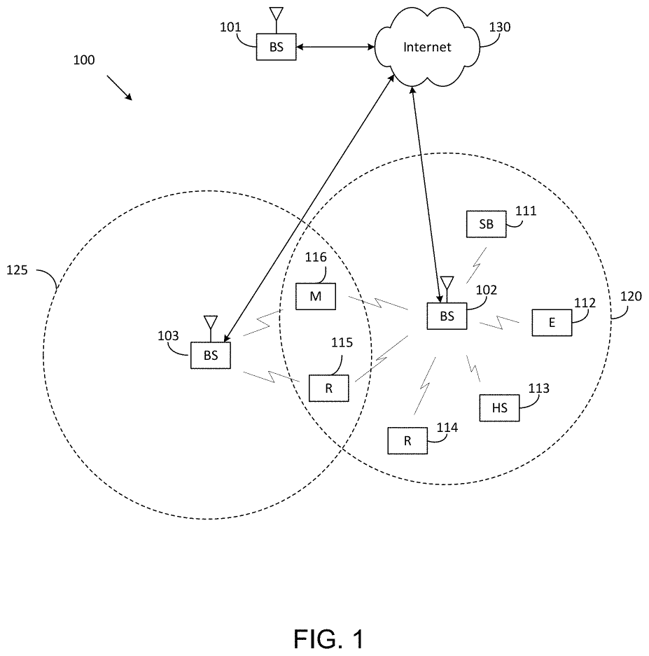

FIG. 1 through FIG. 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a beam measurement and reporting in a wireless communication system. In certain embodiments, and one or more of the gNBs 101-103 includes circuitry, programing, or a combination thereof, for providing for beam measurement and receiving beam measurement reporting in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

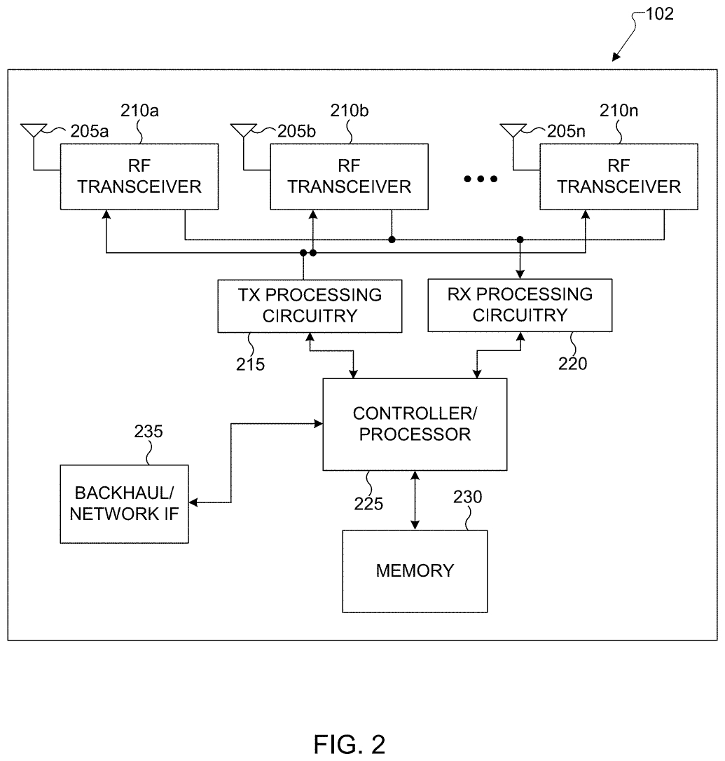

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

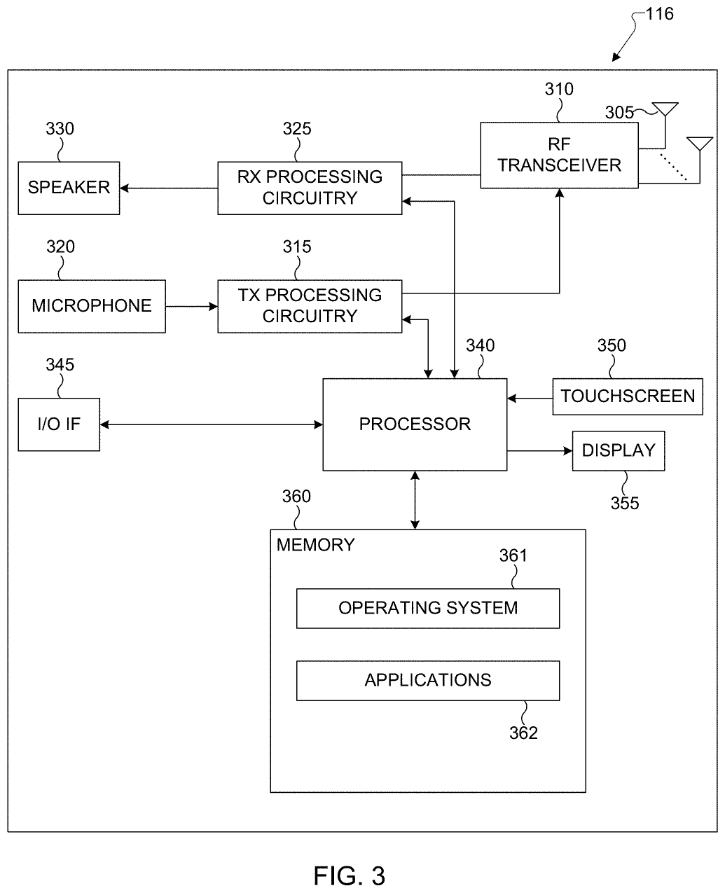

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for a beam measurement and reporting in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 15 KHz or 30 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

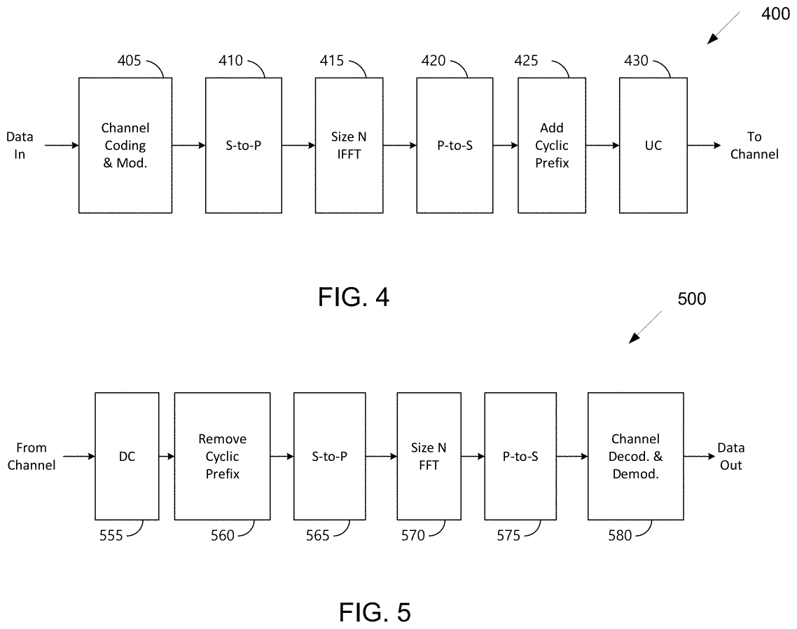

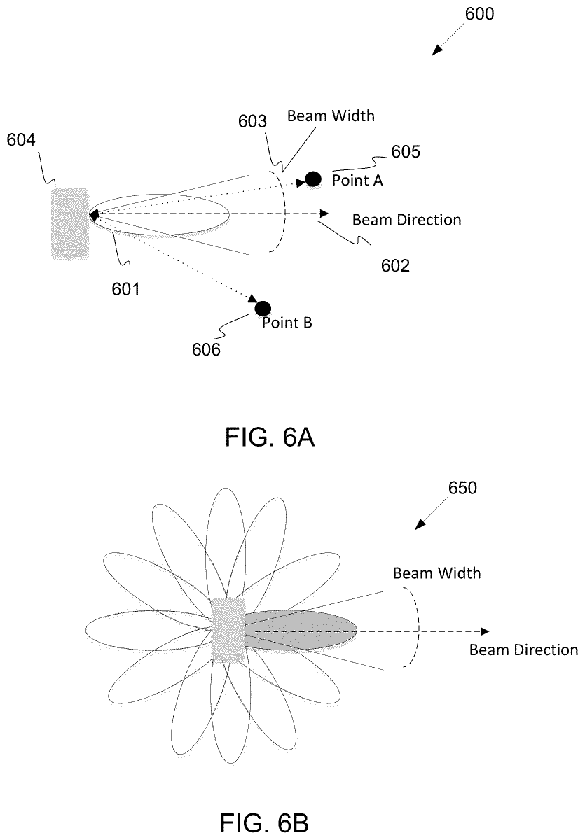

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

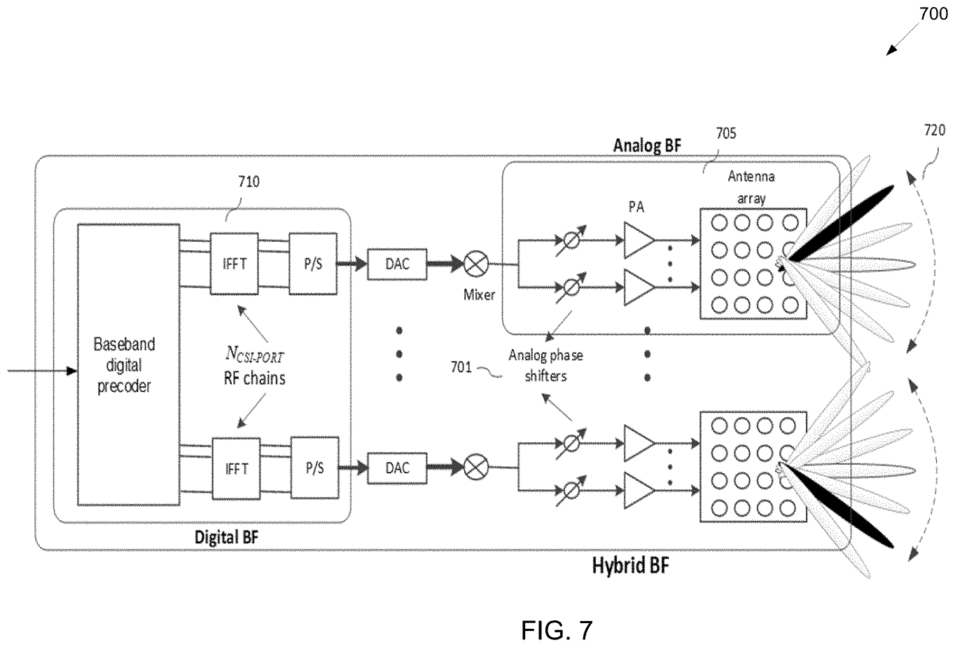

FIG. 6A illustrate an example wireless system beam 600 according to embodiments of the present disclosure. An embodiment of the wireless system beam 600 shown in FIG. 6A is for illustration only.

As illustrated in FIG. 6A, in a wireless system a beam 601, for a device 604, can be characterized by a beam direction 602 and a beam width 603. For example, a device 604 with a transmitter transmits radio frequency (RF) energy in a beam direction and within a beam width. The device 604 with a receiver receives RF energy coming towards the device in a beam direction and within a beam width. As illustrated in FIG. 6A, a device at point A 605 can receive from and transmit to the device 604 as Point A is within a beam width of a beam traveling in a beam direction and coming from the device 604.

As illustrated in FIG. 6A, a device at point B 606 cannot receive from and transmit to the device 604 as Point B is outside a beam width of a beam traveling in a beam direction and coming from the device 604. While FIG. 6A, for illustrative purposes, shows a beam in 2-dimensions (2D), it may be apparent to those skilled in the art, that a beam can be in 3-dimensions (3D), where the beam direction and beam width are defined in space.

FIG. 6B illustrate an example multi-beam operation 650 according to embodiments of the present disclosure. An embodiment of the multi-beam operation 650 shown in FIG. 6B is for illustration only.

In a wireless system, a device can transmit and/or receive on multiple beams. This is known as “multi-beam operation” and is illustrated in FIG. 6B. While FIG. 6B, for illustrative purposes, is in 2D, it may be apparent to those skilled in the art, that a beam can be 3D, where a beam can be transmitted to or received from any direction in space.

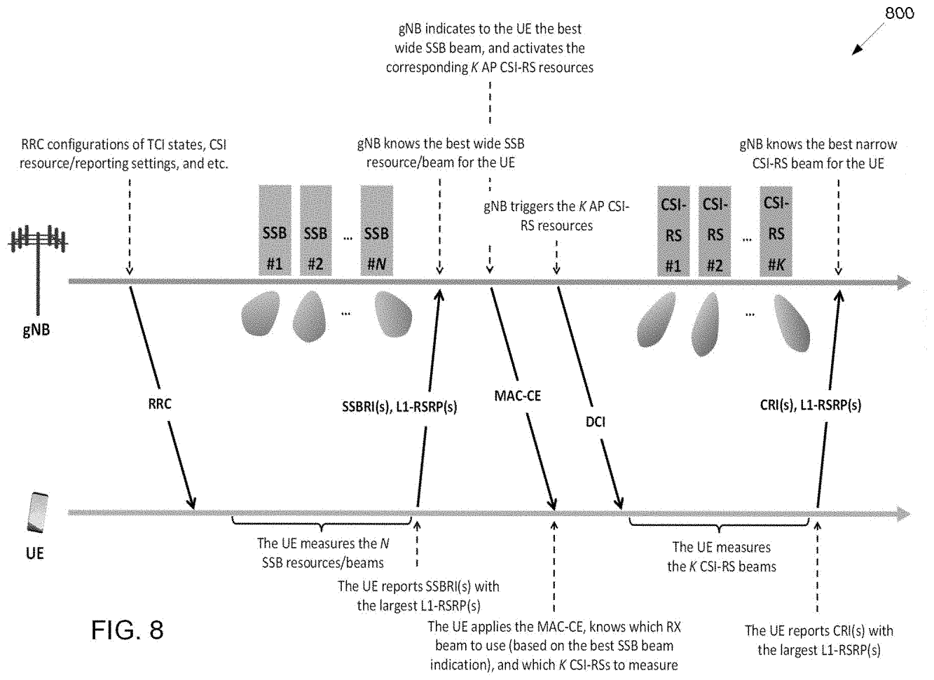

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 7.

FIG. 7 illustrate an example antenna structure 700 according to embodiments of the present disclosure. An embodiment of the antenna structure 700 shown in FIG. 7 is for illustration only.

In this case, one CSI-RS port is mapped onto a large number of antenna elements which can be controlled by a bank of analog phase shifters 701. One CSI-RS port can then correspond to one sub-array which produces a narrow analog beam through analog beamforming 705. This analog beam can be configured to sweep across a wider range of angles 720 by varying the phase shifter bank across symbols or subframes. The number of sub-arrays (equal to the number of RF chains) is the same as the number of CSI-RS ports N_{CSI-PORT}. A digital beamforming unit 710 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The aforementioned system is also applicable to higher frequency bands such as >52.6 GHz (also termed the FR4). In this case, the system can employ only analog beams. Due to the O2 absorption loss around 60 GHz frequency (˜10 dB additional loss @ 100 m distance), larger number of and sharper analog beams (hence larger number of radiators in the array) may be needed to compensate for the additional path loss.

At millimeter-wave (mmWave) frequencies, or FR2 in the 3GPP 5G NR, one or more analog TX-RX beam pair links (BPLs) could be established between the gNB and the UE to transmit/receive the data/control information. To ensure sufficiently good BPL quality, an exhaustive search of all combinations of TX-RX beams could be performed (also referred to as one-stage beam acquisition design), from which the best TX-RX beam pair(s) could be determined. A large amount of TX-RX beam sweeping/scanning is required though, which could be a source of large overhead.

To reduce the beam acquisition latency and overhead, a two-stage beam acquisition and refinement procedure could be adopted. At the first stage, the UE is configured by the network a set of SSB resources/beams. The UE measures the SSB resources/beams and reports the SSBRI(s) with the highest received signal qualities/beam metrics, e.g., L1-RSRP(s), to the gNB. At the second stage, the UE is configured by the network a set of CSI-RS resources/beams. The UE measures the CSI-RS resources/beams and reports the CRI(s) with the highest received signal qualities/beam metrics, e.g., L1-RSRP(s), to the gNB. In contrast to the one-stage beam acquisition design, the two-stage approach could facilitate the overall beam acquisition process. To better trade off the beam acquisition latency/overhead and beam acquisition accuracy, enhancements on the two-stage beam acquisition and refinement process along with the beam measurement and reporting configurations are needed.

In the 5G NR and future-generation wireless systems, a UE could simultaneously receive more than one PDSCHs from multiple transmission-reception points (TRPs) in a multi-TRP system. Specifically, in the multi-TRP system, different TRPs could be placed at different locations (i.e., physically non-co-located) and connected through ideal/non-ideal backhauls. Each TRP can include at least one antenna panel comprising of multiple antenna elements/ports. In this disclosure, a TRP can represent a collection of measurement antenna ports, measurement RS resources and/or control resource sets (CORESETs). For example, a TRP could be associated with one or more of: (i) a plurality of CSI-RS resources; (ii) a plurality of CRIs (CSI-RS resource indices/indicators); (iii) a measurement RS resource set, for example, a CSI-RS resource set along with its indicator; (iv) a plurality of CORESETs associated with a CORESETPoolIndex; and/or (v) a plurality of CORESETs associated with a TRP-specific index/indicator/identity.

Furthermore, different TRPs could broadcast/be associated with different physical cell identities (PCIs) and one or more TRPs in the system could broadcast/be associated with different PCIs from that of serving cell/TRP (i.e., the serving cell PCI). To better enable the multi-TRP operation, a UE could be configured/indicated by the network to report in a single reporting instance more than one CRIs or SSBRIs each corresponding to a TRP (group based beam reporting for the multi-TRP operation). Detailed procedures and signaling support for the group based beam reporting for the multi-TRP operation need to be specified.

The present disclosure considers various design aspects for beam acquisition, refinement and tracking in a wireless communications system. The present disclosure also provides various design options for the group based beam reporting for the multi-TRP operation.

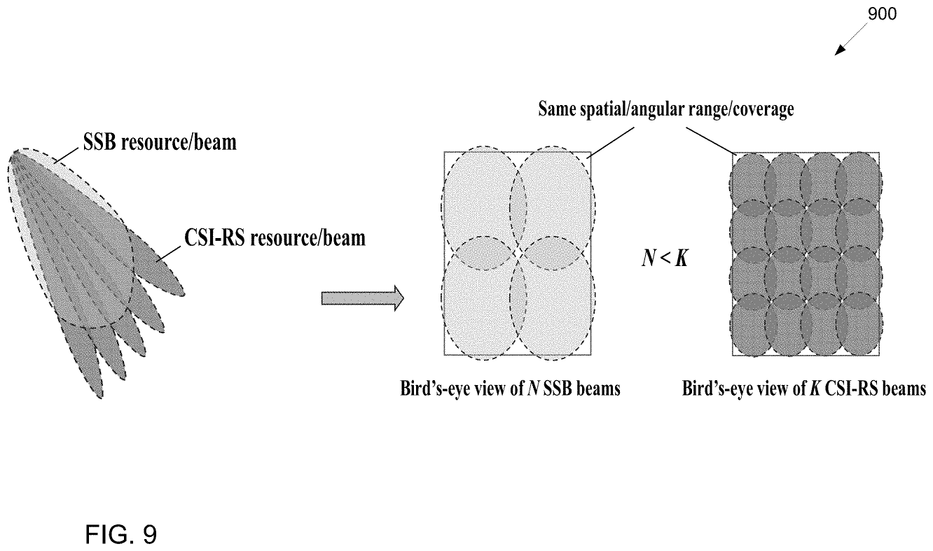

FIG. 8 illustrates an example two-stage beam acquisition and refinement 800 according to embodiments of the present disclosure. An embodiment of the two-stage beam acquisition and refinement 800 shown in FIG. 8 is for illustration only.

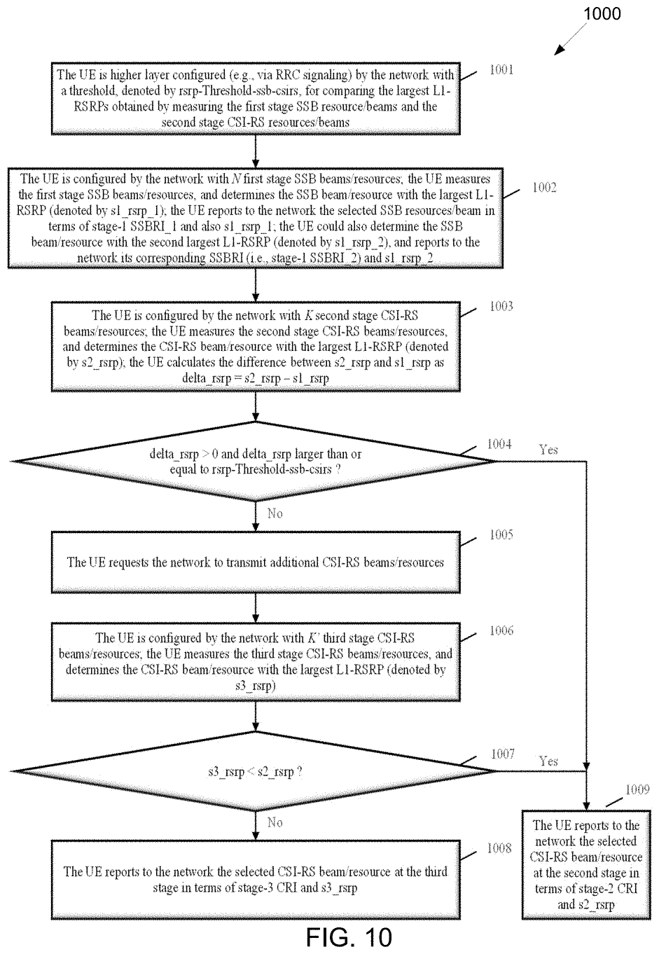

FIG. 9 illustrates an example spatial relationship between first-stage SSB resources/beams and second-stage CSI-RS resources/beams 900 according to embodiments of the present disclosure. An embodiment of the spatial relationship between first-stage SSB resources/beams and second-stage CSI-RS resources/beams 900 shown in FIG. 9 is for illustration only.

In FIG. 8, an illustrative/conceptual example of the two-stage beam acquisition procedure is presented. At the first stage, the UE could be configured by the network a set of N SSB resources/beams. The UE would measure the N SSB resources/beams, and report to the gNB one or more SSBRIs along with their corresponding beam metrics such as L1-RSRPs. The UE could then measure a set of K aperiodic (AP) CSI-RS resources/beams, which could be activated via MAC CE and/or indicated via the dynamic DCI signaling from a larger set of NZP CSI-RS resources higher layer configured to the UE. The UE would report to the gNB one or more CRIs along with their corresponding beam metrics such as L1-RSRPs.

To facilitate the two-stage beam acquisition process, the UE could also be indicated by the network a predefined association rule/mapping relationship between the selected SSB resource(s)/beam(s) and the K CSI-RS resources/beams. For instance, each SSB (wide) resource/beam in the set of SSB resources/beams could correspond to set of CSI-RS (narrow) resources/beams, and the SSB resource/beam and its corresponding CSI-RS resource(s)/beam(s) could cover the same angular space (depicted on the LHS in FIG. 9).

Hence, in one example, the UE could be indicated/configured by the network the association rule/mapping relationship between one or more SSB resources/beams, e.g., in form of their resource indexes, and one or more CSI-RS resources/beams, e.g., in form of their resource indexes. In another example, the UE could be indicated/configured by the network the association rule/mapping relationship between a CSI resource setting/configuration that configures one or more SSB resources/beams and another CSI resource setting/configuration that configures one or more CSI-RS resources/beams.

In yet another example, the UE could be indicated/configured by the network the association rule/mapping relationship between a CSI reporting setting/configuration that is associated with a CSI resource setting/configuration indicating/configuring one or more SSB resources/beams and another CSI reporting setting/configuration that is associated with a CSI resource setting/configuration indicating/configuring one or more CSI-RS resources/beams. In yet another example, the UE could be indicated/configured by the network the association rule/mapping relationship between one or more TCI states indicating one or more SSB resources/beams as the QCL source RSs and one or more TCI states indicating one or more CSI-RS resources/beams as the QCL source RSs, under the same assumption of the QCL source RS type (e.g., QCL-TypeD).

The above indication(s) could be via higher layer (RRC) or/and MAC CE or/and DCI based signaling; the above indication(s) could be via a separate (dedicated) parameter or joint with another parameter. Other association rules/mapping relationships between one or more SSB resource(s)/beam(s) and one or more CSI-RS resources/beams are also possible.

For the two-stage beam acquisition process illustrated in FIG. 8, as a total of N SSB resources/beams and the K CSI-RS resources/beams are used to cover the same spatial/angular range, N could be smaller than K (N<K) given that the SSB resource/beam could be wider/broader than the CSI-RS resource/beam in terms of the beamwidth. This is depicted on the RHS in FIG. 9 as well, in which the bird's-eye views of the N SSB resources/beams and the K CSI-RS resources/beams are provided.

For multi-path channels with strong non-line-of-sight (NLOS) components, the selected CSI-RS resource/beam could even result in a smaller beam metric such as L1-RSRP value than that of the selected SSB resource/beam, though the CSI-RS resource/beam could have a smaller beamwidth than that of the SSB resource/beam (and therefore, a larger beamforming/array gain), and the selected CSI-RS resource/beam is from the K CSI-RS resources/beams sharing the same angular coverage as/associated with the selected SSB resource/beam. Furthermore, the selected CSI-RS resource/beam may not result in the largest beam metric such as L1-RSRP if the UE could have measured all NK CSI-RS beams/resources, though the selected SSB resource/beam results in the largest beam metric such as L1-RSRP among all candidate SSB resources/beams at the first stage.

In this case, if the network uses the CSI-RS resource/beam selected by the UE (in terms of the CRI reported from the UE) to communicate with the UE for both data and control channels, the corresponding system performance could be significantly degraded. For instance, the received signal quality of the selected CSI-RS resource/beam could quickly fall below a certain threshold. Hence, the UE may need to perform the two-stage beam acquisition again, and/or even trigger a beam failure recovery procedure, which would result in significant delay and large signaling overhead.

To tackle the inaccuracy issue between the first stage SSB wide resources/beams and the second stage CSI-RS narrow resources/beams especially under multi-path channels, the UE could be configured/indicated by the network one or more thresholds to compare the difference between the largest beam metrics such as L1-RSRPs obtained at the first stage and the second stage. Based on the comparison results, the UE could request additional CSI-RS resources/beams from the network to measure, which in turn could improve the beam acquisition accuracy.

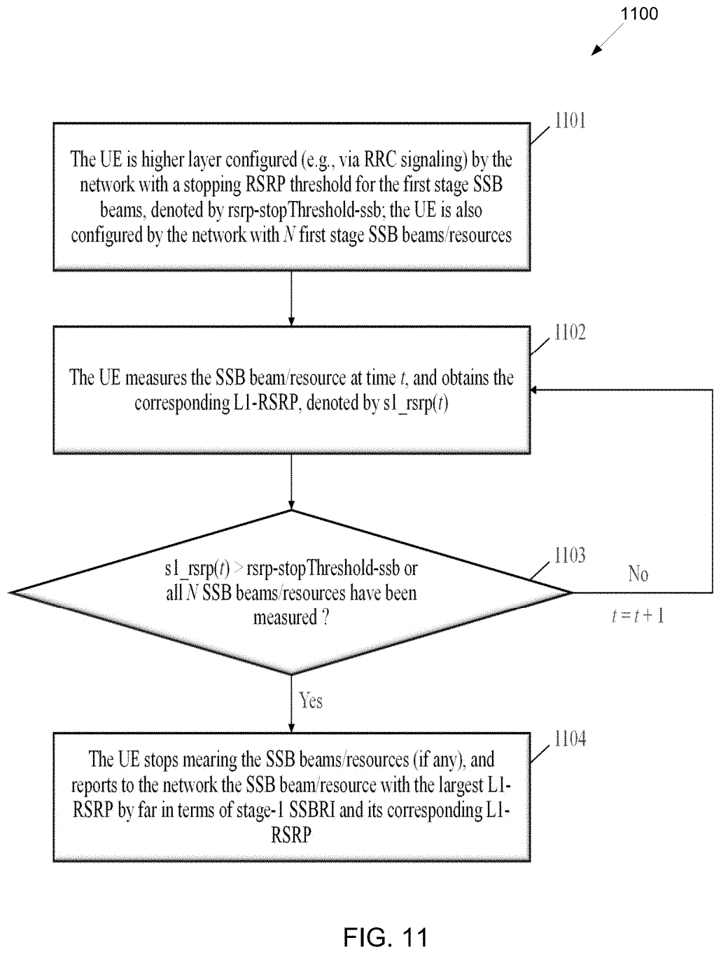

FIG. 10 illustrates a flowchart of a method 1000 for UE procedure according to embodiments of the present disclosure. The method 1000 as may be performed by a UE (e.g., 111-116 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

The corresponding design procedure is presented in FIG. 10, and the threshold for comparing the difference between stage-1 and stage-2 largest beam metrics such as L1-RSRPs is denoted as rsrp-Threshold-ssb-csirs. As illustrated in FIG. 10, in step 1001, the UE is higher layer configured (e.g., via RRC signaling) by the network a threshold rsrp-Threshold-ssb-csirs. The UE would use rsrp-Threshold-ssb-csirs to compare the difference between the largest measured L1-RSRPs from measuring the first stage SSB beams/resources and the second stage CSI-RS beams/resources. If the UE is not configured with rsrp-Threshold-ssb-csirs, the UE could follow the two-stage beam acquisition procedure, including both beam measurement and reporting, as shown in FIG. 8.

In step 1002, the UE is configured by the network a set of N SSB beams/resources (e.g., via higher layer parameter CSI-ResourceConfig). The UE measures L1-RSRPs of all the N SSB beams, and selects the SSB beam/resource with the largest measured L1-RSRP (denoted by s1_rsrp_1). The UE then reports to the network SSBRI_1 (the SSBRI corresponding to/associated with the selected SSB beam/resource with the largest measured L1-RSRP) and s1_rsrp_1. Upon receiving the stage-1 SSBRI_1, the network would determine the corresponding second stage CSI-RS beams/resources.

For instance, as depicted in FIG. 9, the network could determine a set of K CSI-RS beams for the second stage beam acquisition that cover the same angular range as the selected SSB beam at the first stage. The UE could also determine another SSB beam/resource that has the second largest measured L1-RSRP (denoted by s1_rsrp_2), and reports to the network SSBRI_2 (the SSBRI corresponding to/associated with the selected SSB beam/resource with the second largest measured L1-RSRP) and s1_rsrp_2. The UE could report up to 4 SSB beams/resources (and also, their corresponding beam metrics such as L1-RSRPs) to the network.

In step 1003, the UE is configured by the network a set of K CSI-RS beams/resources (e.g., via higher layer parameter CSI-ResourceConfig and/or CSI request in DCI 0_1). The UE measures L1-RSRPs of all the K CSI-RS beams/resources, and selects the CSI-RS beam/resource with the largest measured L1-RSRP (denoted by s2_rsrp). The UE then computes the difference between the largest measured L1-RSRPs obtained from the first stage and the second stage, i.e., delta_rsrp=s2_rsrp−s1_rsrp.

In step 1004, the UE compares the difference delta_rsrp with the configured threshold rsrp-Threshold-ssb-csirs. If delta_rsrp is greater than zero and greater than or equal to rsrp-Threshold-ssb-csirs, the process would proceed to 1009. Otherwise, the process would proceed to 1005.

In step 1005, the UE indicates to the network that the selected CSI-RS beam/resource at the second stage does not result in promising L1-RSRP, and therefore, the UE requests the network to transmit additional CSI-RS beams/resources for the UE to measure. Upon receiving the indication/request from the UE, the network would determine appropriate third stage CSI-RS beams/resources. For instance, the network would determine a set of K′ CSI-RS beams/resources that have the same spatial coverage as the selected SSB beam/resource (SSBRI_2) at the first stage with the second largest measured L1-RSRP.

In step 1006, the UE is configured by the network a set of K′ CSI-RS beams/resources (e.g., via higher layer parameter CSI-ResourceConfig and/or CSI request in DCI 0_1). The UE measures L1-RSRPs of all the K′ CSI-RS resources/beams, and selects the CSI-RS beam/resource with the largest measured L1-RSRP (denoted by s3_rsrp).

In step 1007, the UE compares the largest measured L1-RSRPs obtained at the second and third stages. If s3_rsrp is greater than s2_rsrp, the procedure would proceed to 1009. Otherwise, the procedure would proceed to 1008.

In step 1008, the UE reports the CSI-RS beam/resource selected at the third stage to the network in terms of stage-3 CRI and also its corresponding L1-RSRP s3_rsrp.

In step 1009, the UE reports the CSI-RS beam/resource selected at the second stage to the network in terms of stage-2 CRI and also its corresponding L1-RSRP s2_rsrp.

The UE could also send to the network the difference(s) between the largest L1-RSRPs obtained from different stages of beam acquisition (e.g., delta_rsrp=s2_rsrp−s1_rsrp between stage-1 and stage-2) along with the CSI/beam report(s). As discussed above, to improve the beam acquisition accuracy, the UE may require additional resources to measure, e.g., the third stage CSI-RS resources in the example shown in FIG. 10, from the network. This could increase resource/signaling overhead and beam acquisition latency. To reduce the beam acquisition latency, the UE could be configured by the network one or more stopping thresholds for the first stage SSB beams/resources and/or the second stage CSI-RS beams/resources.

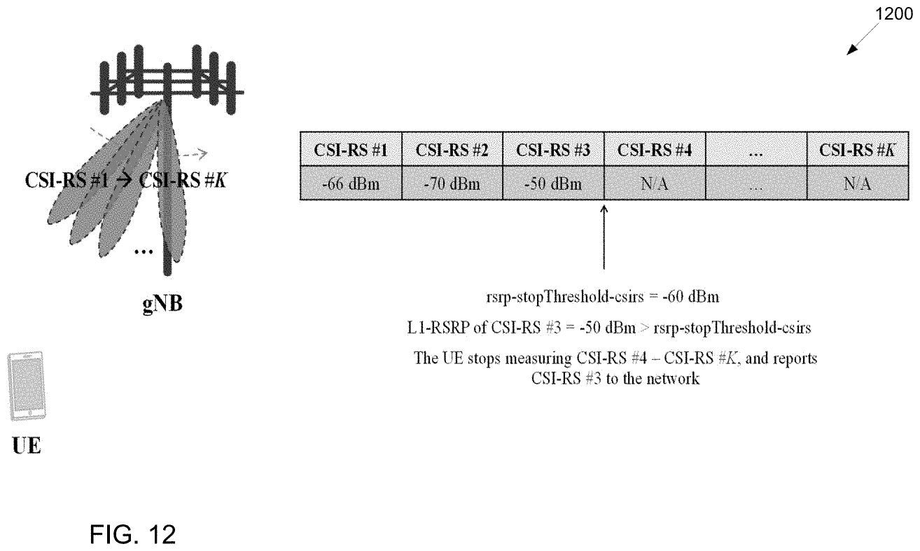

FIG. 11 illustrates another flowchart of a method 1100 for UE procedure according to embodiments of the present disclosure. The method 1100 as may be performed by a UE (e.g., 111-116 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As shown in step 1101 in FIG. 11, the UE is first higher layer configured/indicated (e.g., via RRC signaling) by the network a stopping RSRP threshold for measuring the first stage SSB beams/resources. Here, the stopping RSRP threshold is denoted by rsrp-stopThreshold-ssb. The UE is also configured by the network a set of N SSB beams/resources (e.g., via the higher layer parameter CSI-ResourceConfig). The network would transmit one SSB beam at a time.

In step 1102, the UE measures the SSB beam formed by the network at time t, and obtains the corresponding L1-RSRP, denoted by s1_rsrp(t).

In step 1103, the UE compares the L1-RSRP measured at time t with the configured stopping RSRP threshold. If s1_rsrp(t) is greater than rsrp-stopThreshold-ssb, the algorithm would proceed to 1104. Otherwise, the algorithm would go back to 1102 with t=t+1. That is, the UE would measure the SSB beam formed by the network at time t+1, and obtains the corresponding L1-RSRP s1_rsrp(t+1). If the UE has measured all N SSB beams/resources, the algorithm would also proceed to 1104.

In step 1104, the UE stops measuring the remaining SSB beams/resources (if any), and reports to the network the SSB beam/resource with the largest L1-RSRP measured by far (e.g., until time t) in terms of stage-1 SSBRI and its corresponding L1-RSRP.

Similar design principles and configurations could be applied to the second stage CSI-RS beams/resources as well. For instance, the UE could be higher layer configured (e.g., via RRC signaling) by the network a stopping RSRP threshold for the second stage CSI-RS beams/resources (denoted by rsrp-stopThreshold-csirs). Based on the configured stopping RSRP threshold, the UE could repeat similar procedures to those shown in FIG. 11 to early terminate the beam measurement process if the stopping condition is satisfied.

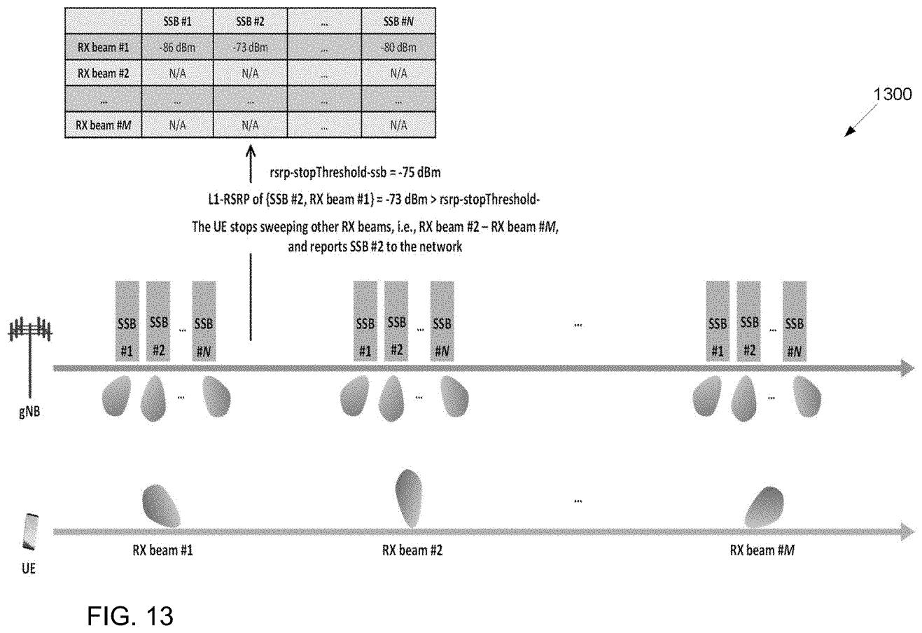

FIG. 12 illustrates an example beam measurement 1200 according to embodiments of the present disclosure. An embodiment of the beam measurement 1200 shown in FIG. 12 is for illustration only.

An illustrative example of the proposed fast CSI-RS beam acquisition strategy is presented in FIG. 12. In this example, the UE is configured by the network K CSI-RS beams/resources (e.g., via the higher layer parameter CSI-ResourceConfig and/or CSI request in DCI 0_1), and the UE measures the K CSI-RS beams/resources in a time-division multiplexing (TDM) manner. As can be seen from FIG. 12, the measured L1-RSRPs of CSI-RS #1 and CSI-RS #2 are below rsrp-StopThreshold-csirs, while the measured L1-RSRP of CSI-RS #3=−50 dBm is beyond rsrp-stopThreshold-csirs=−60 dBm. Hence, the UE would stop at CSI-RS #3 without further measuring the remaining CSI-RS beams/resources. The UE could then use the earlies available uplink resource(s)/opportunities to report to the network CSI-RS #3 as the selected CSI-RS beam/resource (in terms of its corresponding CRI) and also its corresponding L1-RSRP.

In FIG. 11 and FIG. 12, it is assumed that the UE uses a fixed RX beam to receive the SSB and CSI-RS beams/resources. The developed strategies can be applied to other deployment scenarios as well. For instance, with or without RRC connection (e.g., P1 in the initial access), the UE could cycle their RX beams in TDM to receive the SSB and CSI-RS beams/resources meanwhile applying the configured stopping thresholds to facilitate the beam acquisition process.

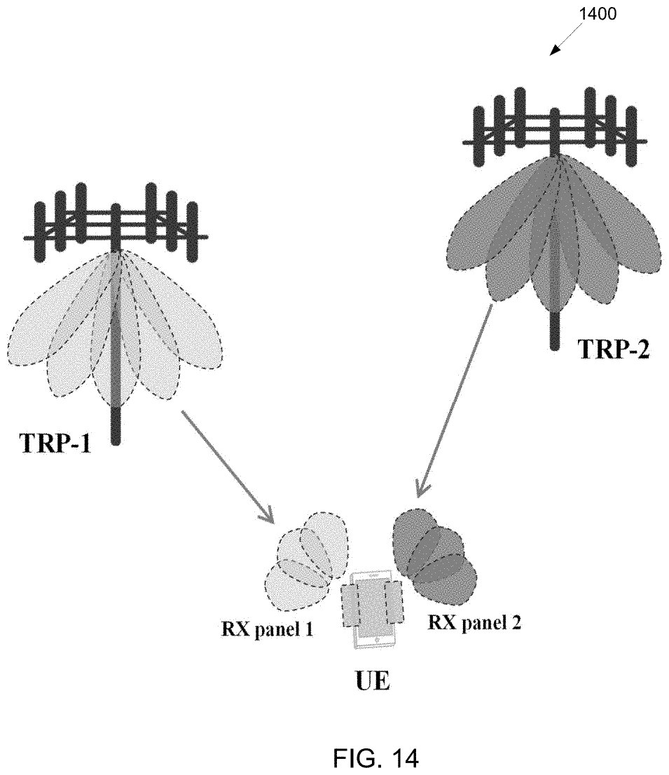

FIG. 13 illustrates an example multi-RX beam sweeping and measurement 1300 according to embodiments of the present disclosure. An embodiment of the multi-RX beam sweeping and measurement 1300 shown in FIG. 13 is for illustration only.

One illustrative example of multi-RX beam sweeping is provided in FIG. 13. In this example, the UE uses M RX beams to measure the configured N SSB beams/resources. As can be seen from FIG. 13, to measure all possible combinations between TX SSB beams/resources and RX beams, the UE could fix one RX beam to receive all SSB beams/resources until the UE has tested all their M RX beams. The UE, however, may not need to form all their M RX beams to take the L1-RSRP measurements if the UE is higher layer configured (e.g., via RRC signaling) by the network with a RSRP stopping threshold.

In the example shown in FIG. 13, after the UE has measured all N SSB beams via their RX beam #1, the UE identifies that the L1-RSRP of the TX-RX beam pair {SSB #2, RX beam #1} is beyond the configured RSRP stopping threshold rsrp-stopThreshold-ssb. Hence, the UE could stop sweeping their remaining RX beams (RX beam #2-RX beam #M in this example) to measure the SSB beams/resources, and reports to the network that SSB #2 is the selected SSB beam (in terms of its corresponding SSBRI) along with its corresponding L1-RSRP.

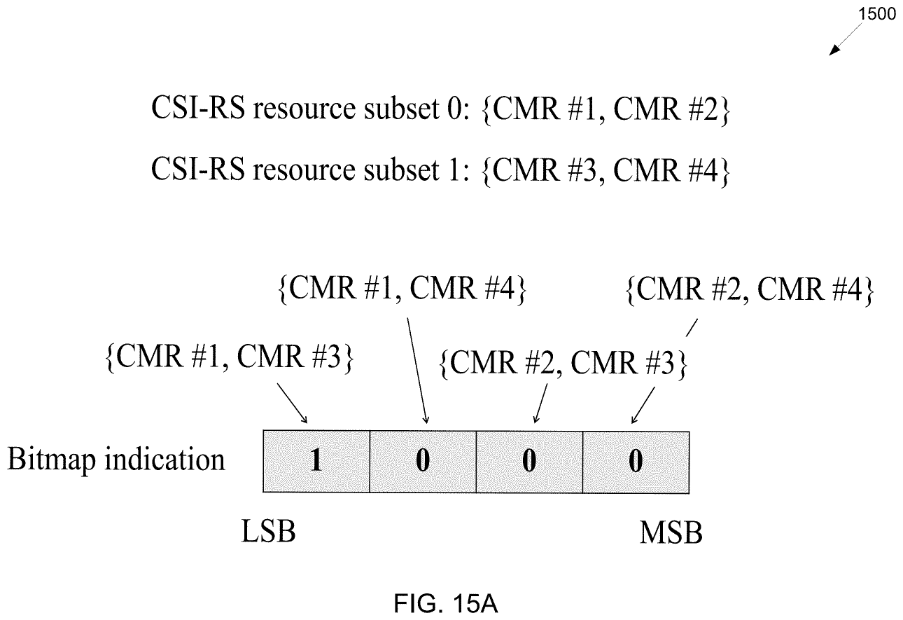

FIG. 14 illustrates an example multi-TRP system 1400 according to embodiments of the present disclosure. An embodiment of the multi-TRP system 1400 shown in FIG. 14 is for illustration only.

In a multi-TRP system, a UE could simultaneously receive multiple DL transmissions (e.g., PDSCHs) from multiple physically non-co-located TRPs (as illustrated FIG. 14). To better support simultaneous transmission/reception in a multi-TRP system, the UE could report in a single reporting instance at least one pair/group of SSBRIs or CRIs with each resource indicator (SSBRI or CRI) reported in the same pair/group of resource indicators corresponding to one TRP in the multi-TRP system (group based beam reporting for multi-TRP).

The above discussed group based beam reporting for the multi-TRP operation could be enabled/configured by the network. For instance, a higher layer parameter groupBasedBeamReporting or groupBasedBeamReportingR17 could be included/incorporated in the corresponding CSI reporting configuration/setting, e.g., in the higher layer parameter CSI-ReportConfig, to turn on/off the group based beam reporting for the multi-TRP operation. If the UE is configured with the higher layer parameter groupBasedBeamReporting or groupBasedBeamReportingR17 set to ‘enabled’, the UE shall report in a single reporting instance at least one pair/group of SSBRIs or CRIs with each resource indicator (SSBRI or CRI) in the same reported pair/group corresponding to a TRP, which could also correspond to a CSI resource setting/configuration, a CSI-RS resource set configured in a CSI resource setting/configuration or a CSI-RS resource subset configured in a CSI-RS resource set.

Various means of mapping/associating between one or more SSB/NZP CSI-RS resources and the coordinating TRPs in a multi-TRP system are provided as follows.

In one example of Option-1, the UE is configured by the network (e.g., provided in the corresponding CSI resource setting/configuration via the higher layer parameter CSI-ResourceConfig) M>1 CSI resource settings and S=1 CSI-RS resource set per CSI resource setting; each configured CSI resource setting is associated with/corresponds to a coordinating TRP in the multi-TRP system; in the present disclosure, the M>1 CSI resource settings could be regarded as a CSI resource super-setting for the multi-TRP operation. Specifically, for M=2, the UE could be configured by the network two CSI resource settings, denoted by CSI resource setting 1 and CSI resource setting 2, via the higher layer parameters CSI-ReportConfig1 and CSI-ReportConfig2, respectively.

In one instance of Option-1a, the mapping/association between the M CSI resource settings and the coordinating TRPs can be established in an implicit manner. For instance, for M=2, the first configured CSI resource setting or the configured CSI resource setting with a lower CSI-ResourceConfigId could be mapped to/associated with value 0 of CORESETPoolIndex, and the second configured CSI resource setting or the configured CSI resource setting with a higher CSI-ResourceConfigId could be mapped to/associated with value 1 of CORESETPoolIndex.

In another example, the UE could be first higher layer configured by the network (e.g., via higher layer RRC signaling) a list of TRP-specific index/ID values such as PCIs; optionally, the UE could also receive from the network a MAC CE activation command/bitmap to activate one or more entries from the list of RRC configured TRP-specific indexes/IDs; in this case, the first configured CSI resource setting (e.g., with the lowest CSI-ResourceConfigId) could be mapped to/associated with the first entry or the lowest (or the highest) TRP-specific index/ID value in the list of network configured TRP-specific index/ID values such as PCIs, the second configured CSI resource setting (e.g., with the second lowest CSI-ResourceConfigId) could be mapped to/associated with the second entry or the second lowest (or the second highest) TRP-specific index/ID value in the list of network configured TRP-specific index/ID values such as PCIs, and so on, and the last/M-th configured CSI resource setting (e.g., with the highest CSI-ResourceConfigId) could be mapped to/associated with the last entry or the highest (or the lowest) TRP-specific index/ID value in the list of network configured TRP-specific index/ID values such as PCIs.

Yet in another example, the M CSI resource settings could be associated with the TRPs through their configured one or more TCI states; each TCI state is linked to a TRP in the multi-TRP system, e.g., via the TRP-specific higher layer signaling index, such as TRP ID, PCI, CORESETPoolIndex, SSB set ID and/or etc. Other implicit mapping/association rules between the CSI resource settings and the coordinating TRPs are also possible, and they should be known to the UE a prior.

In another instance of Option-1b, the UE could be explicitly indicated by the network the mapping relationship between the M CSI resource settings and the TRPs. In one example, a TRP-specific higher layer signaling index, such as TRP ID, TRP RS ID, PCI, CORESETPoolIndex and etc., could be incorporated/included/indicated in the higher layer parameter CSI-ResourceConfig. In this case, a CSI resource setting and a TRP-specific higher layer signaling index are associated if they are configured in/by the same higher layer parameter CSI-ResourceConfig.

In another example, the UE could be first higher layer configured by the network a list of TRP-specific higher layer signaling index values, such as TRP IDs, TRP RS IDs, PCI values, CORESETPoolIndex values and etc. Optionally, the UE could also receive from the network a MAC CE activation command/bitmap to activate one or more entries from the list of higher layer configured TRP-specific higher layer signaling indexes. The k-th configured CSI resource setting (e.g., with the k-th lowest CSI-ResourceConfigId) could be mapped to/associated with the k-th entry or the k-th highest/lowest TRP-specific higher layer signaling index value in the list of network configured TRP-specific higher layer signaling index values, where k=1, . . . , M. Other methods of explicitly indicating/configuring the association rules/mapping relationships between the CSI resource settings and the coordinating TRPs are also possible.

In yet another instance of Option-1c, the UE could be configured by the network multiple CSI resource settings, each with a unique CSI-ResourceConfigId. The association between the CSI-ResourceConfigId's (and therefore, the corresponding CSI resource settings) and the TRPs in the multi-TRP system could follow those specified in Option-1a and Option-1b.

In yet another instance of Option-1d, the UE could be configured by the network multiple CSI resource settings with the same CSI-ResourceConfigId. In this case, one or more SSB/NZP CSI-RS resources configured in one or more of the CSI resource settings (CSI-ResourceConfig's) could be differently indexed. For instance, the UE could be configured by the network two CSI resource settings, CSI-ResourceConfig1 and CSI-ResourceConfig2, associated with TRP-1 and TRP-2 in the multi-TRP system shown in FIG. 14, respectively.

The NZP CSI-RS resources (nzp-CSI-RS-Resources) in the NZP CSI-RS resource set (NZP-CSI-RS-ResourceSet) in CSI-ResourceConfig1 are indexed as {1, 2, . . . , maxNrofNZP-CSI-RS-ResroucesPerSet1}, while the NZP CSI-RS resources in the NZP CSI-RS resource set in CSI-ResourceConfig2 are indexed as {maxNrofNZP-CSI-RS-ResroucesPerSet1+1, maxNrofNZP-CSI-RS-ResroucesPerSet1+2, . . . , maxNrofNZP-CSI-RS-ResroucesPerSet1+maxNrofNZP-CSI-RS-ResroucesPerSet2}.

In one example of Option-2, the UE is configured by the network (e.g., provided in the corresponding CSI resource setting/configuration via the higher layer parameter CSI-ResourceConfig) M=1 CSI resource setting. In the configured CSI resource setting, the UE is configured by the network S>1 CSI-RS resource sets (e.g., via the higher layer parameter CSI-SSB-ResourceSet/NZP-CSI-RS-ResourceSet), each corresponding to/associated with a coordinating TRP in the multi-TRP system.

For instance, for S=2, the UE could be configured by the network two CSI-RS resource sets, denoted by SSB resource set 1/NZP CSI-RS resource set 1 and SSB resource set 2/NZP CSI-RS resource set 2 provided by the higher layer parameters CSI-SSB-ResourceSet1/NZP-CSI-RS-ResourceSet1 and CSI-SSB-ResourceSet2/NZP-CSI-RS-ResourceSet2, respectively in the same CSI resource setting (e.g., via the higher layer parameter CSI-ResourceConfig). Each configured CSI-RS resource set (i.e., either SSB resource set 1/NZP CSI-RS resource set 1 or SSB resource set 2/NZP CSI-RS resource set 2) configures/indicates at least one SSB/NZP CSI-RS resource.

In one instance of Option-2a, the mapping/association between the S CSI-RS resource sets in the CSI resource setting and the coordinating TRPs in the multi-TRP system can be established in an implicit manner. For instance, for S=2, the first configured CSI-RS resource set, e.g., the first entry in the higher layer parameter csi-SSB-ResourceSetList/nzp-CSI-RS-ResourceSetList or provided by the higher layer parameter CSI-SSB-ResourceSet1/NZP-CSI-RS-ResourceSet1, or the configured CSI-RS resource set with a smaller resource set ID (e.g., provided by SSB-ResourceSetId/NZP-CSI-RS-ResourceSetId in CSI-SSB-ResourceSet1/NZP-CSI-RS-ResourceSet1), could be mapped to/associated with value 0 of CORESETPoolIndex, and the second configured CSI-RS resource set, e.g., the second entry in the higher layer parameter csi-SSB-ResourceSetList/nzp-CSI-RS-ResourceSetList or provided by the higher layer parameter CSI-SSB-ResourceSet2/NZP-CSI-RS-ResourceSet2, or the configured CSI-RS resource set with a larger resource set ID (e.g., provided by SSB-ResourceSetId/NZP-CSI-RS-ResourceSetId in CSI-SSB-ResourceSet2/NZP-CSI-RS-ResourceSet2), could be mapped to/associated with value 1 of CORESETPoolIndex.

In another example, the UE could be first higher layer configured by the network a list of TRP-specific index/ID values such as PCIs; optionally, the UE could also receive from the network a MAC CE activation command/bitmap to activate one or more entries from the list of RRC configured TRP-specific indexes/IDs; in this case, the first configured CSI-RS resource set, e.g., the first entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet, or the configured CSI-RS resource set with the lowest resource set ID (e.g., provided by SSB-ResourceSetId/NZP-CSI-RS-ResourceSetId in the corresponding CSI-SSB-ResourceSet/NZP-CSI-RS-ResourceSet) could be mapped to/associated with the first entry or the lowest (or the highest) TRP-specific index/ID value in the list of network configured TRP-specific index/ID values such as PCIs, the second configured CSI-RS resource set, e.g., the second entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet, or the configured CSI-RS resource set with the second lowest resource set ID (e.g., provided by SSB-ResourceSetId/NZP-CSI-RS-ResourceSetId in the corresponding CSI-SSB-ResourceSet/NZP-CSI-RS-ResourceSet) could be mapped to/associated with the second entry or the second lowest (or the second highest) TRP-specific index/ID value in the list of network configured TRP-specific index/ID values such as PCIs, and so on, and the last (S-th) configured CSI-RS resource set, e.g., the last (S-th) entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet, or the configured CSI-RS resource set with the highest resource set ID (e.g., provided by SSB-ResourceSetId/NZP-CSI-RS-ResourceSetId in the corresponding CSI-SSB-ResourceSet/NZP-CSI-RS-ResourceSet) could be mapped to/associated with the last entry or the highest (or the lowest) TRP-specific index/ID value in the list of network configured TRP-specific index/ID values such as PCIs.

Yet in another example, the S CSI-RS resource sets could be associated with the TRPs through their configured one or more TCI states; each TCI state is linked to a TRP in the multi-TRP system, e.g., via the TRP-specific higher layer signaling index, such as TRP ID, PCI, CORESETPoolIndex, SSB set ID and/or etc. Other implicit mapping/association rules between the CSI-RS resource sets in the CSI resource setting and the coordinating TRPs in the multi-TRP system are also possible, and they should be known to the UE a prior.

In one instance of Option-2b, the UE could be explicitly indicated by the network the mapping relationship between the S CSI-RS resource sets in the CSI resource setting and the TRPs in the multi-TRP system. In one example, a TRP-specific higher layer signaling index, such as TRP ID, TRP RS ID, PCI, CORESETPoolIndex and etc., could be incorporated/included/indicated in the corresponding higher layer parameter CSI-SSB-ResourceSet/NZP-CSI-RS-ResourceSet. In this case, a CSI-RS resource set and a TRP-specific higher layer signaling index are associated if they are configured in/by the same higher layer parameter CSI-SSB-ResourceSet/NZP-CSI-RS-ResourceSet.

In another example, the UE could be first higher layer indicated/configured by the network a list of TRP-specific higher layer signaling index values, such as TRP IDs, TRP RS IDs, PCI values, CORESETPoolIndex values and etc. Optionally, the UE could also receive from the network a MAC CE activation command/bitmap to activate one or more entries from the list of higher layer configured TRP-specific higher layer signaling indexes. In this case, the k-th configured CSI-RS resource set, e.g., the k-th entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet, or the configured CSI-RS resource set with the k-th lowest resource set ID value (e.g., provided by SSB-ResourceSetId/NZP-CSI-RS-ResourceSetId in the corresponding CSI-SSB-ResourceSet/NZP-CSI-RS-ResourceSet) could be mapped to/associated with the k-th entry or the k-th highest/lowest TRP-specific higher layer signaling index value in the list of network configured TRP-specific higher layer signaling indexes. Other methods of explicitly indicating/configuring the association rules/mapping relationships between the CSI-RS resource sets in the CSI resource setting and the coordinating TRPs are also possible.

In one instance of Option-2c, the UE could be configured by the network multiple CSI-RS resource sets (e.g., via the higher layer parameter CSI-SSB-ResourceSet/NZP-CSI-RS-ResourceSet) in a single CSI resource setting (e.g., via the higher layer parameter CSI-ResourceConfig), each with a unique resource set ID provided by NZP-CSI-RS-ResourceSetId/SSB-ResourceSetId. The association between the NZP-CSI-RS-ResourceSetId's/SSB-ResourceSetId's (and therefore, the corresponding CSI-RS resource sets) and the TRPs in the multi-TRP system could follow those specified in Option-2a and Option-2b.

In one instance of Option-2d, the UE could be configured by the network multiple CSI-RS resource sets (e.g., via the higher layer parameter CSI-SSB-ResourceSet/NZP-CSI-RS-ResourceSet) with the same resource set ID provided by NZP-CSI-RS-ResourceSetId/SSB-ResourceSetId. In this case, one or more SSB/CSI-RS resources configured in one or more of the CSI-RS resource sets (CSI-SSB-ResourceSet's/NZP-CSI-RS-ResourceSet's) could be differently indexed.

For instance, the UE could be configured by the network two NZP CSI-RS resource sets in a single CSI resource setting, provided by higher layer parameters NZP-CSI-RS-ResourceSet1 and NZP-CSI-RS-ResourceSet2 in CSI-ResourceConfig, respectively. The NZP CSI-RS resources (provided by nzp-CSI-RS-Resources) in NZP-CSI-RS-ResourceSet1 are indexed as {1, 2, . . . , maxNrofNZP-CSI-RS-ResroucesPerSet1}, while the NZP CSI-RS resources (provided by nzp-CSI-RS-Resources) in NZP-CSI-RS-ResourceSet2 are indexed as {maxNrofNZP-CSI-RS-ResroucesPerSet1+1, maxNrofNZP-CSI-RS-ResroucesPerSet1+2, . . . , maxNrofNZP-CSI-RS-ResroucesPerSet1+maxNrofNZP-CSI-RS-ResroucesPerSet2}.

In one example of Option-3, the UE is configured by the network M=1 CSI resource setting (e.g., via the higher layer parameter CSI-ResourceConfig), and the configured CSI resource setting comprises/includes S=1 CSI-RS resource set (e.g., configured/provided to the UE via the higher layer parameter CSI-SSB-ResourceSet/NZP-CSI-RS-ResourceSet). The CSI-RS resource set comprises/includes at least two (Kₛ≥2) SSB/NZP CSI-RS resources.

The Kₛ SSB/NZP CSI-RS resources configured in the CSI-RS resource set are divided into Mₛ>1 CSI-RS resource subsets, each corresponding to/associated with a coordinating TRP in the multi-TRP system. There could be various means to divide the total Kₛ SSB/NZP CSI-RS resources in the CSI-RS resource set into the Mₛ CSI-RS resource subsets. In one example, the r-th (r=1, . . . , Mₛ) CSI-RS resource subset (e.g., with the r-th lowest/highest CSI-RS resource subset ID, denoted by NZP-CSI-RS-ResourceSubSetId/SSB-ResourceSubSetId) could comprise/include kᵣ SSB/NZP CSI-RS resources; the CSI-RS resource set containing the Mₛ CSI-RS resource subsets therefore has a total of Kₛ=Σᵣ₌₁^{Ms} kᵣ SSB/NZP CSI-RS resources.

The UE could be configured/indicated by the network the values of k₁, k₂, . . . , k_{Ms} via higher layer RRC or/and MAC CE or/and dynamic DCI based signaling. In one example, the values of k₁, k₂, . . . , k_{Ms} could be deterministic/fixed per RRC configuration and configured/indicated to the UE via higher layer RRC signaling (e.g., provided in higher layer parameter CSI-ResourceConfig). For instance, for Mₛ=2 (Kₛ=k₁+k₂), k₁ could correspond to the first half of the SSB/NZP CSI-RS resources in the CSI-RS resource set (i.e., k₁=Kₛ/2 or └Kₛ/2┘ or ┌Ks/2┐ or Kₛ−k₂), and k₂ could correspond to the second half of the SSB/NZP CSI-RS resources in the CSI-RS resource set (i.e., k₂=Kₛ/2 or └Ks/2┘ or ┌Ks/2┐ or Kₛ−k₁).

In another example, the UE could be first higher layer configured/indicated by the network (e.g., via RRC signaling) one or more sets of candidate values of k₁, k₂, . . . , k_{Ms}. The UE could then receive from the network one or more MAC CE activation commands/bitmaps to activate/select one set of values of k₁, k₂, . . . , k_{Ms} out of all candidate sets of values of k₁, k₂, . . . , k_{Ms}. In yet another example, the UE could be configured by the network the exact values of k₁, k₂, . . . , k_{Ms} via dynamic DCI indication. The Mₛ CSI-RS resource subsets in the CSI-RS resource set could also form a list of CSI-RS resource subsets with Mₛ entries (denoted by csi-RS-ResourceSubSetList), which could be configured to the UE, e.g., via the higher layer parameter CSI-ResourceConfig.

For instance, for Mₛ=2, the UE could be configured by the network two CSI-RS resource subsets, denoted by SSB resource subset 1/CSI-RS resource subset 1 and SSB resource subset 2/CSI-RS resource subset 2 provided by the higher layer parameters CSI-SSB-ResourceSubSet1/NZP-CSI-RS-ResourceSubSet1 and CSI-SSB-ResourceSubSet2/NZP-CSI-RS-ResourceSubSet2, respectively in the same CSI-RS resource set (e.g., provided by the higher layer parameter CSI-SSB-ResourceSet/NZP-CSI-RS-ResourceSet) in a CSI resource setting (e.g., via the higher layer parameter CSI-ResourceConfig). The SSB resource subset 1/NZP CSI-RS resource subset 1 configures/indicates the k₁ SSB/NZP CSI-RS resources, and the SSB resource subset 2/NZP CSI-RS resource subset 2 configures/indicates the k₂ SSB/NZP CSI-RS resources, wherein k₁ and k₂ could be determined according to the above described design options.

In one instance of Option-3a, the mapping/association between the Mₛ CSI-RS resource subsets and the coordinating TRPs in the multi-TRP system can be established in an implicit manner. For instance, for Mₛ=2, the first configured CSI-RS resource subset (e.g., containing the first half of the SSB/NZP CSI-RS resources in the corresponding CSI-RS resource set), e.g., the first entry in the higher layer parameter csi-SSB-ResourceSubSetList/nzp-CSI-RS-ResourceSubSetList or provided by the higher layer parameter CSI-SSB-ResourceSubSet1/NZP-CSI-RS-ResourceSubSet1, or the configured CSI-RS resource subset with a smaller resource subset ID (e.g., provided by SSB-ResourceSubSetId/NZP-CSI-RS-ResourceSubSetId in CSI-SSB-ResourceSubSet1/NZP-CSI-RS-ResourceSubSet1) could be mapped to/associated with value 0 of CORESETPoolIndex, and the second configured CSI-RS resource subset (e.g., containing the second half of the SSB/NZP CSI-RS resources in the corresponding CSI-RS resource set), e.g., the second entry in the higher layer parameter csi-SSB-ResourceSubSetList/nzp-CSI-RS-ResourceSubSetList or provided by the higher layer parameter CSI-SSB-ResourceSubSet2/NZP-CSI-RS-ResourceSubSet2, or the configured CSI-RS resource subset with a larger resource subset ID (e.g., provided by SSB-ResourceSubSetId/NZP-CSI-RS-ResourceSubSetId in CSI-SSB-ResourceSubSet2/NZP-CSI-RS-ResourceSubSet2), could be mapped to/associated with value 1 of CORESETPoolIndex.

In another example, the UE could be first higher layer configured by the network a list of TRP-specific index/ID values such as PCIs; optionally, the UE could also receive from the network a MAC CE activation command/bitmap to activate one or more entries from the list of RRC configured TRP-specific indexes/IDs; the first configured CSI-RS resource subset (e.g., containing the k₁ SSB/NZP CSI-RS resources in the corresponding CSI-RS resource set), e.g., the first entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet) could be mapped to/associated with the first entry or the lowest (or the highest) TRP-specific index/ID value in the list of network configured TRP-specific index/ID values such as PCIs, the second configured CSI-RS resource subset (e.g., containing the k₂ SSB/NZP CSI-RS resources in the corresponding CSI-RS resource set), e.g., the second entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the second lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet) could be mapped to/associated with the second entry or the second lowest (or the second highest) TRP-specific index/ID value in the list of network configured TRP-specific index/ID values such as PCIs, and so on, and the last (Mₛ-th) configured CSI-RS resource subset (e.g., containing the k_{Ms} SSB/NZP CSI-RS resources in the corresponding CSI-RS resource set), e.g., the last (Mₛ-th) entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the highest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet) could be mapped to/associated with the last entry or the highest (or the lowest) TRP-specific index/ID value in the list of network configured TRP-specific index/ID values such as PCIs.

Yet in another example, the Mₛ CSI-RS resource subsets could be associated with the TRPs through their configured one or more TCI states; each TCI state is linked to a TRP in the multi-TRP system, e.g., via the TRP-specific higher layer signaling index, such as TRP ID, PCI, CORESETPoolIndex, SSB set ID and/or etc. Other implicit mapping/association rules between the CSI-RS resource subsets in the CSI-RS resource set and the coordinating TRPs in the multi-TRP system are also possible, and they should be known to the UE a prior.

In one instance of Option-3b, the UE could be explicitly indicated by the network the mapping relationship between the Mₛ CSI-RS resource subsets (and therefore, the SSB/NZP CSI-RS resources therein) in the CSI-RS resource set and the TRPs in the multi-TRP system. In one example, a TRP-specific higher layer signaling index, such as TRP ID, TRP RS ID, PCI, CORESETPoolIndex and etc., could be incorporated/included/indicated in the corresponding higher layer parameter CSI-SSB-ResourceSubSet/NZP-CSI-RS-ResourceSubSet. In this case, a CSI-RS resource subset and a TRP-specific higher layer signaling index are associated if they are configured in/by the same higher layer parameter CSI-SSB-ResourceSubSet/NZP-CSI-RS-ResourceSubSet.

In another example, the UE could be first higher layer indicated/configured by the network a list of TRP-specific higher layer signaling index values, such as TRP IDs, TRP RS IDs, PCI values, CORESETPoolIndex values and etc. Optionally, the UE could also receive from the network a MAC CE activation command/bitmap to activate one or more entries from the list of higher layer configured TRP-specific higher layer signaling indexes. In this case, the k-th configured CSI-RS resource subset, e.g., the k-th entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the k-th lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet) could be mapped to/associated with the k-th entry or the k-th highest/lowest TRP-specific higher layer signaling index value in the list of network configured TRP-specific higher layer signaling indexes. Other methods of explicitly indicating/configuring the association rules/mapping relationships between the CSI-RS resource subsets (and therefore, the SSB/NZP CSI-RS resources configured therein) in the CSI-RS resource set and the coordinating TRPs are also possible.

In one instance of Option-3c, the UE could be higher layer configured by the network with S=1 CSI-RS resource set in M=1 CSI resource setting (e.g., via the higher layer parameter CSI-ResourceConfig), and the SSB/NZP CSI-RS resources in the CSI-RS resource set are divided into multiple (Mₛ) CSI-RS resource subsets. As discussed above, the UE could be configured/indicated by the network how the SSB/NZP CSI-RS resources in the CSI-RS resource set are divided into the Mₛ>1 CSI-RS resource subsets. In this case, the UE may not need to know the association rule/mapping relationship between the CSI-RS resource subsets (and therefore, the SSB/NZP CSI-RS resources therein) and the coordinating TRPs in the multi-TRP system, unlike those presented in Option-3a and Option-3b.

The UE could be higher layer configured/indicated by the network (e.g., via RRC signaling) one or multiple CSI reports in a single CSI reporting setting (e.g., via the higher layer parameter CSI-ReportConfig). Alternatively, the UE could be higher layer configured/indicated by the network multiple CSI reporting settings (e.g., via the higher layer parameters CSI-ReportConfig's).

In one example of Option-I, the UE is higher layer configured with P=1 CSI reporting setting. The single CSI reporting setting is for all the coordinating TRPs in the multi-TRP system (the number of the coordinating TRPs in the multi-TRP system is denoted by Ntrp). The P=1 CSI reporting setting can include one CSI-report for all TRPs in the multi-TRP system or more than one (e.g. one CSI-report per TRP in the multi-TRP system) CSI-report's.

In one instance of Option-Ia: the UE could report in a single reporting instance all of or a subset of the Ntrp CSI-report's dynamically, i.e., the UE could report X≤Ntrp CSI-report's, {CSI(x), x=0, 1, . . . , X−1}, where the value of X could be fixed, or configured to the UE via RRC, or MAC CE, or DCI, or a combination of at least two of RRC, MAC CE, and DCI, or autonomously determined by the UE and reported to the network as part of the CSI-report and/or a separate CSI parameter and/or jointly with another parameter such as RI, CRI and etc. If the value of X is chosen dynamically by the UE, the X CSI-report's can be partitioned into two parts, CSI part 1 and CSI part 2.

In one example, the CSI part 1 and part 2 are as follows: (i) the CSI part 1 includes x₁<X CSI-report's, where x₁ is fixed or configured (e.g. x₁=1), and an indication about the remaining x₂=X−x₁ CSI-report's. This information can be a bitmap of length Ntrp. The payload (number of bits) of the CSI part 1 is fixed; and (ii) the CSI part 2 includes the remaining x₂ CSI-report's. The payload of the CSI part 2 is variable depending on the value of x₂. In one example, x₂=0 is allowed. In one example, x₂>0. The two parts of the CSI-report can be transmitted (reported) by the UE via a two-part UCI (cf. Rel. 15 two-part UCI).

In one instance of Option-Ib, the UE could report in Ntrp separate reporting instances Ntrp CSI-report's, each associated with a TRP in the multi-TRP system. The mapping/association between the Ntrp CSI-report's (and therefore, the corresponding Ntrp reporting instances) configured in the CSI reporting setting and the coordinating TRPs can be established in an implicit manner. For instance, for Ntrp=2, the first CSI-report could be mapped to/associated value 0 of CORESETPoolIndex, and the second CSI-report could be mapped to/associated with value 1 of CORESETPoolIndex.

In another example, the UE could be first higher layer configured by the network (e.g., via higher layer RRC signaling) a list of TRP-specific index/ID values such as PCIs; optionally, the UE could also receive from the network a MAC CE activation command/bitmap to activate one or more entries from the list of RRC configured TRP-specific indexes/IDs; in this case, the first CSI-report could be mapped to/associated with the first entry or the lowest (or the highest) TRP-specific index/ID value in the list of network configured TRP-specific index/ID values such as PCIs, and the second CSI-report could be mapped to/associated with the second entry or the second lowest (or the second highest) TRP-specific index/ID value in the list of network configured TRP-specific index/ID values such as PCIs, and so on, and the last (Ntrp-th) CSI-report could be mapped to/associated with the last entry or the highest (or the lowest) TRP-specific index/ID value in the list of network configured TRP-specific index/ID values such as PCIs.

In yet another example, the Ntrp CSI-report's could be associated with the TRPs through their configured one or more TCI states; each TCI state is linked to a TRP in the multi-TRP system, e.g., via the TRP-specific higher layer signaling index, such as TRP ID, PCI, CORESETPoolIndex, SSB set ID and/or etc. Other implicit mapping/association rules between the Ntrp CSI-report's (and therefore, the corresponding Ntrp reporting instances) configured in the CSI reporting setting and the coordinating TRPs in the multi-TRP system are also possible, and they should be known to the UE a prior.

In one instance of Option-1c, the UE could report in Ntrp separate reporting instances Ntrp CSI-report's, each associated with a TRP in the multi-TRP system. The UE could be explicitly indicated by the network regarding the mapping relationship between the Ntrp CSI-report's configured in the CSI reporting setting and the TRPs in the multi-TRP system. In one example, a TRP-specific higher layer signaling index, such as TRP ID, TRP RS ID, PCI, CORESETPoolIndex and etc., could be incorporated/included/indicated in a higher layer parameter configuring a CSI-report. In this case, a CSI-report and a TRP-specific higher layer signaling index are associated if they are configured in/by the same higher layer parameter. Alternatively, a set/list of Ntrp TRP-specific higher layer signaling indexes, such as TRP IDs, TRP RS IDs, PCIs, CORESETPoolIndex values and etc. could be incorporated/included/indicated in the higher layer parameter CSI-ReportConfig each corresponding to/associated with a CSI-report configured therein.

In another example, the UE could be first higher layer configured by the network a list of TRP-specific higher layer signaling index values, such as TRP IDs, TRP RS IDs, PCI values, CORESETPoolIndex values and etc. Optionally, the UE could also receive from the network a MAC CE activation command/bitmap to activate one or more entries from the list of higher layer configured TRP-specific higher layer signaling indexes. The k-th CSI-report (and therefore, the k-th reporting instance) could be mapped to/associated with the k-th entry or the k-th highest/lowest TRP-specific higher layer signaling index value in the list of network configured TRP-specific higher layer signaling index values, where k=1, . . . , Ntrp. Other methods of explicitly indicating/configuring the association rules/mapping relationships between the Ntrp CSI-report's (and therefore, the corresponding Ntrp reporting instances) in the CSI reporting setting and the coordinating TRPs in the multi-TRP system are also possible.

In one example of Option-II, the UE is higher layer configured with P>1 CSI reporting settings, which could be indexed/regarded/labelled as the first CSI reporting setting, the second CSI reporting setting, and so on, and the P-th CSI reporting setting. For example, the first CSI reporting setting could have the lowest CSI reporting setting ID value (e.g., provided by the higher layer parameter CSI-ReportConfigId), the second CSI reporting setting could have the second lowest CSI reporting setting ID value, and so on, and the P-th CSI reporting setting could have the highest CSI reporting setting ID value (other association/mapping relationships between the ordering of the CSI reporting settings and the CSI reporting setting ID values are also possible); each CSI reporting setting could be associated with one or more TRPs in the multi-TRP system. A single TRP in the multi-TRP system could be associated with a single CSI reporting setting.

In one instance of Option-IIa, The UE could report all of or a subset of the P CSI reports dynamically (here, each CSI report is associated with a separate CSI reporting setting), i.e., the UE could report Y≤P CSI reports, {CSI(y), y=0, 1, . . . , Y−1}, where the value of Y could be fixed, or configured to the UE via RRC, or MAC CE, or DCI, or a combination of at least two of RRC, MAC CE, and DCI, or autonomously determined by the UE and reported to the network as part of the CSI report and/or a separate CSI parameter and/or jointly with another parameter such as RI, CRI and etc. If the value of Y is chosen dynamically by the UE, the Y CSI reports can be partitioned into two parts, CSI part 1 and CSI part 2.

In one example, the CSI part 1 and part 2 are as follows: (i) the CSI part 1 includes y₁<Y CSI reports, where y₁ is fixed or configured (e.g. y₁=1), and an indication about the remaining y₂=Y−y₁ CSI reports. This information can be a bitmap of length P. The payload (number of bits) of the CSI part 1 is fixed; and (ii) the CSI part 2 includes the remaining y₂ CSI reports. The payload of the CSI part 2 is variable depending on the value of y₂. In one example, y₂=0 is allowed. In one example, y₂>0.

In one instance of Option-IIb, the UE could report in P separate reporting instances P CSI/beam reports (corresponding to P CSI reporting settings), each associated with one or more TRPs in the multi-TRP system. The mapping/association between the P CSI reporting settings and the coordinating TRPs can be established in an implicit manner. For instance, for Ntrp=2, the first CSI reporting setting with a lower CSI-ReportConfigld could be mapped to/associated value 0 of CORESETPoolIndex, and the second CSI reporting setting with a higher CSI-ReportConfigld could be mapped to/associated with value 1 of CORESETPoolIndex.

In another example, the UE could be first higher layer configured by the network (e.g., via higher layer RRC signaling) a list of TRP-specific index/ID values such as PCIs; optionally, the UE could also receive from the network a MAC CE activation command/bitmap to activate one or more entries from the list of RRC configured TRP-specific indexes/IDs; in this case, the first CSI reporting setting (e.g., with the lowest CSI-ReportConfigId) could be mapped to/associated with the first entry or the lowest (or the highest) TRP-specific index/ID value in the list of network configured TRP-specific index/ID values such as PCIs, the second CSI reporting setting (e.g., with the second lowest CSI-ReportConfigId) could be mapped to/associated with the second entry or the second lowest (or the second highest) TRP-specific index/ID value in the list of network configured TRP-specific index/ID values such as PCIs, and so on, and the last (P-th) CSI reporting setting (e.g., with the highest CSI-ReportConfigId) could be mapped to/associated with the last entry or the highest (or the lowest) TRP-specific index/ID value in the list of network configured TRP-specific index/ID values such as PCIs.

In yet another example, the P CSI reporting settings could be associated with the TRPs through their configured one or more TCI states; each TCI state is linked to a TRP in the multi-TRP system, e.g., via the TRP-specific higher layer signaling index, such as TRP ID, PCI, CORESETPoolIndex, SSB set ID and/or etc. Other implicit mapping/association rules between the P CSI reporting settings and the coordinating TRPs in the multi-TRP system are also possible, and they should be known to the UE a prior.

In one instance of Option-IIc, the UE could report in P separate reporting instances P CSI/beam reports (corresponding to P CSI reporting settings), each associated with one or more TRPs in the multi-TRP system. The UE could be explicitly indicated by the network regarding the mapping relationship between the P CSI reporting settings and the TRPs in the multi-TRP system. In one example, a TRP-specific higher layer signaling index, such as TRP ID, TRP RS ID, PCI, CORESETPoolIndex and etc., could be incorporated/included/indicated in the higher layer parameter CSI-ReportConfig. In this case, a reporting instance or a CSI/beam report or a CSI report setting and a TRP-specific higher layer signaling index are associated if they are configured in/by the same higher layer parameter CSI-ReportConfig.

In another example, the UE could be first higher layer configured by the network a list of TRP-specific higher layer signaling index values, such as TRP IDs, TRP RS IDs, PCI values, CORESETPoolIndex values and etc. Optionally, the UE could also receive from the network a MAC CE activation command/bitmap to activate one or more entries from the list of higher layer configured TRP-specific higher layer signaling indexes. The k-th CSI reporting setting (e.g., with the k-th lowest CSI-ReportConfigId) could be mapped to/associated with the k-th entry or the k-th highest/lowest TRP-specific higher layer signaling index value in the list of network configured TRP-specific higher layer signaling index values, where k=1, . . . , Ntrp. Other methods of explicitly indicating/configuring the association rules/mapping relationships between the P CSI reporting settings and the coordinating TRPs in the multi-TRP system are also possible.

The UE could report in a single reporting instance Mg≥2 resource indicators such as SSBRIs/CRIs (and therefore, the corresponding Mg≥2 beam metrics such as L1-RSRPs/L1-SINRs) for a single TRP or multiple TRPs in a multi-TRP system. For instance, a higher layer parameter groupBasedBeamReporting-mTRP or groupBasedBeamReportingR17 could be configured/incorporated/indicated in the corresponding CSI reporting setting, e.g., in the higher layer parameter CSI-ReportConfig, to turn on/off group based beam reporting for the multi-TRP operation.

If groupBasedBeamReporting-mTRP/groupBasedBeamReportingR17 is set to ‘enabled’, the UE shall report in a single reporting instance Mg≥2 resource indicators such as SSBRIs and/or CRIs (and therefore, the corresponding Mg≥2 beam metrics such as L1-RSRPs/L1-SINRs) selected/determined from one or more SSB or NZP CSI-RS resources configured in different CSI resource settings (Option-1 in the present disclosure), different CSI-RS resource sets (Option-2 in the present disclosure), or different CSI-RS resource subsets (Option-3 in the present disclosure); furthermore, the SSB and/or NZP CSI-RS resources corresponding to the selected/determined SSBRIs/CRIs reported in the same reporting instance could be received simultaneously by the UE using either a single receive (RX) spatial filter/panel, or multiple receive (RX) spatial filters/panels.

If groupBasedBeamReporting-mTRP or groupBasedBeamReportingR17 is not enabled while groupBasedBeamReporting is set to ‘enabled’, the UE could autonomously determine whether to report in a single reporting instance Mg≥2 SSBRIs and/or CRIs for the same TRP or for different TRPs. The UE is not expected to be configured with both groupBasedBeamReporting-mTRP/groupBasedBeamReportingR17 and groupBasedBeamReporting set to ‘enabled’.

How the UE would report in a single reporting instance Mg≥2 SSBRIs and/or CRIs for different coordinating TRPs depends on the specific CSI resource/reporting setting(s) and/or their association/mapping with the coordinating TRPs in the multi-TRP system, as described in Option-1a, b, c, d, Option-2a, b, c, d, and Option-3a, b, c. In the following, several mechanisms (reporting formats) of reporting in a single reporting instance the resource indicators such as SSBRIs and/or CRIs (and therefore, their corresponding beam metrics such as L1-RSRPs/L1-SINRs) for different coordinating TRPs in the multi-TRP system are presented.

In one example of Mechanism-1 for Option-1, for the multi-TRP system comprising of at least two TRPs, the UE could report in a single reporting instance Ng≥1 groups of resource indicators such as SSBRIs/CRIs; each group of resource indicators could contain at least two (Mg≥2) SSBRIs and/or CRIs, each determined/selected from or associated with one or more SSB or NZP CSI-RS resources configured in a different CSI resource setting. The UE could also report in the same reporting instance the beam metrics such as L1-RSRPs/L1-SINRs corresponding to the reported resource indicators such as SSBRIs/CRIs. In this case, the UE is expected to simultaneously receive the beams/resources corresponding to the Mg resource indicators such as SSBRIs/CRIs reported in the same group/pair of resource indicators using either a single RX spatial filter/panel or multiple RX spatial filters/panels.

In one example of Mechanism-1a for Option-1a, in one example (Mg=2), in each reported group of resource indicators such as SSBRIs/CRIs in the same reporting instance, the first resource indicator such as SSBRI or CRI corresponds to/is determined/selected from the SSB or NZP CSI-RS resources configured in the first configured CSI resource setting or the configured CSI resource setting with the lower CSI-ResourceConfigId, which could be further associated with/mapped to value 0 of CORESETPoolIndex, and the second resource indicator such as SSBRI or CRI corresponds to/is determined/selected from the SSB or NZP CSI-RS resources configured in the second configured CSI resource setting or the configured CSI resource setting with the higher CSI-ResourceConfigId, which could be further associated with/mapped to value 1 of CORESETPoolIndex.

In another example, in each reported group of resource indicators such as SSBRIs or CRIs in the same reporting instance, the first resource indicator such as SSBRI or CRI corresponds to/is determined/selected from the SSB or NZP CSI-RS resources configured in the first configured CSI resource setting (e.g., with the lowest CSI-ResourceConfigId), which could be further associated with/mapped to the first entry or the lowest (or the highest) TRP-specific index/ID value in the list of network configured TRP-specific index/ID values such as PCIs, the second resource indicator such as SSBRI or CRI corresponds to/is determined/selected from the SSB or CSI-RS resources configured in the second configured CSI resource setting (e.g., with the second lowest CSI-ResourceConfigId), which could be further associated with/mapped to the second entry or the second lowest (or the second highest) TRP-specific index/ID value in the list of network configured TRP-specific index/ID values such as PCIs, and so on, and the last (Mg-th) resource indicator such as SSBRI or CRI corresponds to/is determined/selected from the SSB or NZP CSI-RS resources configured in the last configured CSI resource setting (e.g., with the highest CSI-ResourceConfigId), which could be further associated with/mapped to the last entry or the highest (or the lowest) TRP-specific index/ID value in the list of network configured TRP-specific index/ID values such as PCIs.

Other mapping/association rules between the resource indicators in each reported group of resource indicators (and therefore, the corresponding beam metrics in each reported group of beam metrics) and the configured CSI resource settings in Option-1a (and therefore, the corresponding TRPs in the multi-TRP system) are also possible, and they should be known to the UE a prior.

In one example of Mechanism-1b for Option-1b, in each reported group of resource indicators such as SSBRIs/CRIs in the same reporting instance, the k-th resource indicator such as SSBRI or CRI corresponds to/is determined/selected from the SSB or NZP CSI-RS resources configured in the k-th configured CSI resource setting (e.g., with the k-th lowest CSI-ResourceConfigId), which could be further associated with/mapped to the k-th entry or the k-th highest/lowest TRP-specific higher layer signaling index value in the list of network configured TRP-specific higher layer signaling index values, where k=1, . . . , Mg. Other mapping/association rules between the resource indicators in each reported group of resource indicators (and therefore, the corresponding beam metrics in each reported group of beam metrics) and the configured CSI resource settings in Option-1b (and therefore, the corresponding TRPs in the multi-TRP system) are also possible, and they should be known to the UE a prior.

In another example, in each group of resource indicators, the first resource indicator such as SSBRI or CRI corresponds to/is determined from the CSI resource setting associated with the first entry in a higher layer configured list of TRP-specific higher layer signaling index values, such as TRP IDs, PCI values, CORESETPoolIndex values, SSB set IDs and/or etc., the second resource indicator such as SSBRI or CRI corresponds to/is determined from the CSI resource setting associated with the second entry in the list of TRP-specific higher layer signaling index values, and so on, and the last/Mg-th resource indicator such as SSBRI or CRI corresponds to/is determined from the CSI resource setting associated with the last entry in the list of TRP-specific higher layer signaling index values. Other mapping/association rules between the resource indicators in each group of resource indicators (and therefore, the corresponding beam metrics in each group of beam metrics) and the configured CSI resource settings in Option-1b (and therefore, the coordinating TRPs in the multi-TRP system) are also possible, and they may be known to the UE a prior.

In one example of Mechanism-1c for Option-1c, in each reported group of resource indicators such as SSBRIs/CRIs in the same reporting instance, the first resource indicator such as SSBRI or CRI corresponds to/is determined/selected from the SSB or NZP CSI-RS resources configured in the configured CSI resource setting with the lowest CSI-ResourceConfigId, the second resource indicator such as SSBRI or CRI corresponds to/is determined/selected from the SSB or NZP CSI-RS resources configured in the configured CSI resource setting with the second lowest CSI-ResourceConfigId, and so on, and the last (Mg-th) resource indicator such as SSBRI or CRI corresponds to/is determined/selected from the SSB or NZP CSI-RS resources configured in the configured CSI resource setting with the highest CSI-ResourceConfigId. Other mapping/association rules between the resource indicators in each reported group of resource indicators (and therefore, the corresponding beam metrics in each reported group of beam metrics) and the configured CSI resource settings in Option-1c (and therefore, the corresponding TRPs in the multi-TRP system) are also possible, and they should be known to the UE a prior.

In one example of Mechanism-1d for Option-1d, in each reported group of resource indicators such as SSBRIs/CRIs in the same reporting instance, each resource indicator such as SSBRI or CRI corresponds to/is determined/selected from one or more SSB or NZP CSI-RS resources configured in a different CSI resource setting. Predefined mapping/association rules between the resource indicators in each reported group of resource indicators (and therefore, the corresponding beam metrics in each reported group of beam metrics) and the configured CSI resource settings are not needed here, which is different from Mechanism-1a, Mechanism-1b and Mechanism-1c. This is because the SSB/NZP CSI-RS resources in one or more of the CSI resource settings are differently indexed.

In Mechanism-1a, Mechanism-1b and Mechanism-1c, the reported Mg resource indicators such as SSBRIs and/or CRIs in the same group of resource indicators could be the same (in terms of the resource indicator/index), while in Mechanism-1d, the reported Mg resource indictors such as SSBRIs and/or CRIs in the same group of resource indicators should be different because the SSB/NZP CSI-RS resources in one or more of the CSI resource settings are differently indexed.

In one example of Mechanism-2 for Option-2, for the multi-TRP system comprising of at least two TRPs, the UE could report in a single reporting instance Ng≥1 groups of resource indicators such as SSBRIs/CRIs; each group of resource indicators could contain at least two (Mg≥2) SSBRIs and/or CRIs, each determined/selected from or associated with one or more SSB or NZP CSI-RS resources configured in a different CSI-RS resource set configured in the CSI resource setting. The UE could also report in the same reporting instance the beam metrics such as L1-RSRPs/L1-SINRs corresponding to the reported resource indicators such as SSBRIs/CRIs. In this case, the UE is expected to simultaneously receive the beams/resources corresponding to the Mg resource indicators such as SSBRIs/CRIs in the same reported group/pair of resource indicators using either a single RX spatial filter/panel or multiple RX spatial filters/panels.

In one example of Mechanism-2a for Option-2a, in one example (Mg=2), in each reported group of resource indicators such as SSBRIs/CRIs in the same reporting instance, the first resource indicator such as SSBRI or CRI corresponds to/is determined/selected from the SSB or NZP CSI-RS resources configured in the first configured CSI-RS resource set, e.g., the first entry in the higher layer parameter csi-SSB-ResourceSetList/nzp-CSI-RS-ResourceSetList or provided by the higher layer parameter CSI-SSB-ResourceSet1/NZP-CSI-RS-ResourceSet1, or the configured CSI-RS resource set with a smaller resource set ID (e.g., provided by SSB-ResourceSetId/NZP-CSI-RS-ResourceSetId in SSB-ResourceSet1/NZP-CSI-RS-ResourceSet1), which could be further mapped to/associated with value 0 of CORESETPoolIndex, and the second resource indicator such as SSBRI or CRI corresponds to/is determined/selected from the SSB or NZP CSI-RS resources configured in the second configured CSI-RS resource set, e.g., the second entry in the higher layer parameter csi-SSB-ResourceSetList/nzp-CSI-RS-ResourceSetList or provided by the higher layer parameter CSI-SSB-ResourceSet2/NZP-CSI-RS-ResourceSet2, or the configured CSI-RS resource set with a larger resource set ID (e.g., provided by SSB-ResourceSetId/NZP-CSI-RS-ResourceSetId in SSB-ResourceSet2/NZP-CSI-RS-ResourceSet2), which could be further mapped to/associated with value 1 of CORESETPoolIndex.

In another example, in each reported group of resource indicators such as SSBRIs/CRIs in the same reporting instance, the first resource indicator such as SSBRI or CRI corresponds to/is determined/selected from the SSB or NZP CSI-RS resources configured in the first configured CSI-RS resource set (e.g., the first entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet or with the lowest SSB-ResourceSetId/NZP-CSI-RS-ResourceSetId in the corresponding higher layer parameter CSI-SSB-ResourceSet/NZP-CSI-RS-ResourceSet), which could be further mapped to/associated with the first entry or the lowest (or the highest) TRP-specific index/ID value in the list of network configured TRP-specific index/ID values such as PCIs, the second resource indicator such as SSBRI or CRI corresponds to/is determined/selected from the SSB or NZP CSI-RS resources configured in the second configured CSI-RS resource set (e.g., the second entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet or with the second lowest SSB-ResourceSetId/NZP-CSI-RS-ResourceSetId in the corresponding higher layer parameter CSI-SSB-ResourceSet/NZP-CSI-RS-ResourceSet), which could be further mapped to/associated with the second entry or the second lowest (or the second highest) TRP-specific index/ID value in the list of network configured TRP-specific index/ID values such as PCIs, and so on, and the last (Mg-th) resource indicator such as SSBRI or CRI corresponds to/is determined/selected from the SSB or NZP CSI-RS resources configured in the last configured CSI-RS resource set (e.g., the last entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet or with the highest SSB-ResourceSetId/NZP-CSI-RS-ResourceSetId in the corresponding higher layer parameter CSI-SSB-ResourceSet/NZP-CSI-RS-ResourceSet), which could be further mapped to/associated with the last entry or the highest (or the lowest) TRP-specific index/ID value in the list of network configured TRP-specific index/ID values such as PCIs.

Other mapping/association rules between the resource indicators in each reported group of resource indicators (and therefore, the corresponding beam metrics in each reported group of beam metrics) and the configured CSI-RS resource sets in the same CSI resource setting in Option-2a (and therefore, the corresponding TRPs in the multi-TRP system) are also possible, and they should be known to the UE a prior.

In one example of Mechanism-2b for Option-2b, in each reported group of resource indicators such as SSBRIs/CRIs in the same reporting instance, the k-th resource indicator such as SSBRI or CRI corresponds to/is determined/selected from the SSB or NZP CSI-RS resources configured in the k-th configured CSI-RS resource set, e.g., the k-th entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet, or the configured CSI-RS resource set with the k-th lowest resource set ID value (e.g., provided by NZP-CSI-RS-ResourceSetId/SSB-ResourceSetId in the corresponding CSI-SSB-ResourceSet/NZP-CSI-RS-ResourceSet), which could be further associated with/mapped to the k-th entry or the k-th highest/lowest TRP-specific higher layer signaling index value in the list of network configured TRP-specific higher layer signaling indexes, where k=1, . . . , Mg.

Other mapping/association rules between the resource indicators in each reported group of resource indicators (and therefore, the corresponding beam metrics in each reported group of beam metrics) and the configured CSI-RS resource sets in the same CSI resource setting in Option-2b (and therefore, the corresponding TRPs in the multi-TRP system) are also possible, and they should be known to the UE a prior.

In one example of Mechanism-2c for Option-2c, in each reported group of resource indicators such as SSBRIs/CRIs in the same reporting instance, the first resource indicator such as SSBRI or CRI corresponds to/is determined/selected from the SSB or NZP CSI-RS resources configured in the configured CSI-RS resource set with the lowest NZP-CSI-RS-ResourceSetId/SSB-ResourceSetId, the second resource indicator such as SSBRI or CRI corresponds to/is determined/selected from the SSB or NZP CSI-RS resources configured in the configured CSI-RS resource set with the second lowest NZP-CSI-RS-ResourceSetId/SSB-ResourceSetId, and so on, and the last (Mg-th) resource indicator such as SSBRI or CRI corresponds to/is determined/selected from the SSB or NZP CSI-RS resources configured in the configured CSI-RS resource set with the highest NZP-CSI-RS-ResourceSetId/SSB-ResourceSetId. Other mapping/association rules between the resource indicators in each reported group of resource indicators (and therefore, the corresponding beam metrics in each reported group of beam metrics) and the configured CSI-RS resource sets in the same CSI resource setting in Option-2c (and therefore, the corresponding TRPs in the multi-TRP system) are also possible, and they should be known to the UE a prior.

In one example of Mechanism-2d for Option-2d, in each reported group of resource indicators such as SSBRIs/CRIs in the same reporting instance, each resource indicator such as SSBRI or CRI corresponds to/is determined/selected from one or more SSB or NZP CSI-RS resources configured in a different CSI-RS resource set. Predefined mapping/association rules between the resource indicators in each reported group of resource indicators (and therefore, the corresponding beam metrics in each reported group of beam metrics) and the configured CSI-RS resource sets are not needed here, which is different from Mechanism-2a, Mechanism-2b and Mechanism-2c. This is because the SSB/NZP CSI-RS resources in one or more of the configured CSI-RS resource sets are differently indexed.

In Mechanism-2a, Mechanism-2b and Mechanism-2c, the reported Mg resource indicators such as SSBRIs and/or CRIs in the same group of resource indicators could be the same (in terms of the resource indicator/index), while in Mechanism-2d, the reported Mg resource indictors such as SSBRIs and/or CRIs in the same group of resource indicators should be different because the SSB/NZP CSI-RS resources are differently indexed in one or more of the CSI-RS resource sets configured in the same CSI resource setting.

In one example of Mechanism-3 for Option-3, for the multi-TRP system comprising of at least two TRPs, the UE could report in a single reporting instance Ng≥1 groups of resource indicators such as SSBRIs/CRIs; each group of resource indicators could contain at least two (Mg≥2) SSBRIs and/or CRIs, each determined/selected from or associated with one or more SSB or NZP CSI-RS resources configured in a different CSI-RS resource subset configured in the CSI-RS resource set. The UE could also report in the same reporting instance the beam metrics such as L1-RSRPs/L1-SINRs corresponding to the reported resource indicators such as SSBRIs/CRIs. In this case, the UE is expected to simultaneously receive the beams/resources corresponding to the Mg resource indicators such as SSBRIs/CRIs in the same group/pair of resource indicators using either a single RX spatial filter/panel or multiple RX spatial filters/panels. The UE could also report one or more CSI reports determined from measuring one or more SSB or NZP CSI-RS resources configured in different CSI-RS resource subsets in the CSI-RS resource set, where a CSI report includes at least one of: a rank indicator (RI), a CSI-RS resource indicator (CRI), a layer indicator (LI), a precoding matrix indicator (PMI), a channel quality indicator (CQI), a layer 1 RS received power (L1-RSRP), and a layer 1 signal to interference plus noise ratio (L1-SINR).

In one example of Mechanism-3a for Option-3a, in one example (Mg=2), in each reported group of resource indicators such as SSBRIs/CRIs in the same reporting instance, the first resource indicator such as SSBRI or CRI corresponds to/is determined/selected from the SSB or NZP CSI-RS resources configured in the first CSI-RS resource subset (e.g., containing the first half of the SSB/NZP CSI-RS resources in the corresponding CSI-RS resource set), e.g., the first entry in the higher layer parameter csi-SSB-ResourceSubSetList/nzp-CSI-RS-ResourceSubSetList or provided by the higher layer parameter CSI-SSB-ResourceSubSet1/NZP-CSI-RS-ResourceSubSet1, or the configured CSI-RS resource subset with a smaller resource subset ID (e.g., provided by SSB-ResourceSubSetId/NZP-CSI-RS-ResourceSubSetId in CSI-SSB-ResourceSubSet1/NZP-CSI-RS-ResourceSubSet1), which could be further mapped to/associated with value 0 of CORESETPoolIndex, and the second resource indicator such as SSBRI or CRI corresponds to/is determined/selected from the SSB or NZP CSI-RS resources configured in the second CSI-RS resource subset (e.g., containing the second half of the SSB/NZP CSI-RS resources in the corresponding CSI-RS resource set), e.g., the second entry in the higher layer parameter csi-SSB-ResourceSubSetList/nzp-CSI-RS-ResourceSubSetList or provided by the higher layer parameter CSI-SSB-ResourceSubSet2/NZP-CSI-RS-ResourceSubSet2, or the configured CSI-RS resource subset with a larger resource subset ID (e.g., provided by SSB-ResourceSubSetId/NZP-CSI-RS-ResourceSubSetId in CSI-SSB-ResourceSubSet2/NZP-CSI-RS-ResourceSubSet2), which could be further mapped to/associated with value 1 of CORESETPoolIndex.

Furthermore, the UE could also report two CSI reports determined from measuring one or more SSB or NZP CSI-RS resources configured in different CSI-RS resource subsets in the CSI-RS resource set. A first CSI report could be determined from measuring the SSB or NZP CSI-RS resources configured in the first CSI-RS resource subset (e.g., containing the first half of the SSB/NZP CSI-RS resources in the corresponding CSI-RS resource set), e.g., the first entry in the higher layer parameter csi-SSB-ResourceSubSetList/nzp-CSI-RS-ResourceSubSetList or provided by the higher layer parameter CSI-SSB-ResourceSubSet1/NZP-CSI-RS-ResourceSubSet1, or the configured CSI-RS resource subset with a smaller resource subset ID (e.g., provided by SSB-ResourceSubSetId/NZP-CSI-RS-ResourceSubSetId in CSI-SSB-ResourceSubSet1/NZP-CSI-RS-ResourceSubSet1), which could be further mapped to/associated with value 0 of CORESETPoolIndex, and a second CSI report is determined from measuring the SSB or NZP CSI-RS resources configured in the second CSI-RS resource subset (e.g., containing the second half of the SSB/NZP CSI-RS resources in the corresponding CSI-RS resource set), e.g., the second entry in the higher layer parameter csi-SSB-ResourceSubSetList/nzp-CSI-RS-ResourceSubSetList or provided by the higher layer parameter CSI-SSB-ResourceSubSet2/NZP-CSI-RS-ResourceSubSet2, or the configured CSI-RS resource subset with a larger resource subset ID (e.g., provided by SSB-ResourceSubSetId/NZP-CSI-RS-ResourceSubSetId in CSI-SSB-ResourceSubSet2/NZP-CSI-RS-ResourceSubSet2), which could be further mapped to/associated with value 1 of CORESETPoolIndex.

In another example, in each reported group of resource indicators, the first resource indicator such as SSBRI or CRI corresponds to/is determined/selected from the SSB or NZP CSI-RS resources configured in the first configured CSI-RS resource subset (e.g., containing the k₁ SSB/NZP CSI-RS resources in the corresponding CSI-RS resource set), e.g., the first entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the first entry or the lowest (or the highest) TRP-specific index/ID value in the list of network configured TRP-specific index/ID values such as PCIs, the second resource indicator such as SSBRI or CRI corresponds to/is determined/selected from the SSB or NZP CSI-RS resources configured in the second configured CSI-RS resource subset (e.g., containing the k₂ SSB/NZP CSI-RS resources in the corresponding CSI-RS resource set), e.g., the second entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the second lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the second entry or the second lowest (or the second highest) TRP-specific index/ID value in the list of network configured TRP-specific index/ID values such as PCIs, and so on, and the last (Mg-th) resource indicator such as SSBRI or CRI corresponds to/is determined/selected from the SSB or NZP CSI-RS resources configured in the last configured CSI-RS resource subset (e.g., containing the k_{Ms} SSB/NZP CSI-RS resources in the corresponding CSI-RS resource set), e.g., the last entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the highest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the last entry or the highest (or the lowest) TRP-specific index/ID value in the list of network configured TRP-specific index/ID values such as PCIs.

Furthermore, a first CSI report could be determined from measuring the SSB or NZP CSI-RS resources configured in the first configured CSI-RS resource subset (e.g., containing the k₁ SSB/NZP CSI-RS resources in the corresponding CSI-RS resource set), e.g., the first entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the first entry or the lowest (or the highest) TRP-specific index/ID value in the list of network configured TRP-specific index/ID values such as PCIs, a second CSI report could be determined from measuring the SSB or NZP CSI-RS resources configured in the second configured CSI-RS resource subset (e.g., containing the k₂ SSB/NZP CSI-RS resources in the corresponding CSI-RS resource set), e.g., the second entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the second lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the second entry or the second lowest (or the second highest) TRP-specific index/ID value in the list of network configured TRP-specific index/ID values such as PCIs, and so on, and a last (Mg-th) CSI report could be determined from measuring the SSB or NZP CSI-RS resources configured in the last configured CSI-RS resource subset (e.g., containing the k_{Ms} SSB/NZP CSI-RS resources in the corresponding CSI-RS resource set), e.g., the last entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the highest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the last entry or the highest (or the lowest) TRP-specific index/ID value in the list of network configured TRP-specific index/ID values such as PCIs.

Other mapping/association rules between the resource indicators in each reported group of resource indicators (and therefore, the corresponding beam metrics in each reported group of beam metrics) or the CSI reports and the configured CSI-RS resource subsets in the same CSI-RS resource set in Option-3a (and therefore, the corresponding TRPs in the multi-TRP system) are also possible, and they should be known to the UE a prior.

In one example of Mechanism-3b for Option-3b, in each reported group of resource indicators such as SSBRIs/CRIs in the same reporting instance, the k-th resource indicator such as SSBRI or CRI corresponds to/is determined/selected from the SSB or NZP CSI-RS resources configured in the k-th configured CSI-RS resource subset, e.g., the k-th entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the k-th lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the k-th entry or the k-th highest/lowest TRP-specific higher layer signaling index value in the list of network configured TRP-specific higher layer signaling indexes.

Furthermore, the k-th CSI report could be determined from measuring the SSB or NZP CSI-RS resources configured in the k-th configured CSI-RS resource subset, e.g., the k-th entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the k-th lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the k-th entry or the k-th highest/lowest TRP-specific higher layer signaling index value in the list of network configured TRP-specific higher layer signaling indexes.

Other mapping/association rules between the resource indicators in each reported group of resource indicators (and therefore, the corresponding beam metrics in each reported group of beam metrics) or the CSI reports and the configured CSI-RS resource subsets in the same CSI-RS resource set in Option-3b (and therefore, the corresponding TRPs in the multi-TRP system) are also possible, and they should be known to the UE a prior.

In one example of Mechanism-3c for Option-3c, in each reported group of resource indicators such as SSBRIs/CRIs in the same reporting instance, each resource indicator such as SSBRI or CRI corresponds to/is determined/selected from one or more SSB or NZP CSI-RS resources configured in a different CSI-RS resource subset. Furthermore, each CSI report could be determined from measuring one or more SSB or NZP CSI-RS resources configured in a different CSI-RS resource subset. Predefined mapping/association rules between the resource indicators in each reported group of resource indicators (and therefore, the corresponding beam metrics in each reported group of beam metrics) or the CSI reports and the configured CSI-RS resource subsets are not needed here, which is different from Mechanism-3a and Mechanism-3b.

In Mechanism-3a, Mechanism-3b and Mechanism-3c, the reported Mg resource indicators such as SSBRIs and/or CRIs in the same group of resource indicators should be different (in terms of the resource indicator/index) because the corresponding SSB/NZP CSI-RS resources are from the same CSI-RS resource set (i.e., they are indexed differently in the same CSI-RS resource set).

The UE could be indicated/configured by the network the exact values of Ng and/or Mg; this indication could be via higher layer (RRC) or/and MAC CE or/and DCI based signaling or/and any combination of at least two of RRC, MAC CE and DCI based signaling; this indication could be via a separate (dedicated) parameter or joint with another parameter. Alternatively, the UE could dynamically determine the exact values of Ng and/or Mg, and report one or more of them to the network along with/in part of the CSI/beam report(s).

The UE could be configured/indicated by the network the maximum values/upper limits of Ng and/or Mg via high layer RRC or/and MAC CE or/and DCI based signaling or/and any combination of at least two of RRC, MAC CE and DCI based signaling. Alternatively, the UE could autonomously determine the maximum values/upper limits of Ng and/or Mg, and report one or more of them to the network, e.g., along with/in part of the CSI/beam report(s). Denote the maximum values/upper limits of Ng and Mg by Ng_max and Mg_max. The UE could report in a single reporting instance up to Ng_max groups of resource indicators with each group containing up to Mg_max resource indicators such as SSBRIs/CRIs (and also the corresponding up to Ng_max groups of beam metrics with each group containing up to Mg_max beam metrics such as L1-RSRPs/L1-SINRs) for each reporting setting, where Ng_max≥1, Mg_max≥2.

For instance, for Ng_max=3 and Mg_max=2, the UE could report in a single reporting instance a single group of two resource indicators such as SSBRIs/CRIs (and also the corresponding beam metrics such as L1-RSRPs/L1-SINRs), or two groups of resource indicators each comprising of two resource indicators such as SSBRIs/CRIs (and also the corresponding beam metrics such as L1-RSRPs/L1-SINRs), or three groups of resource indicators each comprising of two resource indicators such as SSBRIs/CRIs (and also the corresponding beam metrics such as L1-RSRPs/L1-SINRs). The SSBRIs/CRIs in each reported group of resource indicators are determined/selected from or associated with one or more SSB or NZP CSI-RS resources configured in different CSI resource settings, different CSI-RS resource sets or/and different CSI-RS resource subsets (and therefore, the corresponding TRPs in the multi-TRP system) following Mechanism-1, Mechanism-2 or/and Mechanism-3 discussed above.

Alternatively, the UE could be configured/indicated by the network one or more candidate values for Ng and/or Mg via high layer RRC or/and MAC CE or/and DCI based signaling or/and any combination of at least two of RRC, MAC CE and DCI based signaling. Alternatively, the UE could autonomously determine the candidate value(s) for Ng and/or Mg, and report one or more of them to the network, e.g., along with/in part of the CSI/beam report(s).

Denote the sets containing the candidate value(s) for Ng and Mg by Ng_set and Mg_set. For example, Ng_set={1, 2, 3} and Mg_set={2}. For another example, Ng_set={1, 2, 4} and Mg_set={2, 3}. For instance, for Ng_set={1, 2, 3} and Mg_set={2}, the UE could report in a single reporting instance a single group of two resource indicators such as SSBRIs/CRIs (and also the corresponding beam metrics such as L1-RSRPs/L1-SINRs), or two groups of resource indicators each comprising of two resource indicators such as SSBRIs/CRIs (and also the corresponding beam metrics such as L1-RSRPs/L1-SINRs), or three groups of resource indicators each comprising of two resource indicators such as SSBRIs/CRIs (and also the corresponding beam metrics such as L1-RSRPs/L1-SINRs). The SSBRIs/CRIs in each reported group of resource indicators are associated with different CSI resource settings, different CSI-RS resource sets or/and different CSI-RS resource subsets (and therefore, the corresponding TRPs in the multi-TRP system) following Mechanism-1, Mechanism-2 or/and Mechanism-3 discussed above.

The UE could autonomously determine which reporting format(s)/mechanism(s) to follow (among Mechanism-1, Mechanism-2 and Mechanism-3) to group and report the resource indicators such as SSBRIs/CRIs (and therefore, the corresponding beam metrics such as L1-RSRPs/L1-SINRs). To avoid any ambiguities between the UE and the network sides, the UE could indicate to the network their determined/used reporting format(s)/mechanism(s). Alternatively, the UE could be configured/indicated by the network which reporting format(s)/mechanism(s) to follow (among Mechanism-1, Mechanism-2 and Mechanism-3) to group and report the resource indicators such as SSBRIs/CRIs (and therefore, the corresponding beam metrics such as L1-RSRPs/L1-SINRs); this indication could be via higher layer (RRC) or/and MAC CE or/and DCI based signaling; this indication could be via a separate (dedicated) parameter or joint with another parameter.

To associate between the resource indicators in each reported group/pair of resource indicators (and therefore the corresponding beam metrics) and the coordinating TRPs in the multi-TRP system, the UE could be higher layer indicated/configured by the network (a list of) one or more TRP-specific higher layer signaling index values, such as TRP IDs, PCI values, CORESETPoolIndex values, SSB set IDs and/or etc. Alternatively, the UE could report to the network (a list of) one or more TRP-specific higher layer signaling index values, such as TRP IDs, PCI values, CORESETPoolIndex values, SSB set IDs and/or etc. in the same reporting instance with the resource indicators/beam metrics. Further, the UE could indicate to the network how the resource indicators in each group/pair of resource indicators (and therefore, the corresponding beam metrics) are associated with the coordinating TRPs in the multi-TRP system.

The UE could be configured/indicated by the network a candidate set/pool of SSB/NZP CSI-RS resources/resource groups/pairs; this indication could be via higher layer (RRC) or/and MAC CE or/and DCI based signaling or/and any combination of at least two of RRC, MAC CE and DCI based signaling; this indication could be via a separate (dedicated) parameter or joint with another parameter. For instance, the UE could be higher layer configured/indicated by the network (e.g., via higher layer RRC signaling) a set/pool of N_cand≥1 groups/pairs of SSB/NZP CSI-RS resources/beams determined/selected from the SSB/NZP CSI-RS resources configured in different CSI resource settings, different CSI-RS resource sets and/or different CSI-RS resource subsets following Option-1, Option-2 and/or Option-3 in the present disclosure.

For instance, the UE could be higher layer RRC configured by the network a list of N_cand indexes to indicate the N_cand groups/pairs of SSB/NZP CSI-RS resources out of all possible (N_group≥1) groups/pairs of SSB/NZP CSI-RS resources determined/selected from the SSB/NZP CSI-RS resources configured in different CSI resource settings, different CSI-RS resource sets and/or different CSI-RS resource subsets following Option-1, Option-2 and/or Option-3 in the present disclosure. Optionally, the UE could receive from the network a MAC CE activation command/bitmap to activate M_cand≥1 groups/pairs of SSB/NZP CSI-RS resources/beams from the higher layer configured set/pool of N_cand groups/pairs of SSB/NZP CSI-RS resources/beams or all possible N_group groups/pairs of SSB/NZP CSI-RS resources/beams.

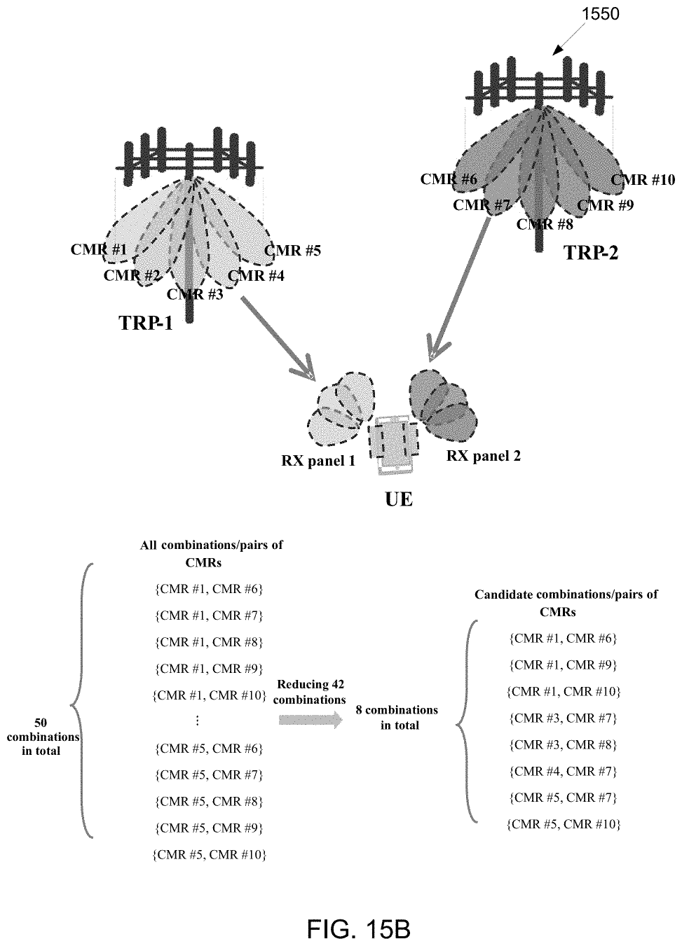

FIG. 15A illustrates an example bitmap indication for candidate RS resources selection 1500 according to embodiments of the present disclosure. An embodiment of the bitmap indication for candidate RS resources selection 1500 shown in FIG. 15A is for illustration only.

For example, the UE could receive from the network a bitmap with length N_cand or N_group. Each entry/bit position in the bitmap could correspond to a group/pair of SSB/NZP CSI-RS resources determined from the set/pool of N_cand groups/pairs of SSB/NZP CSI-RS resources or all possible N_group groups/pairs of SSB/NZP CSI-RS resources. The bitmap could contain at least M_cand ‘1’s (with other entries/bit positions in the bitmap configured as ‘0’s), indicating to the UE which M_cand groups/pairs of SSB/NZP CSI-RS resources are activated for measurement from the set/pool of N_cand groups/pairs of SSB/NZP CSI-RS resources or all possible N_group groups/pairs of SSB/NZP CSI-RS resources.

In FIG. 15A, an illustrative example of the bitmap indication of the candidate groups/pairs of SSB/NZP CSI-RS resources for beam measurement is provided. In this example, two CSI-RS resource subsets, CSI-RS resource subset 0 and CSI-RS resource subset 1, are configured, containing {CMR #1, CMR #2} and {CMR #3, CMR #4}, respectively. In this case, all possible groups/pairs of CMRs are {CMR #1, CMR #3}, {CMR #1, CMR #4}, {CMR #2, CMR #3} and {CMR #2, CMR #4}. The UE could receive from the network a bitmap of length N_group=4, with the first entry/bit position in the bitmap configured as ‘1’ (corresponding to {CMR #1, CMR #3}). Based on the bitmap configuration/indication, the UE would only perform the measurement on {CMR #1, CMR #3} and report to the network the corresponding measurement results.

For beam measurement, in one example, the UE could perform beam measurement on each group/pair of SSB/NZP CSI-RS resources from all possible N_group groups/pairs of SSB/NZP CSI-RS resources, and derive/evaluate the corresponding beam metrics such as L1-RSRPs/L1-SINRs; in another example, the UE could perform beam measurement on each group/pair of SSB/NZP CSI-RS resources from N_cand groups/pairs of SSB/NZP CSI-RS resources, and derive/evaluate the corresponding beam metrics such as L1-RSPRs/L1-SINRs; in yet another example, the UE could perform beam measurement on each group/pair of SSB/NZP CSI-RS resources from M_cand groups/pairs of SSB/NZP CSI-RS resources, and derive/evaluate the corresponding beam metrics such as L1-RSRPs/L1-SINRs.

In each group/pair of SSB/NZP CSI-RS resources, a SSB/NZP CSI-RS resource could be configured as a channel measurement resource (CMR) or an interference measurement resource (IMR) from a CSI resource setting or a CSI-RS resource set or a CSI-RS resource subset. For example, for a group of two SSB/NZP CSI-RS resources, the first SSB/NZP CSI-RS resource could be configured as a CMR from a CSI resource setting/CSI-RS resource set/CSI-RS resource subset following those specified in Option-1/Option-2/Option-3, and the second SSB/NZP CSI-RS resource could be configured as a CMR from a different CSI resource setting/CSI-RS resource set/CSI-RS resource subset following those specified in Option-1/Option-2/Option-3.

For another example, for a group of two SSB/NZP CSI-RS resources, the first SSB/NZP CSI-RS resource could be configured as a IMR from a CSI resource setting/CSI-RS resource set/CSI-RS resource subset following those specified in Option-1/Option-2/Option-3, and the second SSB/NZP CSI-RS resource could be configured as a CMR from a different CSI resource setting/CSI-RS resource set/CSI-RS resource subset following those specified in Option-1/Option-2/Option-3.

Yet for another example, for a group of two SSB/NZP CSI-RS resources, the first SSB/NZP CSI-RS resource could be configured as a CMR from a CSI resource setting/CSI-RS resource set/CSI-RS resource subset following those specified in Option-1/Option-2/Option-3, and the second SSB/NZP CSI-RS resource could be configured as a IMR from a different CSI resource setting/CSI-RS resource set/CSI-RS resource subset following those specified in Option-1/Option-2/Option-3.

Yet for another example, for a group of two SSB/NZP CSI-RS resources, the first SSB/NZP CSI-RS resource could be configured as a IMR from a CSI resource setting/CSI-RS resource set/CSI-RS resource subset following those specified in Option-1/Option-2/Option-3, and the second SSB/NZP CSI-RS resource could be configured as a IMR from a different CSI resource setting/CSI-RS resource set/CSI-RS resource subset following those specified in Option-1/Option-2/Option-3.

FIG. 15B illustrates an example configuring candidate groups/pairs of channel measurement resources (CMRs) 1550 according to embodiments of the present disclosure. An embodiment of configuring the candidate groups/pairs of channel measurement resources (CMRs) 1550 shown in FIG. 15B is for illustration only.

As illustrated in FIG. 15B, another illustrative example of configuring candidate groups/pairs of SSB/NZP CSI-RS resources for beam measurement in a multi-TRP system comprising of two TRPs (TRP-1 and TRP-2) is presented. In this example, NZP CSI-RS resources are assumed, and all of them are configured as CMRs and transmitted from the two coordinating TRPs, TRP-1 and TRP-2. For better illustration, the CMRs are indexed as {CMR #1, CMR #2, CMR #3, CMR #4, CMR #5} for TRP-1, and {CMR #6, CMR #7, CMR #8, CMR #9, CMR #10} for TRP-2. The actual configuration of the CMRs, and therefore the NZP CSI-RS resources (e.g., whether they are configured in two separate CSI resource settings or two separate CSI-RS resource sets or two separate CSI-RS resource subsets and etc.) and how they are associated with the coordinating TRPs in the multi-TRP system could follow those specified in Option-1, Option-2 and/or Option-3 in the present disclosure.

As can be seen from FIG. 15B, the total number of all possible groups/pairs of CMRs from TRP-1 and TRP-2 is 50. The UE could be configured by the network a subset of all possible groups/pairs of the CMRs from TRP-1 and TRP-2 via higher layer RRC based or/and MAC CE based or/and dynamic DCI based signaling or/and any combination of at least two of RRC, MAC CE and DCI based signaling. In the example shown in FIG. 15B, the UE could be configured/indicated by the network a set of 8 candidate CMR pairs ({CMR #1, CMR #6}, {CMR #1, CMR #9}, {CMR #1, CMR #10}, {CMR #3, CMR #7}, {CMR #3, CMR #8}, {CMR #4, CMR #7}, {CMR #5, CMR #7}, {CMR #5, CMR #10}), and the UE could only measure the configured candidate CMR pairs. After the beam measurement, the UE could determine/select one or more CMR pairs from the set of all candidate CMR pairs (8 candidate CMR pairs in the example shown in FIG. 15B) based on the corresponding measurement results/beam metrics such as L1-RSRPs or/and L1-SINRs. The UE could then report to the network the resource indicators such as CRIs corresponding to the CMRs in the selected CMR pair(s). Optionally, the UE could report to the network the index(es) of the selected CMR pair(s) in the set of all candidate CMR pairs.

As discussed above, the UE could report to the network in the same reporting instance the resource indicators such as SSBRIs/CRIs for the coordinating TRPs in the multi-TRP system and their corresponding beam metrics such as L1-RSRPs and/or L1-SINRs. For instance, for a multi-TRP system comprising of two TRPs, the UE could obtain two L1-RSRPs by measuring the CMR resources respectively configured for the two TRPs (e.g., configured in two separate CSI resource settings/CSI-RS resource sets/CSI-RS resource subsets). The UE could also obtain two L1-SINRs by measuring the CMR resources respectively configured for the two TRPs (e.g., configured in two separate CSI resource settings/CSI-RS resource sets/CSI-RS resource subsets). For example, consider the CMR pair {CMR #1, CMR #6} in FIG. 15B. For RX panel 1 at the UE, the UE could treat CMR #1 as the channel while CMR #6 as the interference to compute the corresponding L1-SINR (denoted by L1-SINR-1). Similarly, for RX panel 2, the UE could treat CMR #6 as the channel while CMR #1 as the interference to compute the corresponding L1-SINR (denoted by L1-SINR-2).

Similar to the examples shown in FIG. 12 and FIG. 13, for the group based beam reporting in a multi-TRP system, the UE could be higher layer configured/indicated (e.g., via higher layer RRC parameter CSI-ResourceConfig or CSI-ReportConfig) by the network a stopping RSRP/SINR threshold, denoted by stopThreshold-groupBasedBeamReporting-mTRP or stopThreshold-groupBasedBeamReportingR17. As long as the UE could determine that the beam metrics such as L1-RSRPs/L1-RSRPs corresponding to the resource indicators such as SSBRIs/CRIs for the coordinating TRPs in the multi-TRP system are beyond the configured threshold stopThreshold-groupBasedBeamReporting-mTRP or stopThreshold-groupBasedBeamReportingR17, the UE could stop measuring the remaining SSB/NZP CSI-RS resources from the coordinating TRPs.

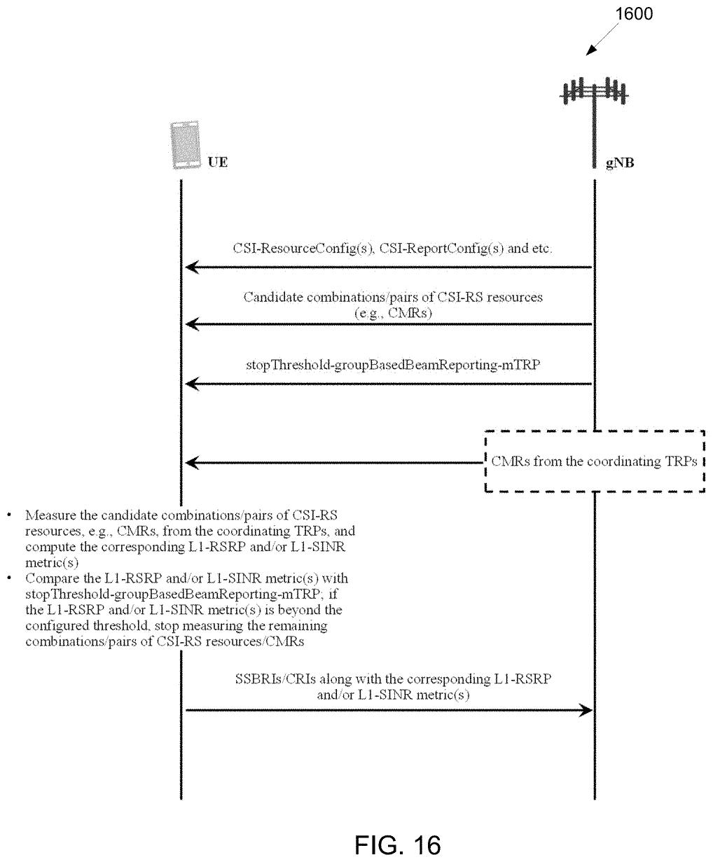

FIG. 16 illustrates a signaling flow 1600 between a UE and gNB for beam measurement and reporting according to embodiments of the present disclosure. An embodiment of the signaling flow 1600 shown in FIG. 16 is for illustration only. For example, the signaling flow 1600 may be implemented by a UE (e.g., 111-116 as illustrated in FIG. 1) and/or a gNB (e.g., BS 102 as illustrated in FIG. 2).

In FIG. 16, an illustrative example of network configuration assisted group based beam measurement and reporting for multi-TRP is provided. As can be seen from FIG. 16, the UE is higher layer configured by the network both stopThreshold-groupBasedBeamReporting-mTRP/stopThreshold-groupBasedBeamReportingR17 and candidate groups/pairs of SSB/NZP CSI-RS resources (a subset of all possible groups/pairs of SSB/NZP CSI-RS resources). By applying the configured stopping threshold when measuring the candidate groups/pairs of SSB/NZP CSI-RS resources, the UE could be able to quickly identify the resource indicators such as SSBRIs/CRIs and their corresponding beam metrics such as L1-RSRPs/L1-SINRs to be reported in the same reporting instance. In the example shown in FIG. 15B, the CMRs are assumed for both the coordinating TRPs (TRP-1 and TRP-2) in the multi-TRP system. The proposed design strategies could be extended/generalized/applied to the case where interference measurement resources (IMRs) are configured for one or more of the coordinating TRPs in the multi-TRP system.

In the above discussed CSI/beam reporting format(s) for the group based beam reporting for multi-TRP, the UE could report in a single reporting instance Ng≥1 groups of resource indicators such as SSBRIs/CRIs with each group of resource indicators containing at least two (Mg≥2) SSBRIs and/or CRIs selected/determined from one or more SSB or NZP CSI-RS resources configured in different CSI resource settings, different CSI-RS resource sets, or different CSI-RS resource subsets following those specified in Option-1, Option-2 or Option-3.

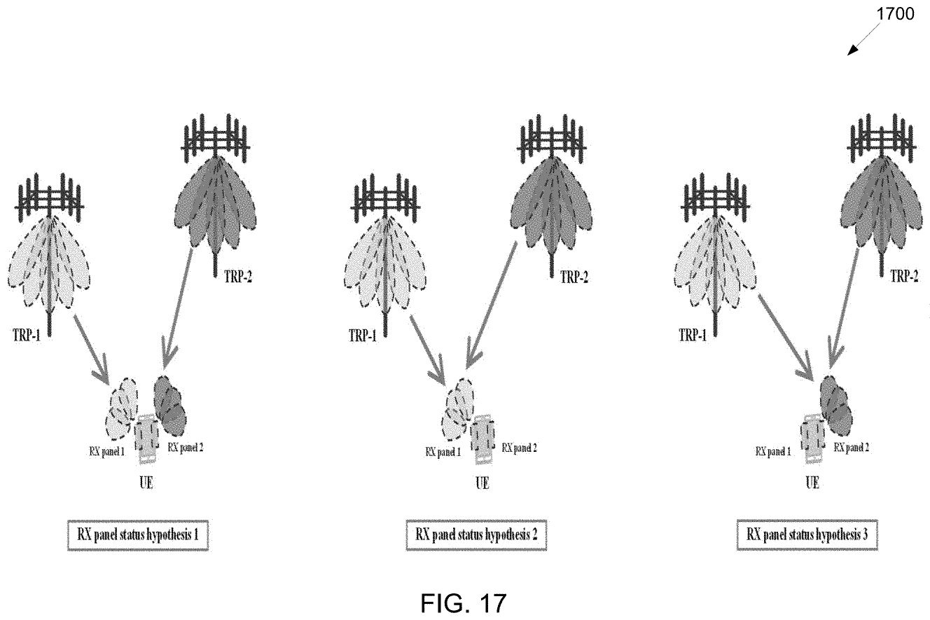

FIG. 17 illustrates an example beam measurement using different RX panels 1700 according to embodiments of the present disclosure. An embodiment of the beam measurement using different RX panels 1700 shown in FIG. 17 is for illustration only.

As can be seen from the illustrative example shown in FIG. 17, the UE could use (i) more than one RX panels such as both RX panel 1 and RX panel 2 to simultaneously receive/measure the SSB/NZP CSI-RS resources/beams configured in different CSI resource settings (Option-1), different CSI-RS resource sets (Option-2) or different CSI-RS resource subsets (Option-3), e.g., associated with TRP-1 and TRP-2 (RX receiving hypothesis 1), (ii) only a single RX panel such as RX panel 1 to simultaneously receive the SSB/NZP CSI-RS resources/beams configured in different CSI resource settings (Option-1), different CSI-RS resource sets (Option-2) or different CSI-RS resource subsets (Option-3), e.g., associated with TRP-1 and TRP-2 (RX receiving hypothesis 2), and (iii) only a single RX panel such as RX panel 2 to simultaneously receive the SSB/NZP CSI-RS resources/beams configured in different CSI resource settings (Option-1), different CSI-RS resource sets (Option-2) or different CSI-RS resource subsets (Option-3), e.g., associated with TRP-1 and TRP-2 (RX receiving hypothesis 3).

For each reported group of resource indicators such as SSBRIs/CRIs in the same reporting instance (and therefore, the corresponding reported group of beam metrics such as L1-RSRPs/L1-SINRs), the UE could indicate to the network the corresponding receiving hypothesis (e.g., from RX receiving hypothesis 1, RX receiving hypothesis 2 and RX receiving hypothesis 3).

In one example, for each reported group of resource indicators such as SSBRIs/CRIs, the UE could report to the network an associated receiving hypothesis index/indicator. Hence, in the same reporting instance of reporting the Ng groups of resource indicators, the UE could report to the network one or more (e.g., Ng) receiving hypothesis indexes/indicators, e.g., in part of the CSI/beam report(s), each corresponding to/associated with a reported group of resource indicators. For the example illustrated in FIG. 17, a receiving hypothesis index/indicator could be 1, 2 or 3, and the corresponding bitwidth is 2.

In another example, for each reported group of resource indicators such as SSBRIs/CRIs, the UE could report to the network an associated RX panel status. Hence, in the same reporting instance of reporting the Ng groups of resource indicators, the UE could report to the network one or more (e.g., Ng) RX panel status, e.g., in part of the CSI/beam report(s), each corresponding to/associated with a reported group of resource indicators. For the example illustrated in FIG. 17, a RX panel status could correspond to {‘ON’, ‘ON’ }, {‘ON’, ‘OFF’ }, {‘OFF’, ‘ON’ } or {‘OFF’, ‘OFF’ }. For each RX panel status {‘X’, ‘Y’ }, ‘X’=‘ON’ or ‘OFF’ could be for RX panel 1 and ‘Y’=‘ON’ or ‘OFF’ could be for RX panel 2. Based on the above discussions, a 2-bit indicator could be used to indicate one of the RX panel status.

In yet another example, for each reported group of resource indicators such as SSBRIs/CRIs, the UE could report to the network one or more associated RX panel IDs. Hence, in the same reporting instance of reporting the Ng groups of resource indicators, the UE could report to the network one or more (e.g., at least Ng) RX panel IDs, e.g., in part of the CSI/beam report(s), each corresponding to/associated with a reported group of resource indicators. For the example illustrated in FIG. 17, a RX panel ID could correspond to 1 or 2. For the RX receiving hypothesis 1, the UE could report two RX panel IDs 1 and 2; for the RX receiving hypothesis 2, the UE could report RX panel ID 1; for the RX receiving hypothesis 3, the UE could report RX panel ID 2. Alternatively, the UE could report to the network a 2-bit indicator to indicate {1,2}, {1} or {2} for RX panel ID(s).

For the example shown in TABLE 1, in a single reporting instance, the UE could report {CRI #1, CRI #10} for TRP-1 and TRP-2. The UE could also report in the same reporting instance the corresponding RX panel status and/or RX panel IDs to the network. In this example, the UE uses both RX panel 1 and RX panel 2 to simultaneously receive the NZP CSI-RS resources/beams from TRP-1 and TRP-2. Furthermore, the UE uses RX panel 1 to derive the CRI #1 for TRP-1, and RX panel 2 to derive the CRI #10 for TRP-2. In this case, the UE could report the RX panel status as {‘ON’, ‘ON’ } for RX panel 1 and RX panel 2, and/or the UE could report the RX panel IDs as {1,2} for RX panel 1 and RX panel 2, to the network.

TABLE 1
An illustrative example of relationship between
groups/pairs of CRIs and UE RX panel condition

| Group | Reported | UE RX panel status | UE RX panel IDs |
|---|---|---|---|
| index/reporting | groups/pairs | {RX panel 1, | {RX panel 1, |
| instance | of CRIs | RX panel 2} | RX panel 2} |
| 1 | {CRI #1, | {“ON,” “ON”} | {1, 2} |
| | CRI #10} | | |
| 2 | {CRI #1, | {“ON,” “OFF”} | {1} |
| | CRI #6} | | |
| 3 | {CRI #5, | {“OFF,” “ON”} | {2} |
| | CRI #10} | | |

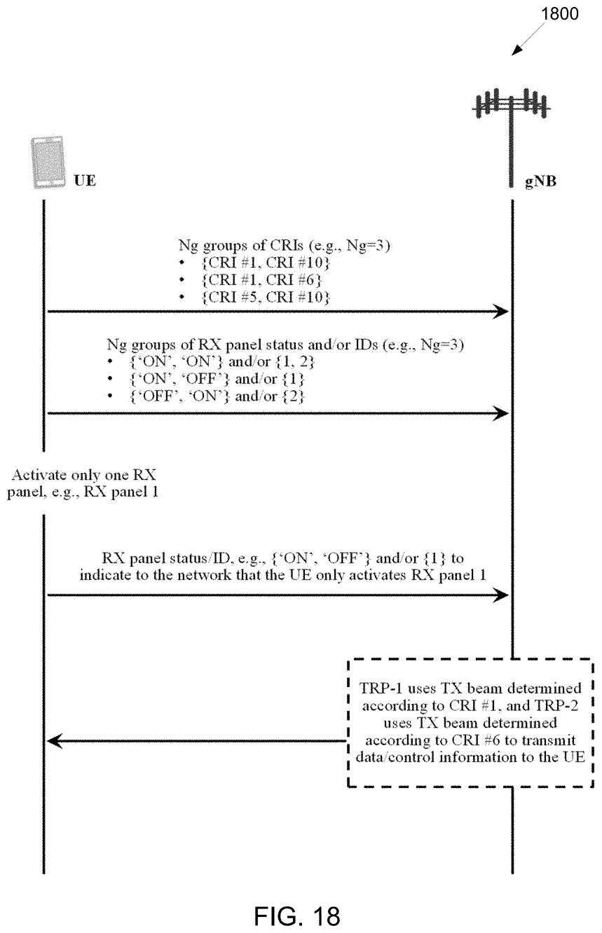

FIG. 18 illustrates a signaling flow 1800 between a UE and gNB for reporting RX panel condition to embodiments of the present disclosure. An embodiment of the signaling flow 1800 shown in FIG. 18 is for illustration only. For example, the signaling flow 1800 may be implemented by a UE (e.g., 111-116 as illustrated in FIG. 1) and/or a gNB (e.g., BS 102 as illustrated in FIG. 2).

In another example illustrated in FIG. 18, the UE could report to the network in the same reporting instance Ng=3 groups of CRIs, and they are {CRI #1, CRI #10}, {CRI #1, CRI #6} and {CRI #5, CRI #10}. In the same reporting instance of reporting the Ng=3 groups of CRIs, the UE could also report the corresponding RX panel status and/or RX panel IDs as the receiving hypothesis for each reported group of CRIs. In this example, the reported RX panel status and/or RX panel IDs are {‘ON’, ‘ON’}, {‘ON’, ‘OFF’}, {‘OFF’, ‘ON’} and/or {1, 2}, {1} and {2}. For instance, as the UE could use only RX panel 1 to simultaneously receive the NZP CSI-RS resources corresponding to the second reported group of CRIs {CRI #1, CRI #6}, the UE could report to the network a RX panel status {‘ON’, ‘OFF’} and/or a RX panel ID {1} for the second reported groups of CRIs.

The UE could be indicated/configured by the network one or more receiving hypothesis (e.g., from RX receiving hypothesis 1, RX receiving hypothesis 2 and RX receiving hypothesis 3) for beam measurement and reporting; this indication could be via higher layer (RRC) or/and MAC CE or/and DCI based signaling or/and any combination of at least two of RRC, MAC CE and DCI based signaling; this indication could be via a separate (dedicated) parameter or joint with another parameter. For example, the UE could be indicated by the network to use a single RX panel/spatial filter (e.g., RX receiving hypothesis 2 or RX receiving hypothesis 3) to simultaneously measure the SSB or NZP CSI-RS resources configured in different CSI resource settings (Option-1) or different CSI-RS resource sets (Option-2) or different CSI-RS resource subsets (Option-3)-associated with different TRPs in the multi-TRP system, and report in the same reporting instance one or more groups of resource indicators determined/selected from the measured SSB/NZP CSI-RS resources.

For another example, the UE could be indicated by the network to use more than one RX panels/spatial filters (e.g., RX receiving hypothesis 1) to simultaneously measure the SSB or NZP CSI-RS resources configured in different CSI resource settings (Option-1) or different CSI-RS resource sets (Option-2) or different CSI-RS resource subsets (Option-3)-associated with different TRPs in the multi-TRP system, and report in the same reporting instance one or more groups of resource indicators determined/selected from the measured SSB/NZP CSI-RS resources.

In one example, the UE could be indicated/configured by the network one or more receiving hypothesis indexes/indicators for one or more groups of resource indicators to be reported by the UE in the same reporting instance. For the example illustrated in FIG. 17, a receiving hypothesis index/indicator could be 1, 2 or 3, corresponding to RX receiving hypothesis 1, RX receiving hypothesis 2 or RX receiving hypothesis 3.

In another example, the UE could be indicated/configured by the network one or more RX panel status for one or more groups of resource indicators to be reported by the UE in the same reporting instance. For the example illustrated in FIG. 17, a RX panel status could correspond to {‘ON’, ‘ON’}, {‘ON’, ‘OFF’}, {‘OFF’, ‘ON’ } or {‘OFF’, ‘OFF’}. For each RX panel status {‘X’, ‘Y’}, ‘X’=‘ON’ or ‘OFF’ could be for RX panel 1 and ‘Y’=‘ON’ or ‘OFF’ could be for RX panel 2. Based on the above discussions, the UE could be configured with a 2-bit indicator indicating one of the RX panel status, and therefore, the corresponding receiving hypothesis.

In yet another example, the UE could be indicated/configured by the network one or more RX panel IDs for one or more groups of resource indicators to be reported by the UE in the same reporting instance. For the example illustrated in FIG. 17, a RX panel ID could correspond to 1 or 2. The UE could be configured with two RX panel IDs 1 and 2 for RX receiving hypothesis 1, a single RX panel ID 1 for RX receiving hypothesis 2, or a single RX panel ID 2 for RX receiving hypothesis 3. Alternatively, the UE could be configured by the network a 2-bit indicator to indicate {1,2}, {1} or {2} for RX panel ID(s), and therefore, the corresponding receiving hypothesis.

Due to various reasons such as UE's rotation, power consumption and etc., the UE could change their RX panel condition, e.g., switching from activating both RX panel 1 and RX panel 2 to activating only RX panel 1 while turning off RX panel 2. In this case, the UE could report to the network the current receiving hypothesis such as the corresponding receiving hypothesis index/indicator, the current RX panel status, e.g., {‘ON’, ‘OFF’ }, or the current RX panel ID information such as {1}. Based on the receiving hypothesis such as RX panel status and/or RX panel ID(s) reported by the UE, the network could configure appropriate beams/TCI states for the subsequent RSs/channels transmission from different TRPs in the multi-TRP system according to the group(s) of resource indicators such as SSBs/CRIs and the associated receiving hypothesis such as RX panel status and/or RX panel ID(s) previously reported by the UE.

In the example shown in FIG. 18, as the reported RX panel status/ID indicates that the UE only activates RX panel 1 for reception, the network would use/configure the SSB or NZP CSI-RS resource corresponding to/associated with CRI #1, and, the SSB or NZP CSI-RS resource corresponding to/associated with CRI #6 as the QCL source RSs in the TCI states indicated for the RSs/channels transmitted from TRP-1 and TRP-2, respectively. Note that the association between the assumptions of the RX panel status/ID with the reported groups of resource indicators could be predefined, and known to both the UE and the network. In this case, the UE may not need to report to the network the RX panel status and/or RX panels IDs assumed for generating the corresponding resource indicators such as SSBRIs/CRIs and their corresponding beam metrics such as L1-RSRPs/L1-SINRs.

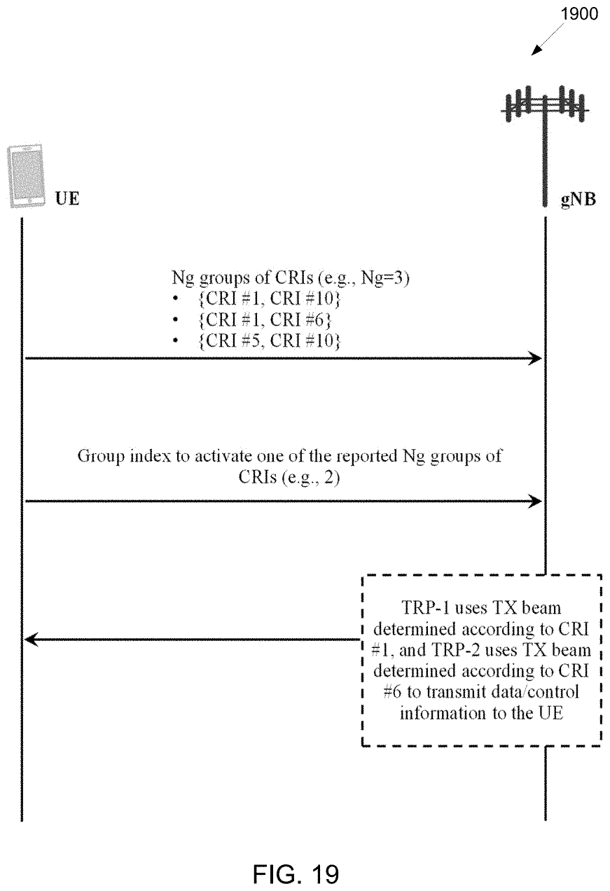

FIG. 19 illustrates a signaling flow 1900 between a UE and gNB for indicating a group of RS resources according to embodiments of the present disclosure. An embodiment of the signaling flow 1900 shown in FIG. 19 is for illustration only. For example, the signaling flow 1900 may be implemented by a UE (e.g., 111-116 as illustrated in FIG. 1) and/or a gNB (e.g., BS 102 as illustrated in FIG. 2).

In FIG. 19, another example of group based beam reporting and indication procedure for a multi-TRP system is provided. As illustrated in FIG. 19, after reporting in the same reporting instance Ng groups of resource indicators, the UE could indicate to the network a group index/ID, e.g., 2. Based on the group index/ID reported/indicated by the UE, the network could determine/configure appropriate beams/TCI states (and therefore, the corresponding QCL source RSs indicated therein) for the subsequent RSs/channels transmission from different TRPs in the multi-TRP system according to the group(s) of resource indicators such as SSBRIs/CRIs previously reported by the UE.

In the example shown in FIG. 18, as the reported group index/ID is 2, the network would use/configure the SSB or NZP CSI-RS resource corresponding to/associated with CRI #1, and, the SSB or NZP CSI-RS resource corresponding to/associated with CRI #6 as the QCL source RSs in the TCI states indicated for the RSs/channels transmitted from TRP-1 and TRP-2, respectively.

As discussed above, the UE could report in a single reporting instance Ng≥groups of resource indicators such as SSBRIs/CRIs with each group of resource indicators containing at least two (Mg≥2) SSBRIs and/or CRIs determined/selected from the SSB or NZP CSI-RS resources configured in different CSI resource settings, different CSI-RS resource sets or different CSI-RS resource subsets. The UE could also report in the same reporting instance the beam metrics such as L1-RSRPs/L1-SINRs corresponding to the reported resource indicators. The UE is expected to simultaneously receive the beams/resources corresponding to the resource indicators such as SSBRIs/CRIs in the same reported group/pair of resource indicators using either a single RX spatial filter/panel or multiple RX spatial filters/panels.

Alternatively, the UE could report in a single reporting instance Nh≥2 groups of resource indicators such as SSBRIs/CRIs with each group of resource indicators containing at least one (Mh≥1) resource indicator(s) such as SSBRI(s)/CRI(s). The resource indicator(s) such as SSBRI(s)/CRI(s) in the same reported group of resource indicator(s) could be for the same TRP, i.e., selected/determined from the SSB or NZP CSI-RS resources configured in the same CSI resource setting, the same CSI-RS resource set or the same CSI-RS resource subset, while the resource indicators such as SSBRIs/CRIs in different reported groups of resource indicators could be for different coordinating TRPs in the multi-TRP system, i.e., determined/selected from the SSB or NZP CSI-RS resources configured in different CSI resource settings (Option-1), different CSI-RS resource sets (Option-2) or different CSI-RS resource subsets (Option-3). The UE could also report in the same reporting instance the beam metrics such as L1-RSRPs/L1-SINRs corresponding to the reported resource indicators.

A higher layer parameter groupBasedBeamReporting-mTRP-ext or groupBasedBeamReportingR17Ext could be configured/incorporated/indicated in the corresponding CSI reporting setting, e.g., in the higher layer parameter CSI-ReportConfig, to turn on/off the group based beam reporting format discussed above. If groupBasedBeamReporting-mTRP-ext/groupBasedBeamReportingR17Ext is set to ‘enabled’, the UE shall report in a single reporting instance Nh≥2 groups of resource indicators such as SSBRIs/CRIs with each group of resource indicators containing at least one (Mh≥1) resource indicator(s) such as SSBRI(s)/CRI(s); furthermore, the resource indicator(s) such as SSBRI(s)/CRI(s) in the same reported group of resource indicator(s) could be for the same TRP, i.e., selected/determined from the SSB or NZP CSI-RS resources configured in the same CSI resource setting, the same CSI-RS resource set or the same CSI-RS resource subset, while the resource indicators such as SSBRIs/CRIs in different reported groups of resource indicators could be for different coordinating TRPs in the multi-TRP system, i.e., determined/selected from the SSB or NZP CSI-RS resources configured in different CSI resource settings (Option-1), different CSI-RS resource sets (Option-2) or different CSI-RS resource subsets (Option-3).

If groupBasedBeamReporting-mTRP-ext or groupBasedBeamReportingR17Ext is not enabled while groupBasedBeamReporting is set to ‘enabled’, the UE could autonomously determine whether to report in a single reporting instance Nh≥2 groups of SSBRIs and/or CRIs for the same TRP or for different TRPs. The UE is not expected to be configured with both groupBasedBeamReporting-mTRP-ext/groupBasedBeamReportingR17Ext and groupBasedBeamReporting set to ‘enabled’. In this case, the UE is expected to simultaneously receive the beams/resources corresponding to the resource indicators such as SSBRIs/CRIs in different reported groups/pairs of resource indicators using either a single RX spatial filter/panel or multiple RX spatial filters/panels. The corresponding CSI resource setting could follow those discussed in Option-1, Option-2 and Option-3 in the present disclosure, and the corresponding CSI reporting setting could follow those specified in Option-I and Option-II in the present disclosure.

In the following, several mechanisms (reporting formats) of reporting in a single reporting instance the SSBRIs and/or CRIs (and therefore, their corresponding beam metrics such as L1-RSRPs/L1-SINRs) for one or more TRPs are presented.

In one example of Mechanism-I for Option-1, for the multi-TRP system comprising of at least two TRPs, the UE could report in a single reporting instance Nh≥2 groups of resource indicators such as SSBRIs/CRIs; each group of resource indicators could contain at least one (Mh≥1) resource indicator such as SSBRI and/or CRI. The resource indicator(s) in the same reported group of resource indicator(s) could be determined/selected from/associated with one or more SSB or NZP CSI-RS resources configured in the same CSI resource setting; different resource indicators from different reported groups of resource indicators could be determined/selected from/associated with one or more SSB or NZP CSI-RS resources configured in different CSI resource settings. The UE could also report in the same reporting instance (group(s) of) beam metrics such as L1-RSRPs/L1-SINRs corresponding to the reported (group(s) of) resource indicators such as SSBRIs/CRIs.

In this case, the UE is expected to simultaneously receive the beams/resources corresponding to the resource indicators such as SSBRIs/CRIs from different reported groups/pairs of resource indicators using either a single RX spatial filter/panel or multiple RX spatial filters/panels; the UE, however, is not expected to simultaneously receive the beams/resources corresponding to the resource indicators such as SSBRIs/CRIs in the same reported group/pair of resource indicators using either a single RX spatial filter/panel or multiple RX spatial filters/panels.

In one example of Mechanism-Ia for Option-1a, in one example (Nh=2), the resource indicator(s) such as SSBRI(s)/CRI(s) in the first reported group of resource indicator(s) corresponds to/is determined/selected from the SSB or NZP CSI-RS resources configured in the first configured CSI resource setting or the configured CSI resource setting with the lower CSI-ResourceConfigId, which could be further mapped to/associated with value 0 of CORESETPoolIndex, and the resource indicator(s) such as SSBRI(s)/CRI(s) in the second reported group of resource indicator(s) corresponds to/is determined/selected from the SSB or NZP CSI-RS resources configured in the second configured CSI resource setting or the configured CSI resource setting with the higher CSI-ResourceConfigId, which could be further mapped to/associated with value 1 of CORESETPoolIndex.

In another example, the resource indicator(s) such as SSBRI(s)/CRI(s) in the k-th reported group of resource indicator(s) corresponds to/is determined/selected from the SSB or NZP CSI-RS resources configured in the (mod(k−1, N_0)+1)-th configured CSI resource setting (e.g., with the (mod(k−1, N_0)+1)-th lowest CSI-ResourceConfigId), which could be further mapped to/associated with the (mod(k−1, N_0)+1)-th entry or the (mod(k−1, N_0)+1)-th lowest (or the (mod(k−1, N_0)+1)-th highest) TRP-specific index/ID value in the list of network configured TRP-specific index/ID values such as PCIs, where k=1, . . . , Nh, N_0 is the total number of configured CSI resource settings, and mod(a,b)=a−└a/b┘×b. Other mapping/association rules between the Nh reported groups of resource indicators (and therefore, the corresponding Nh reported groups of beam metrics such as L1-RSRPs/L1-SINRs) and the N_0 configured CSI resource settings in Option-1a (and therefore, the corresponding TRPs in the multi-TRP system) are also possible, and they should be known to the UE a prior.

In one example of Mechanism-Ib for Option-1b, the resource indicator(s) such as SSBRI(s)/CRI(s) in the k-th reported group of resource indicator(s) corresponds to/is determined/selected from the SSB or NZP CSI-RS resources configured in the (mod(k−1, N_0)+1)-th configured CSI resource setting (e.g., with the (mod(k−1, N_0)+1)-th lowest CSI-ResourceConfigId), which could be further associated with/mapped to the (mod(k−1, N_0)+1)-th entry or the (mod(k−1, N_0)+1)-th highest/lowest TRP-specific higher layer signaling index value in the list of network configured TRP-specific higher layer signaling index values, where k=1, . . . , Nh, N_0 is the total number of configured CSI resource settings, and mod(a,b)=a−└a/b┘×b. Other mapping/association rules between the Nh reported groups of resource indicators (and therefore, the corresponding Nh reported groups of beam metrics such as L1-RSRPs/L1-SINRs) and the N_0 configured CSI resource settings in Option-1b (and therefore, the corresponding TRPs in the multi-TRP system) are also possible, and they should be known to the UE a prior.

In one example of Mechanism-Ic for Option-1c, the resource indicator(s) such as SSBRI(s)/CRI(s) in the k-th reported group of resource indicator(s) corresponds to/is determined/selected from the SSB or NZP CSI-RS resources configured in the CSI resource setting with the (mod(k−1, N_0)+1)-th lowest CSI-ResourceConfigId, where k=1, . . . , Nh, N_0 represents the total number of configured CSI resource settings, and mod(a,b)=a−└a/b┘×b. Other mapping/association rules between the Nh groups of resource indicators (and therefore, the corresponding Nh groups of beam metrics such as L1-RSRPs/L1-SINRs) and the N_0 configured CSI resource settings in Option-1c (and therefore, the corresponding TRPs in the multi-TRP system) are also possible, and they should be known to the UE a prior.

In one example of Mechanism-Id for Option-1d, the resource indicator(s) such as SSBRI(s)/CRI(s) in each reported group of resource indicator(s) corresponds to/is determined/selected from one or more SSB or NZP CSI-RS resources configured in a different CSI resource setting. Predefined mapping/association rules between the Nh groups of resource indicators (and therefore, the corresponding Nh groups of beam metrics such as L1-RSRPs/L1-SINRs) and the N_0 configured CSI resource settings are not needed here, which is different from Mechanism-Ia, Mechanism-Ib and Mechanism-Ic. This is because the SSB/NZP CSI-RS resources in one or more of the CSI resource settings are differently indexed.

In one example of Mechanism-II for Option-2, for the multi-TRP system comprising of at least two TRPs, the UE could report in a single reporting instance Nh≥2 groups of resource indicators such as SSBRIs/CRIs; each group of resource indicators could contain at least one (Mh≥1) resource indicator such as SSBRI and/or CRI. The resource indicator(s) in the same reported group of resource indicator(s) could be determined/selected from/associated with one or more SSB or NZP CSI-RS resources configured in the same CSI-RS resource set in the CSI resource setting; different resource indicators from different reported groups of resource indicators could be determined/selected from/associated with one or more SSB or NZP CSI-RS resources configured in different CSI-RS resource sets in the CSI resource setting. The UE could also report in the same reporting instance (group(s) of) beam metrics such as L1-RSRPs/L1-SINRs corresponding to the reported (group(s) of) resource indicators such as SSBRIs/CRIs.

In this case, the UE is expected to simultaneously receive the beams/resources corresponding to the resource indicators such as SSBRIs/CRIs from different reported groups/pairs of resource indicators using either a single RX spatial filter/panel or multiple RX spatial filters/panels; the UE, however, is not expected to simultaneously receive the beams/resources corresponding to the resource indicators such as SSBRIs/CRIs in the same reported group/pair of resource indicators using either a single RX spatial filter/panel or multiple RX spatial filters/panels.

In one example of Mechanism-IIa for Option-2a, in one example (Nh=2), the resource indicator(s) such as SSBRI(s)/CRI(s) in the first reported group of resource indicator(s) corresponds to/is determined/selected from the SSB or NZP CSI-RS resources configured in the first configured CSI-RS resource set, e.g., the first entry in the higher layer parameter csi-SSB-ResourceSetList/nzp-CSI-RS-ResourceSetList or provided by the higher layer parameter CSI-SSB-ResourceSet1/NZP-CSI-RS-ResourceSet1, or the configured CSI-RS resource set with a smaller resource set ID (e.g., provided by SSB-ResourceSetId/NZP-CSI-RS-ResourceSetId in SSB-ResourceSet1/NZP-CSI-RS-ResourceSet1), which could be further mapped to/associated with value 0 of CORESETPoolIndex, and the resource indicator(s) such as SSBRI(s)/CRI(s) in the second reported group of resource indicator(s) corresponds to/is determined/selected from the SSB or NZP CSI-RS resources configured in the second configured CSI-RS resource set, e.g., the second entry in the higher layer parameter csi-SSB-ResourceSetList/nzp-CSI-RS-ResourceSetList or provided by the higher layer parameter CSI-SSB-ResourceSet2/NZP-CSI-RS-ResourceSet2, or the configured CSI-RS resource set with a smaller resource set ID (e.g., provided by SSB-ResourceSetId/NZP-CSI-RS-ResourceSetId in SSB-ResourceSet2/NZP-CSI-RS-ResourceSet2), which could be further mapped to/associated with value 1 of CORESETPoolIndex.

In another example, the resource indicator(s) such as SSBRI(s)/CRI(s) in the k-th reported group of resource indicator(s) corresponds to/is determined/selected from the SSB or NZP CSI-RS resources configured in the (mod(k−1, N_1)+1)-th configured CSI-RS resource set (e.g., the (mod(k−1,N_1)+1)-th entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet or with the (mod(k−1,N_1)+1)-th lowest SSB-ResourceSetId/NZP-CSI-RS-ResourceSetId in the corresponding higher layer parameter CSI-SSB-ResourceSet/NZP-CSI-RS-ResourceSet), which could be further mapped to/associated with the (mod(k−1,N_1)+1)-th entry or the (mod(k−1,N_1)+1)-th lowest (or the (mod(k−1,N_1)+1)-th highest) TRP-specific index/ID value in the list of network configured TRP-specific index/ID values such as PCIs, where k=1, . . . , Nh, Ni is the total number of configured CSI-RS resource sets in the CSI resource setting, and mod(a,b)=a−└a/b┘×b.

Other mapping/association rules between the Nh groups of resource indicators (and therefore, the corresponding Nh groups of beam metrics such as L1-RSRPs/L1-SINRs) and the N_1 configured CSI-RS resource sets in the same CSI resource setting in Option-2a (and therefore, the corresponding TRPs in the multi-TRP system) are also possible, and they should be known to the UE a prior.

In one example of Mechanism-IIb for Option-2b, the resource indicator(s) such as SSBRI(s)/CRI(s) in the k-th reported group of resource indicator(s) corresponds to/is determined/selected from the SSB or NZP CSI-RS resources configured in the (mod(k−1,N_1)+1)-th CSI-RS resource set, e.g., the (mod(k−1,N_1)+1)-th entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet, or the configured CSI-RS resource set with the (mod(k−1,N_1)+1)-th lowest resource set ID value (e.g., provided by NZP-CSI-RS-ResourceSetId/SSB-ResourceSetId in the corresponding CSI-SSB-ResourceSet/NZP-CSI-RS-ResourceSet), which could be further associated with/mapped to the (mod(k−1,N_1)+1)-th entry or the (mod(k−1,N_1)+1)-th highest/lowest TRP-specific higher layer signaling index value in the list of network configured TRP-specific higher layer signaling indexes, where k=1, . . . , Nh, Ni is the total number of configured CSI-RS resources sets in the CSI resource setting, and mod(a,b)=a−└a/b┘×b.

Other mapping/association rules between the Nh groups of resource indicators (and therefore, the corresponding Nh groups of beam metrics such as L1-RSRPs/L1-SINRs) and the Ni configured CSI-RS resource sets in the same CSI resource setting in Option-2b (and therefore, the corresponding TRPs in the multi-TRP system) are also possible, and they should be known to the UE a prior.

In one example of Mechanism-IIc for Option-2c, the resource indicator(s) such as SSBRI(s)/CRI(s) in the k-th reported group of resource indicator(s) corresponds to/is determined/selected from the SSB or NZP CSI-RS resources configured in the CSI-RS resource set with the (mod(k−1,N_1)+1)-th lowest NZP-CSI-RS-ResourceSetId/SSB-ResourceSetId, where k=1, . . . , Nh, N_1 is the total number of configured CSI-RS resource sets in the CSI resource setting, and mod(a,b)=a−└a/b┘×b. Other mapping/association rules between the Nh groups of resource indicators (and therefore, the corresponding Nh groups of beam metrics such as L1-RSRPs/L1-SINRs) and the Ni configured CSI-RS resource sets in the same CSI resource setting in Option-2c (and therefore, the corresponding TRPs in the multi-TRP system) are also possible, and they should be known to the UE a prior.

In one example of Mechanism-IId for Option-2d, the resource indicator(s) such as SSBRI(s)/CRI(s) in each reported group of resource indicator(s) corresponds to/is determined/selected from one or more SSB or NZP CSI-RS resources configured in a different CSI-RS resource set. Predefined mapping/association rules between the Nh groups of resource indicators (and therefore, the corresponding Nh groups of beam metrics such as L1-RSRPs/L1-SINRs) and the N_1 configured CSI-RS resource sets are not needed here, which is different from Mechanism-IIa, Mechanism-IIb and Mechanism-IIc. This is because the SSB/NZP CSI-RS resources in one or more of the CSI-RS resource sets are differently indexed.

In one example of Mechanism-III for Option-3, for the multi-TRP system comprising of at least two TRPs, the UE could report in a single reporting instance Nh≥2 groups of resource indicators such as SSBRIs/CRIs; each group of resource indicators could contain at least one (Mh≥1) resource indicator such as SSBRI and/or CRI. The resource indicator(s) in the same reported group of resource indicator(s) could be determined/selected from/associated with one or more SSB or NZP CSI-RS resources configured in the same CSI-RS resource subset configured in the CSI-RS resource set; different resource indicators from different reported groups of resource indicators could be determined/selected from/associated with one or more SSB or NZP CSI-RS resources configured in different CSI-RS resource subsets configured in the CSI-RS resource set. The UE could also report in the same reporting instance (group(s) of) beam metrics such as L1-RSRPs/L1-SINRs corresponding to the reported (group(s) of) resource indicators such as SSBRIs/CRIs.

In this case, the UE is expected to simultaneously receive the beams/resources corresponding to the resource indicators such as SSBRIs/CRIs from different reported groups/pairs of resource indicators using either a single RX spatial filter/panel or multiple RX spatial filters/panels; the UE, however, is not expected to simultaneously receive the beams/resources corresponding to the resource indicators such as SSBRIs/CRIs in the same reported group/pair of resource indicators using either a single RX spatial filter/panel or multiple RX spatial filters/panels.

In one example of Mechanism-IIIa for Option-3a, in one example (Nh=2), the resource indicator(s) such as SSBRI(s)/CRI(s) in the first reported group of resource indicator(s) corresponds to/is determined/selected from the SSB or NZP CSI-RS resources configured in the first configured CSI-RS resource subset, e.g., containing the first half of the SSB/NZP CSI-RS resources configured in the CSI-RS resource set, which could be further mapped to/associated with value 0 of CORESETPoolIndex, and the resource indicator(s) such as SSBRI(s)/CRI(s) in the second reported group of resource indicator(s) corresponds to/is determined/selected from the SSB or NZP CSI-RS resources configured in the second configured CSI-RS resource subset, e.g., containing the second half of the SSB/NZP CSI-RS resources configured in the CSI-RS resource set, which could be further mapped to/associated with value 1 of CORESETPoolIndex.

In another example, the resource indicator(s) such as SSBRI(s)/CRI(s) in the k-th reported group of resource indicator(s) corresponds to/is determined/selected from the SSB or NZP CSI-RS resources configured in the (mod(k−1,N_2)+1)-th configured CSI-RS resource subset, e.g., the (mod(k−1,N_2)+1)-th entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the (mod(k−1,N_2)+1)-th lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the (mod(k−1,N_2)+1)-th entry or the (mod(k−1,N_2)+1)-th lowest (or the (mod(k−1,N_2)+1)-th highest) TRP-specific index/ID value in the list of network configured TRP-specific index/ID values such as PCIs, where k=1, . . . , Nh, N_2 is the total number of configured CSI-RS resource subsets in the same CSI-RS resource set, and mod(a,b)=a−└a/b┘×b.

Other mapping/association rules between the Nh reported groups of resource indicators (and therefore, the corresponding Nh reported groups of beam metrics such as L1-RSRPs/L1-SINRs) and the N_2 configured CSI-RS resource subsets in the same CSI-RS resource set in Option-3a (and therefore, the corresponding TRPs in the multi-TRP system) are also possible, and they should be known to the UE a prior.

In one example of Mechanism-IIIb for Option-3b, the resource indicator(s) such as SSBRI(s)/CRI(s) in the k-th reported group of resource indicator(s) corresponds to/is determined/selected from the SSB or NZP CSI-RS resources configured in the (mod(k−1,N_2)+1)-th configured CSI-RS resource subset, e.g., the (mod(k−1,N_2)+1)-th entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the (mod(k−1,N_2)+1)-th lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the (mod(k−1,N_2)+1)-th entry or the (mod(k−1,N_2)+1)-th highest/lowest TRP-specific higher layer signaling index value in the list of network configured TRP-specific higher layer signaling indexes, where k=1, . . . , Nh, N_2 is the total number of configured CSI-RS resource subsets in the same CSI-RS resource set, and mod(a,b)=a−└a/b┘×b.

Other mapping/association rules between the Nh reported groups of resource indicators (and therefore, the corresponding Nh reported groups of beam metrics such as L1-RSRPs/L1-SINRs) and the N_2 configured CSI-RS resource subsets in the same CSI-RS resource set in Option-3b (and therefore, the corresponding TRPs in the multi-TRP system) are also possible, and they should be known to the UE a prior.

In one example of Mechanism-IIIc for Option-3c, the resource indicator(s) such as SSBRI(s)/CRI(s) in each reported group of resource indicator(s) corresponds to/is determined/selected from one or more SSB or NZP CSI-RS resources configured in a different CSI-RS resource subset. Predefined mapping/association rules between the Nh groups of resource indicators (and therefore, the corresponding Nh groups of beam metrics such as L1-RSRPs/L1-SINRs) and the N_2 configured CSI-RS resource subsets are not needed here, which is different from Mechanism-IIIa and Mechanism-Mb.

In one example of Mechanism-IV for Option-1, for the multi-TRP system comprising of at least two TRPs, the UE could report in a single reporting instance Nh≥2 groups of resource indicators such as SSBRIs/CRIs; each reported group of resource indicators could contain at least one (Mh≥1) resource indicator such as SSBRI and/or CRI. The resource indicator(s) in the same reported group of resource indicator(s) could be determined/selected from/associated with one or more SSB or NZP CSI-RS resources configured in the same CSI resource setting; furthermore, different resource indicators from different reported groups of resource indicators could be determined/selected from/associated with one or more SSB or NZP CSI-RS resources configured in different CSI resource settings. The UE could also report in the same reporting instance (group(s) of) beam metrics such as L1-RSRPs/L1-SINRs corresponding to the reported (group(s) of) resource indicators such as SSBRIs/CRIs.

In this case, the UE is expected to simultaneously receive the beams/resources corresponding to the resource indicators such as SSBRIs/CRIs from different reported groups/pairs of resource indicators using either a single RX spatial filter/panel or multiple RX spatial filters/panels; furthermore, the UE is also expected to simultaneously receive the beams/resources corresponding to the resource indicators such as SSBRIs/CRIs in the same reported group/pair of resource indicators using either a single RX spatial filter/panel or multiple RX spatial filters/panels. The mapping/association between the Nh groups of resource indicators (and therefore, the corresponding Nh groups of beam metrics such as L1-RSRPs/L1-SINRs) and the N_0 configured CSI resource settings (and therefore, the corresponding TRPs in the multi-TRP system) could follow those discussed in Mechanism-Ia, Mechanism-Ib, Mechanism-Ic and Mechanism-Id.

In one example of Mechanism-V for Option-2, for the multi-TRP system comprising of at least two TRPs, the UE could report in a single reporting instance Nh≥2 groups of resource indicators such as SSBRIs/CRIs; each group of resource indicators could contain at least one (Mh≥1) resource indicator such as SSBRI and/or CRI. The resource indicator(s) in the same reported group of resource indicator(s) could be determined/selected from/associated with one or more SSB or NZP CSI-RS resources configured in the same CSI-RS resource set in the CSI resource setting; different resource indicators from different reported groups of resource indicators could be determined/selected from/associated with one or more SSB or NZP CSI-RS resources configured in different CSI-RS resource sets in the CSI resource setting. The UE could also report in the same reporting instance (group(s) of) beam metrics such as L1-RSRPs/L1-SINRs corresponding to the reported (group(s) of) resource indicators such as SSBRIs/CRIs.

In this case, the UE is expected to simultaneously receive the beams/resources corresponding to the resource indicators such as SSBRIs/CRIs from different reported groups/pairs of resource indicators using either a single RX spatial filter or multiple RX spatial filters; furthermore, the UE is also expected to simultaneously receive the beams/resources corresponding to the resource indicators such as SSBRIs/CRIs in the same reported group/pair of resource indicators using either a single RX spatial filter/panel or multiple RX spatial filters/panels. The mapping/association between the Nh groups of resource indicators (and therefore, the corresponding Nh groups of beam metrics such as L1-RSRPs/L1-SINRs) and the Ni configured CSI-RS resource sets in the same CSI resource setting (and therefore, the corresponding TRPs in the multi-TRP system) could follow those discussed in Mechanism-IIa, Mechanism-IIb, Mechanism-IIc and Mechanism-IId.

In one example of Mechanism-VI for Option-3, for the multi-TRP system comprising of at least two TRPs, the UE could report in a single reporting instance Nh≥2 groups of resource indicators such as SSBRIs/CRIs; each reported group of resource indicators could contain at least one (Mh≥1) resource indicator such as SSBRI and/or CRI. The resource indicator(s) in the same reported group of resource indicator(s) could be determined/selected from/associated with one or more SSB or NZP CSI-RS resources configured in the same CSI-RS resource subset configured in the CSI-RS resource set; different resource indicators from different reported groups of resource indicators could be determined/selected from/associated with one or more SSB or NZP CSI-RS resources configured in different CSI-RS resource subsets configured in the CSI-RS resource set. The UE could also report in the same reporting instance (group(s) of) beam metrics such as L1-RSRPs/L1-SINRs corresponding to the reported (group(s) of) resource indicators such as SSBRIs/CRIs.

In this case, the UE is expected to simultaneously receive the beams/resources corresponding to the resource indicators such as SSBRIs/CRIs from different reported groups/pairs of resource indicators using either a single RX spatial filter/panel or multiple RX spatial filters/panels; furthermore, the UE is also expected to simultaneously receive the beams/resources corresponding to the resource indicators such as SSBRIs/CRIs in the same reported group/pair of resource indicators using either a single RX spatial filter/panel or multiple RX spatial filters/panels. The mapping/association between the Nh groups of resource indicators (and therefore, the corresponding Nh groups of beam metrics such as L1-RSRPs/L1-SINRs) and the N_2 configured CSI-RS resource subsets in the same CSI-RS resource set (and therefore, the corresponding TRPs in the multi-TRP system) could follow those discussed in Mechanism-IIIa, Mechanism-IIIb and Mechanism-IIIc.

As discussed above, the UE is expected to simultaneously receive the beams/resources corresponding to the resource indicators such as SSBRIs/CRIs across/from different reported groups/pairs of resource indicators in the same reporting instance. Consider the example shown in FIG. 15B, wherein the NZP CSI-RS resources are configured as CMRs and transmitted from the two coordinating TRPs, TRP-1 and TRP-2, i.e., {CMR #1, CMR #2, CMR #3, CMR #4, CMR #5} for TRP-1, and {CMR #6, CMR #7, CMR #8, CMR #9, CMR #10} for TRP-2. Furthermore, it is assumed that all possible groups/pairs of CMRs that can be simultaneously received by the UE (either using a single RX spatial filter/panel or multiple RX spatial filters/panels) are {CMR #1, CMR #7}, {CMR #1, CMR #8}, {CMR #3, CMR #6} and {CMR #3, CMR #8}.

In this case, the UE could only report to the network in a single reporting instance {CRI #1} and {CRI #7, CRI #8} for a given reporting setting/configuration. Upon receiving the reported CRIs, the network would know that the beams/resources corresponding to the two CRIs in {CRI #1, CRI #7} or {CRI #1, CRI #8} (i.e., CRIs across different groups/pairs) can be simultaneously received by the UE. In this example, CRI #3 cannot be in any part of the report because the UE is not expected to simultaneously receive the beams/resources corresponding to {CMR #3, CMR #7}. Similarly, for a given reporting setting/configuration, the UE could only report to the network in a single reporting instance {CRI #3} and {CRI #6, CRI #8}. In this case, CRI #1 cannot be in any part of the report because the UE is not expected to simultaneously receive the beams/resources corresponding to the CRIs in {CMR #1, CMR #6}. Upon receiving the reported CRIs, the network would know that the beams/resources corresponding to the two CRIs in {CMR #3, CMR #6} or {CMR #3, CMR #8} could be simultaneously received by the UE.

In Mechanism-IV, Mechanism-V and Mechanism-VI, the UE is expected to simultaneously receive the beams/resources corresponding to the resource indicators such as SSBRIs/CRIs within the same reported group/pair of resource indicators. This is in addition to the assumption that the UE is expected to simultaneously receive the beams/resources corresponding to the resource indicators such as SSBRIs/CRIs across/from different reported groups/pairs of resource indicators. The reporting formats/mechanisms developed in Mechanism-IV, Mechanism-V and Mechanism-VI could better enable the simultaneous multi-RX-panel reception at the UE side. That is, the UE could use the same RX panel to simultaneously receive the beams/resources corresponding to the resource indicators such as SSBRIs/CRIs within the same reported group/pair of resource indicators, while the UE could use different RX panels to simultaneously receive the beams/resources corresponding to the resource indicators such as SSBRIs/CRIs across/from different reported groups/pairs of resource indicators.

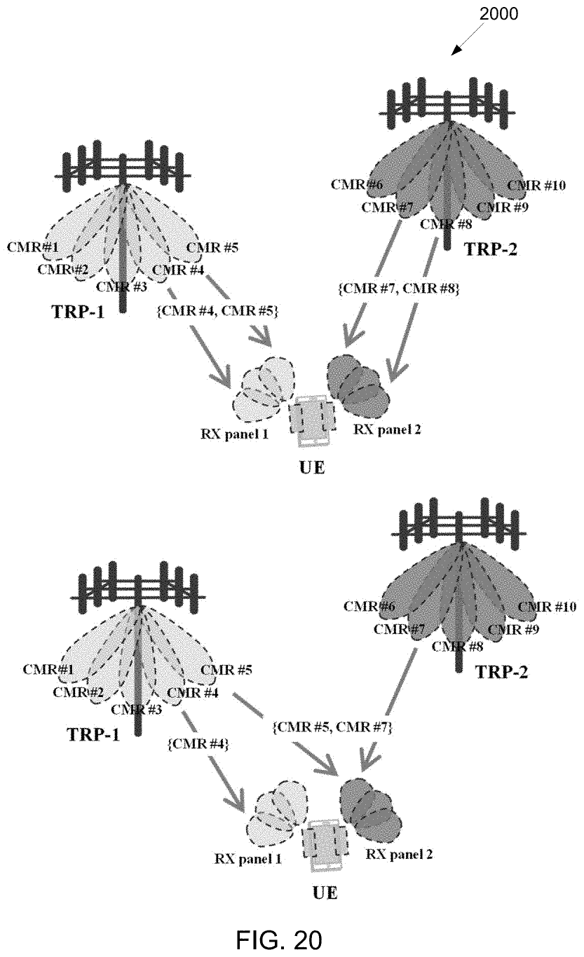

FIG. 20 illustrates an example beam measurement using two RX panels 2000 according to embodiments of the present disclosure. An embodiment of the beam measurement using two RX panels 2000 shown in FIG. 20 is for illustration only.

Two conceptual examples illustrating the simultaneous multi-RX-panel reception are depicted in FIG. 20. As can be seen from the left-hand-side (LHS) in FIG. 20, the UE could use their RX panel 1 to simultaneously receive CMR #4 and CMR #5 from TRP-1, and their RX panel 2 to simultaneously receive CMR #7 and CMR #8 from TRP-2. Furthermore, the UE could use both RX panel 1 and RX panel 2 to simultaneously receive {CMR #4, CMR #7}, {CMR #4, CMR #8}, {CMR #5, CMR #7} or {CMR #5, CMR #8} from both TRP-1 and TRP-2. In this case, the UE could report to the network in a single reporting instance {CRI #4, CRI #5} and {CRI #7, CRI #8}, and the network would know which TX beams to form such that they can be simultaneously received by the UE through either a single RX panel or across multiple RX panels. Another example is given on the right-hand-side (RHS) in FIG. 20. In this example, the reported CRIs within the same reported group/pair of CRIs could be from different TRPs.

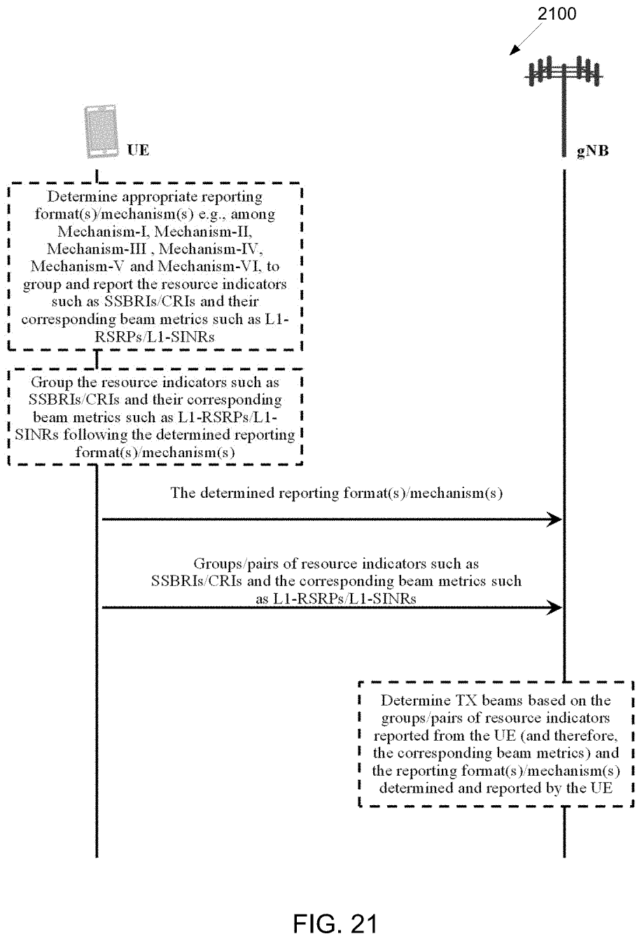

FIG. 21 illustrates a signaling flow 2100 between a UE and gNB for indicating one or more beam reporting formats according to embodiments of the present disclosure. An embodiment of the signaling flow 2100 shown in FIG. 21 is for illustration only. For example, the signaling flow 2100 may be implemented by a UE (e.g., 111-116 as illustrated in FIG. 1) and/or a gNB (e.g., BS 102 as illustrated in FIG. 2).

The UE could autonomously determine which reporting format(s)/mechanism(s) to follow (among Mechanism-I, Mechanism-II, Mechanism-III, Mechanism-IV, Mechanism-V and Mechanism-VI) to group and report the resource indicators such as SSBRIs/CRIs (and therefore, the corresponding beam metrics such as L1-RSRPs/L1-SINRs). For instance, if the UE activates all their RX panels and the channel is rich scattered, the UE could use Mechanism-IV, Mechanism-V or Mechanism-VI to group and report the SSBRIs/CRIs. To avoid any ambiguities between the UE and the network sides, the UE could indicate to the network their determined/used reporting format(s)/mechanism(s).

Alternatively, the UE could be configured/indicated by the network which reporting format(s)/mechanism(s) to follow (among Mechanism-I, Mechanism-II, Mechanism-III, Mechanism-IV, Mechanism-V and Mechanism-VI) to group and report the resource indicators such as SSBRIs/CRIs (and therefore, the corresponding beam metrics such as L1-RSRPs/L1-SINRs); this indication could be via higher layer (RRC) or/and MAC CE or/and DCI based signaling or/and any combination of at least two of RRC, MAC CE and DCI based signaling; this indication could be via a separate (dedicated) parameter or joint with another parameter. In FIG. 21, the UE initiated reporting format(s)/mechanism(s) selection is presented.

The UE could report the resource indicators such as SSBRIs/CRIs (and therefore, the corresponding beam metrics such as L1-RSRPs/L1-SINRs) to one or more of the coordinating TRPs, having (1) the most recent UL channels/resources (PUCCHs/PUSCHs) to carry/convey the beam reports comprising of the resource indicators such as SSBRIs/CRIs and the corresponding beam metrics such as L1-RSRPs/L1-SINRs, (2) the most available UL channels/resources (PUCCHs/PUSCHs) to carry/convey the beam reports comprising of the resource indicators such as SSBRIs/CRIs and the corresponding beam metrics such as L1-RSRPs/L1-SINRs, and/or (3) the smallest propagation delay between the UE among all coordinating TRPs in the multi-TRP system.

Upon receiving the CSI/beam report(s), the TRP(s) could send the received CSI/beam report(s) to other coordinating TRPs through backhaul so that all the coordinating TRPs in the multi-TRP system would know which TX beams to use/form to communicate with the UE. Sharing the CSI/beam report(s) among the coordinating TRPs could only be feasible if the backhaul latency is negligible, e.g., ideal backhaul. For non-ideal backhaul with tens of milliseconds latency, the UE could be configured by the network a single CSI reporting setting (P=1) with multiple CSI-report's or multiple CSI reporting settings (P>1) to report the CSI/beam reports for/to different coordinating TRPs in the multi-TRP system. The association/mapping between the CSI-report's/CSI reporting settings and the CSI resource settings/CSI-RS resource sets/CSI-RS resource subsets (and therefore, the corresponding TRPs in the multi-TRP system) could follow those specified in Option-I and Option-II in the present disclosure.

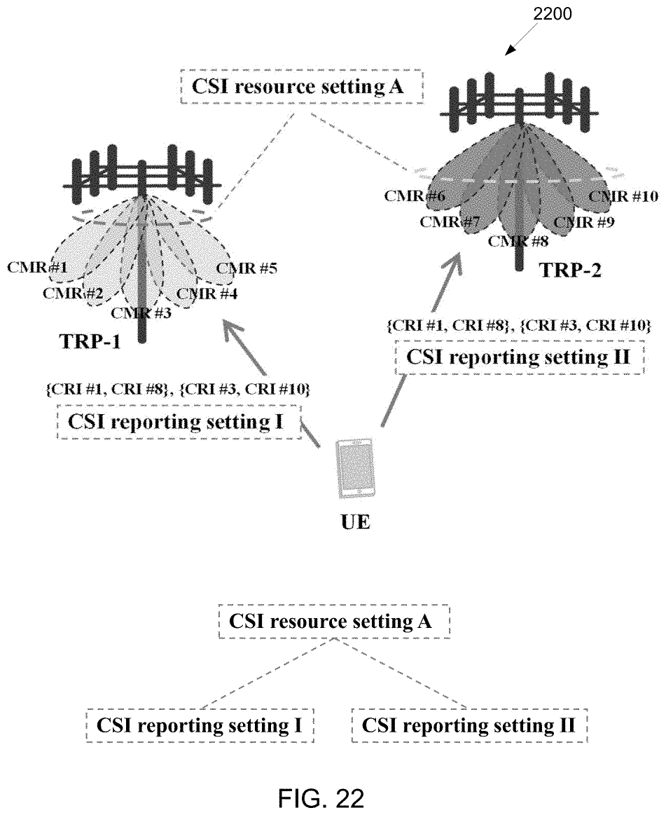

FIG. 22 illustrates an example beam measurement and reporting 2200 according to embodiments of the present disclosure. An embodiment of the beam measurement and reporting 2200 shown in FIG. 22 is for illustration only.

In one example, the UE could report in separate reporting instances the same resource indicators such as SSBRIs/CRIs (and therefore, the corresponding beam metrics such as L1-RSRPs/L1-SINRs) to different coordinating TRPs in the multi-TRP system according to the configured CSI-report's and/or P>1 CSI reporting settings. In FIG. 22, a conceptual example illustrating the proposed separate CSI/beam reporting strategy is presented for a multi-TRP system comprising of two coordinating TRPs, TRP-1 and TRP-2. As can be seen from FIG. 22, the UE is configured by the network a single CSI resource setting (CSI resource setting A) comprising of two CSI-RS resource sets each corresponding to a TRP ({CMR #1, CMR #2, CMR #3, CMR #4, CMR #5} for TRP-1 and ({CMR #6, CMR #7, CMR #8, CMR #9, CMR #10} for TRP-2).

Furthermore, CSI resource setting A is linked to/associated with two CSI reporting settings, CSI reporting setting I and CSI reporting setting II, corresponding to TRP-1 and TRP-2 respectively. In this example, the UE determines two groups/pairs of CRIs {CRI #1, CRI #8} and {CRI #3, CRI #10}, and reports them in two separate reporting instances according to CSI reporting setting I and CSI reporting setting II, respectively. That is, both TRP-1 and TRP-2 would obtain the two groups/pairs of CRIs {CRI #1, CRI #8} and {CRI #3, CRI #10} reported from the UE without backhaul coordination.

In another example, the UE could report in separate reporting instances different resource indicators such as SSBRIs/CRIs (and therefore, their corresponding beam metrics such as L1-RSRPs/L1-SINRs) to different coordinating TRPs in the multi-TRP system according to the configured CSI-report's and/or P>1 CSI reporting settings. The UE could also indicate to the network whether/how the beam reports in separate reporting instances (corresponding to separate CSI-report's/CSI reporting settings) are associated.

In this case, the UE is expected to simultaneously receive the beams/resources corresponding to the resource indicators such as SSBRIs/CRIs reported in separate associated reporting instances (corresponding to separate associated CSI-report's/CSI reporting settings) using either a single RX spatial filter/panel or multiple RX spatial filters/panels. The CSI resource setting could follow those discussed in Option-1, Option-2 and Option-3 in the present disclosure, and the CSI reporting setting could follow those discussed in Option-I and Option-II in the present disclosure.

In the following, several mechanisms (reporting formats) of reporting in separate reporting instances (corresponding to separate CSI-report's/CSI reporting settings) the SSBRIs and/or CRIs (and therefore, their corresponding beam metrics such as L1-RSRPs/L1-SINRs) for/to different coordinating TRPs in the multi-TRP system are presented (also referred to as non-group based beam reporting for multi-TRP).

In one example of Mechanism-A for Option-1, for the multi-TRP system comprising of at least two TRPs, the UE could report in Nh≥2 reporting instances (corresponding to Nh CSI-report's/CSI reporting settings) one or more resource indicators such as SSBRIs/CRIs (and therefore, their corresponding beam metrics such as L1-RSRPs/L1-SINRs) with at least one (Mh≥1) resource indicator such as SSBRI and/or CRI (and the corresponding beam metric such as L1-RSRP/L1-SINR) per reporting instance. The resource indicator(s) reported in the same reporting instance (corresponding to the same CSI-report/CSI reporting setting) could be determined/selected from/associated with one or more SSB or NZP CSI-RS resources configured in the same CSI resource setting; different resource indicators reported in different reporting instances (corresponding to different CSI-report's/CSI reporting settings) could be determined/selected from/associated with one or more SSB or NZP CSI-RS resources configured in different CSI resource settings. The UE could also report in Nh reporting instances the beam metrics such as L1-RSRPs/L1-SINRs corresponding to the reported resource indicators such as SSBRIs/CRIs.

In this case, the UE is expected to simultaneously receive the beams/resources corresponding to the resource indicators such as SSBRIs/CRIs reported in separate associated reporting instances (corresponding to separate associated CSI-report's/CSI reporting settings) using either a single RX spatial filter/panel or multiple RX spatial filters/panels; the UE, however, is not expected to simultaneously receive the beams/resources corresponding to the resource indicators such as SSBRIs/CRIs reported in the same reporting instance (corresponding to the same CSI-report/CSI reporting setting) using either a single RX spatial filter/panel or multiple RX spatial filters/panels.

In one example of Mechanism-Aa for Option-1a, in one example (Nh=2), the resource indicator(s) such as SSBRI(s)/CRI(s) reported in the first reporting instance (corresponding to the first CSI-report/CSI reporting setting configured in Option-I/II) corresponds to/is determined/selected from the SSB or NZP CSI-RS resources configured in the first configured CSI resource setting or the configured CSI resource setting with the lower CSI-ResourceConfigId, which could be further associated with/mapped to value 0 of CORESETPoolIndex, and the resource indicator(s) such as SSBRI(s)/CRI(s) reported in the second reporting instance (corresponding to the second CSI-report/CSI reporting setting configured in Option-I/II) corresponds to/is determined/selected from the SSB or NZP CSI-RS resources configured in the second configured CSI resource setting or the configured CSI resource setting with the higher CSI-ResourceConfigId, which could be further associated with/mapped to value 1 of CORESETPoolIndex.

In another example, the resource indicator(s) such as SSBRI(s)/CRI(s) reported in the first reporting instance (corresponding to the first CSI-report/CSI reporting setting configured in Option-I/II) corresponds to/is determined/selected from the SSB or NZP CSI-RS resources configured in the first configured CSI resource setting (e.g., with the lowest CSI-ResourceConfigId), which could be further associated with/mapped to the first entry or the lowest (or the highest) TRP-specific index/ID value in the list of network configured TRP-specific index/ID values such as PCIs, the resource indicator(s) such as SSBRI(s)/CRI(s) reported in the second reporting instance (corresponding to the second CSI-report/CSI reporting setting configured in Option-I/II) corresponds to/is determined/selected from the SSB or NZP CSI-RS resources configured in the second configured CSI resource setting (e.g., with the second lowest CSI-ResourceConfigId), which could be further associated with/mapped to the second entry or the second lowest (or the second highest) TRP-specific index/ID value in the list of network configured TRP-specific index/ID values such as PCIs, and so on, and the resource indicator(s) such as SSBRI(s)/CRI(s) reported in the last (Nh-th) reporting instance (corresponding to the last (Nh-th) CSI-report/CSI reporting setting configured in Option-I/II) corresponds to/is determined/selected from the SSB or NZP CSI-RS resources configured in the last configured CSI resource setting (e.g., with the highest CSI-ResourceConfigId), which could be further associated with/mapped to the last entry or the highest (or the lowest) TRP-specific index/ID value in the list of network configured TRP-specific index/ID values such as PCIs.

Other mapping/association rules between the resource indicators reported in the Nh reporting instances (and therefore, the corresponding beam metrics such as L1-RSRPs/L1-SINRs reported in the Nh reporting instances) and the configured CSI resource settings in Option-1a (and therefore, the corresponding TRPs in the multi-TRP system) are also possible, and they should be known to the UE a prior.

In one example of Mechanism-Ab for Option-1b, the resource indicator(s) such as SSBRI(s)/CRI(s) reported in the k-th reporting instance (corresponding to the k-th CSI-report/CSI reporting setting configured in Option-I/II) corresponds to/is determined/selected from the SSB or NZP CSI-RS resources configured in the k-th configured CSI resource setting (e.g., with the k-th lowest CSI-ResourceConfigId), which could be further associated with/mapped to the k-th entry or the k-th highest/lowest TRP-specific higher layer signaling index value in the list of network configured TRP-specific higher layer signaling index values, where k=1, . . . , Nh. Other mapping/association rules between the resource indicators reported in the Nh reporting instances (and therefore, the corresponding beam metrics such as L1-RSRPs/L1-SINRs reported in the Nh reporting instances) and the configured CSI resource settings in Option-1b (and therefore, the corresponding TRPs in the multi-TRP system) are also possible, and they should be known to the UE a prior.

In one example of Mechanism-Ac for Option-1c, the resource indicator(s) such as SSBRI(s)/CRI(s) reported in the first reporting instance (corresponding to the first CSI-report/CSI reporting setting configured in Option-I/II) corresponds to/is determined/selected from the SSB or NZP CSI-RS resources configured in the CSI resource setting with the lowest CSI-ResourceConfigId, the resource indicator(s) such as SSBRI(s)/CRI(s) reported in the second reporting instance (corresponding to the second CSI-report/CSI reporting setting configured in Option-I/II) corresponds to/is determined/selected from the SSB or NZP CSI-RS resources configured in the CSI resource setting with the second lowest CSI-ResourceConfigId, and so on, and the resource indicator(s) such as SSBRI(s)/CRI(s) reported in the last (Nh-th) reporting instance (corresponding to the last (Nh-th) CSI-report/CSI reporting setting configured in Option-I/II) corresponds to/is determined/selected from the SSB or NZP CSI-RS resources configured in the CSI resource setting with the highest CSI-ResourceConfigId.

Other mapping/association rules between the resource indicators reported in the Nh reporting instances (and therefore, the corresponding beam metrics such as L1-RSRPs/L1-SINRs reported in the Nh reporting instances) and the configured CSI resource settings in Option-1c (and therefore, the corresponding TRPs in the multi-TRP system) are also possible, and they should be known to the UE a prior.

In one example of Mechanism-Ad for Option-1d, the resource indicator(s) such as SSBRI(s)/CRI(s) reported in a different reporting instance (corresponding to a different CSI-report/CSI reporting setting) corresponds to/is determined/selected from one or more SSB or NZP CSI-RS resources configured in a different CSI resource setting. Predefined mapping/association rules between the resource indicators reported in the Nh reporting instances (and therefore, the corresponding beam metrics such as L1-RSRPs/L1-SINRs reported in the Nh reporting instances) and the configured CSI resource settings are not needed here, which is different from Mechanism-Aa, Mechanism-Ab and Mechanism-Ac. This is because the SSB/NZP CSI-RS resources configured in one or more of the CSI resource settings are differently indexed.

In one example of Mechanism-B for Option-2, for the multi-TRP system comprising of at least two TRPs, the UE could report in Nh≥2 reporting instances (corresponding to Nh CSI-report's/CSI reporting settings) one or more resource indicators such as SSBRIs/CRIs (and therefore, their corresponding beam metrics such as L1-RSRPs/L1-SINRs) with at least one (Mh≥1) resource indicator such as SSBRI and/or CRI (and the corresponding beam metric such as L1-RSRP/L1-SINR) per reporting instance. The resource indicator(s) reported in the same reporting instance (corresponding to the same CSI-report/CSI reporting setting) could be determined/selected from/associated with one or more SSB or NZP CSI-RS resources configured in the same CSI-RS resource set in the CSI resource setting; different resource indicators reported in different reporting instances (corresponding to different CSI-report's/CSI reporting setting) could be determined/selected from/associated with one or more SSB or NZP CSI-RS resources configured in different CSI-RS resource sets in the CSI resource setting. The UE could also report in Nh reporting instances the beam metrics such as L1-RSRPs/L1-SINRs corresponding to the reported resource indicators such as SSBRIs/CRIs.

In this case, the UE is expected to simultaneously receive the beams/resources corresponding to the resource indicators such as SSBRIs/CRIs reported in separate associated reporting instances (corresponding to separate associated CSI-report's/CSI reporting settings) using either a single RX spatial filter/panel or multiple RX spatial filters/panels; the UE, however, is not expected to simultaneously receive the beams/resources corresponding to the resource indicators such as SSBRIs/CRIs reported in the same reporting instance (corresponding to the same CSI-report/CSI reporting setting) using either a single RX spatial filter/panel or multiple RX spatial filters/panels.

In one example of Mechanism-Ba for Option-2a, in one example (Nh=2), the resource indicator(s) such as SSBRI(s)/CRI(s) reported in the first reporting instance (corresponding to the first CSI-report/CSI reporting setting configured in Option-I/II) corresponds to/is determined/selected from the SSB or NZP CSI-RS resources configured in the first configured CSI-RS resource set, e.g., the first entry in the higher layer parameter csi-SSB-ResourceSetList/nzp-CSI-RS-ResourceSetList or provided by the higher layer parameter CSI-SSB-ResourceSet1/NZP-CSI-RS-ResourceSet1, or the configured CSI-RS resource set with a smaller resource set ID (e.g., provided by SSB-ResourceSetId/NZP-CSI-RS-ResourceSetId in SSB-ResourceSet1/NZP-CSI-RS-ResourceSet1), which could be further mapped to/associated with value 0 of CORESETPoolIndex, and the resource indicator(s) such as SSBRI(s)/CRI(s) reported in the second reporting instance (corresponding to the second CSI-report/CSI reporting setting configured in Option-I/II) corresponds to/is determined from the SSB or NZP CSI-RS resources configured in the second configured CSI-RS resource set, e.g., the second entry in the higher layer parameter csi-SSB-ResourceSetList/nzp-CSI-RS-ResourceSetList or provided by the higher layer parameter CSI-SSB-ResourceSet2/NZP-CSI-RS-ResourceSet2, or the configured CSI-RS resource set with a higher resource set ID (e.g., provided by SSB-ResourceSetId/NZP-CSI-RS-ResourceSetId in SSB-ResourceSet2/NZP-CSI-RS-ResourceSet2), which could be further mapped to/associated with value 1 of CORESETPoolIndex.

In another example, the resource indicator(s) such as SSBRI(s)/CRI(s) reported in the first reporting instance (corresponding to the first CSI-report/CSI reporting setting configured in Option-I/II) corresponds to/is determined from the SSB or NZP CSI-RS resources configured in the first configured CSI-RS resource set (e.g., the first entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet or with the lowest SSB-ResourceSetId/NZP-CSI-RS-ResourceSetId in the corresponding higher layer parameter CSI-SSB-ResourceSet/NZP-CSI-RS-ResourceSet), which could be further mapped to/associated with the first entry or the lowest (or the highest) TRP-specific index/ID value in the list of network configured TRP-specific index/ID values such as PCIs, the resource indicator(s) such as SSBRI(s)/CRI(s) reported in the second reporting instance (corresponding to the second CSI-report/CSI reporting setting configured in Option-I/II) corresponds to/is determined from the SSB or NZP CSI-RS resources configured in the second configured CSI-RS resource set (e.g., the second entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet or with the second lowest SSB-ResourceSetId/NZP-CSI-RS-ResourceSetId in the corresponding higher layer parameter CSI-SSB-ResourceSet/NZP-CSI-RS-ResourceSet), which could be further mapped to/associated with the second entry or the second lowest (or the second highest) TRP-specific index/ID value in the list of network configured TRP-specific index/ID values such as PCIs, and so on, and the resource indicator(s) such as SSBRI(s)/CRI(s) reported in the last (Nh-th) reporting instance (corresponding to the last (Nh-th) CSI-report/CSI reporting setting configured in Option-I/II) corresponds to/is determined/selected from the SSB or NZP CSI-RS resources configured in the last configured CSI-RS resource set (e.g., the last entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet or with the highest SSB-ResourceSetId/NZP-CSI-RS-ResourceSetId in the corresponding higher layer parameter CSI-SSB-ResourceSet/NZP-CSI-RS-ResourceSet), which could be further mapped to/associated with the last entry or the highest (or the lowest) TRP-specific index/ID value in the list of network configured TRP-specific index/ID values such as PCIs. Other mapping/association rules between the resource indicators reported in the Nh reporting instances (and therefore, the corresponding beam metrics such as L1-RSRPs/L1-SINRs reported in the Nh reporting instances) and the configured CSI-RS resource sets in the same CSI resource setting in Option-2a (and therefore, the corresponding TRPs in the multi-TRP system) are also possible, and they should be known to the UE a prior.

In one example of Mechanism-Bb for Option-2b, the resource indicator(s) such as SSBRI(s)/CRI(s) reported in the k-th reporting instance (corresponding to the k-th CSI-report/CSI reporting setting configured in Option-I/II) corresponds to/is determined from the SSB or NZP CSI-RS resources configured in the k-th configured CSI-RS resource set, e.g., the k-th entry in the higher layer parameter csi-SSB-ResourceSetList/nzp-CSI-RS-ResourceSetList or provided by the corresponding higher layer parameter CSI-SSB-ResourceSet/NZP-CSI-RS-ResourceSet, or the configured CSI-RS resource set with the k-th lowest resource set ID value (e.g., provided by NZP-CSI-RS-ResourceSetId/SSB-ResourceSetId in the corresponding CSI-SSB-ResourceSet/NZP-CSI-RS-ResourceSet), which could be further associated with/mapped to the k-th entry or the k-th highest/lowest TRP-specific higher layer signaling index value in the list of network configured TRP-specific higher layer signaling indexes, where k=1, . . . , Nh.

Other mapping/association rules between the resource indicators reported in the Nh reporting instances (and therefore, the corresponding beam metrics such as L1-RSRPs/L1-SINRs reported in the Nh reporting instances) and the configured CSI-RS resource sets in the same CSI resource setting in Option-2b (and therefore, the corresponding TRPs in the multi-TRP system) are also possible, and they should be known to the UE a prior.

In one example of Mechanism-Bc for Option-2c, in one example, the resource indicator(s) such as SSBRI(s)/CRI(s) reported in the first reporting instance (corresponding to the first CSI-report/CSI reporting setting configured in Option-I/II) corresponds to/is determined from the SSB or NZP CSI-RS resources configured in the CSI-RS resource set with the lowest NZP-CSI-RS-ResourceSetId/SSB-ResourceSetId, the resource indicator(s) such as SSBRI(s)/CRI(s) reported in the second reporting instance (corresponding to the second CSI-report/CSI reporting setting configured in Option-I/II) corresponds to/is determined from the SSB or NZP CSI-RS resources configured in the CSI-RS resource set with the second lowest NZP-CSI-RS-ResourceSetId/SSB-ResourceSetId, and so on, and the resource indicator(s) such as SSBRI(s)/CRI(s) reported in the last (Nh-th) reporting instance (corresponding to the last (Nh-th) CSI-report/CSI reporting setting configured in Option-I/II) corresponds to/is determined from the SSB or NZP CSI-RS resources configured in the CSI-RS resource set with the highest NZP-CSI-RS-ResourceSetId/SSB-ResourceSetId.

Other mapping/association rules between the resource indicators reported in the Nh reporting instances (and therefore, the corresponding beam metrics such as L1-RSRPs/L1-SINRs reported in the Nh reporting instances) and the configured CSI-RS resource sets in the same CSI resource setting in Option-2c (and therefore, the corresponding TRPs in the multi-TRP system) are also possible, and they should be known to the UE a prior.

In one example of Mechanism-Bd for Option-2d, the resource indicator(s) such as SSBRI(s)/CRI(s) reported in a different reporting instance (corresponding to a different CSI-report/CSI reporting setting) corresponds to/is determined/selected from one or more SSB or NZP CSI-RS resources configured in a different CSI-RS resource set. Predefined mapping/association rules between the resource indicators reported in the Nh reporting instances (and therefore, the corresponding beam metrics such as L1-RSRPs/L1-SINRs reported in the Nh reporting instances) and the configured CSI-RS resource sets are not needed here, which is different from Mechanism-Ba, Mechanism-Bb and Mechanism-Bc. This is because the SSB/NZP CSI-RS resources configured in one or more of the CSI-RS resource sets are differently indexed.

In one example of Mechanism-C for Option-3, for the multi-TRP system comprising of at least two TRPs, the UE could report in Nh≥2 reporting instances (corresponding to Nh CSI-report's/CSI reporting settings) one or more resource indicators such as SSBRIs/CRIs (and therefore, their corresponding beam metrics such as L1-RSRPs/L1-SINRs) with at least one (Mh≥1) resource indicator such as SSBRI and/or CRI (and the corresponding beam metric such as L1-RSRP/L1-SINR) per reporting instance. The resource indicator(s) reported in the same reporting instance (corresponding to the same CSI-report/CSI reporting setting) could be determined/selected from/associated with one or more SSB or NZP CSI-RS resources configured in the same CSI-RS resource subset configured in the CSI-RS resource set; different resource indicators reported in different reporting instances (corresponding to different CSI-report's/CSI reporting settings) could be determined/selected from/associated with one or more SSB or NZP CSI-RS resources configured in different CSI-RS resource subsets configured in the CSI-RS resource set. The UE could also report in Nh reporting instances the beam metrics such as L1-RSRPs/L1-SINRs corresponding to the reported resource indicators such as SSBRIs/CRIs.

In this case, the UE is expected to simultaneously receive the beams/resources corresponding to the resource indicators such as SSBRIs/CRIs reported in separate associated reporting instances (corresponding to separate associated CSI-report's/CSI reporting settings) using either a single RX spatial filter/panel or multiple RX spatial filters/panels; the UE, however, is not expected to simultaneously receive the beams/resources corresponding to the resource indicators such as SSBRIs/CRIs reported in the same reporting instance (corresponding to the same CSI-report/CSI reporting setting) using either a single RX spatial filter/panel or multiple RX spatial filters/panels.

In one example of Mechanism-Ca for Option-3a, in one example (Nh=2), the resource indicator(s) such as SSBRI(s)/CRI(s) reported in the first reporting instance (corresponding to the first CSI-report/CSI reporting setting configured in Option-I/II) corresponds to/is determined/selected from the SSB or NZP CSI-RS resources configured in the first CSI-RS resource subset (e.g., containing the first half of the SSB/NZP CSI-RS resources in the corresponding CSI-RS resource set), e.g., the first entry in the higher layer parameter csi-SSB-ResourceSubSetList/nzp-CSI-RS-ResourceSubSetList or provided by the higher layer parameter CSI-SSB-ResourceSubSet1/NZP-CSI-RS-ResourceSubSet1, or the configured CSI-RS resource subset with a smaller resource subset ID (e.g., provided by SSB-ResourceSubSetId/NZP-CSI-RS-ResourceSubSetId in CSI-SSB-ResourceSubSet1/NZP-CSI-RS-ResourceSubSet1), which could be further mapped to/associated with value 0 of CORESETPoolIndex, and the resource indicator(s) such as SSBRI(s)/CRI(s) reported in the second reporting instance (corresponding to the second CSI-report/CSI reporting setting configured in Option-I/II) corresponds to/is determined/selected from the SSB or NZP CSI-RS resources configured in the second CSI-RS resource subset (e.g., containing the second half of the SSB/NZP CSI-RS resources in the corresponding CSI-RS resource set), e.g., the second entry in the higher layer parameter csi-SSB-ResourceSubSetList/nzp-CSI-RS-ResourceSubSetList or provided by the higher layer parameter CSI-SSB-ResourceSubSet2/NZP-CSI-RS-ResourceSubSet2, or the configured CSI-RS resource subset with a higher resource subset ID (e.g., provided by SSB-ResourceSubSetId/NZP-CSI-RS-ResourceSubSetId in CSI-SSB-ResourceSubSet2/NZP-CSI-RS-ResourceSubSet2), which could be further mapped to/associated with value 1 of CORESETPoolIndex.

In another example, the resource indicator(s) such as SSBRI(s)/CRI(s) reported in the first reporting instance (corresponding to the first CSI-report/CSI reporting setting configured in Option-I/II) corresponds to/is determined from the SSB or NZP CSI-RS resources configured in the first configured CSI-RS resource subset (e.g., containing the k₁ SSB/NZP CSI-RS resources in the corresponding CSI-RS resource set), e.g., the first entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the first entry or the lowest (or the highest) TRP-specific index/ID value in the list of network configured TRP-specific index/ID values such as PCIs, the resource indicator(s) such as SSBRI(s)/CRI(s) reported in the second reporting instance (corresponding to the second CSI-report/CSI reporting setting configured in Option-I/II) corresponds to/is determined/selected from the SSB or NZP CSI-RS resources configured in the second configured CSI-RS resource subset (e.g., containing the k₂ SSB/NZP CSI-RS resources in the corresponding CSI-RS resource set), e.g., the second entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the second lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the second entry or the second lowest (or the second highest) TRP-specific index/ID value in the list of network configured TRP-specific index/ID values such as PCIs, and so on, and the resource indicator(s) such as SSBRI(s)/CRI(s) reported in the last (Nh-th) reporting instance (corresponding to the last (Nh-th) CSI-report/CSI reporting setting configured in Option-I/II) corresponds to/is determined/selected from the SSB or NZP CSI-RS resources configured in the last configured CSI-RS resource subset (e.g., containing the k_{Ms} SSB/NZP CSI-RS resources in the corresponding CSI-RS resource set), e.g., the last entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the highest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the last entry or the highest (or the lowest) TRP-specific index/ID value in the list of network configured TRP-specific index/ID values such as PCIs.

Other mapping/association rules between the resource indicators reported in the Nh reporting instances (and therefore, the corresponding beam metrics such as L1-RSRPs/L1-SINRs reported in the Nh reporting instances) and the configured CSI-RS resource subsets in the same CSI-RS resource set in Option-3a (and therefore, the corresponding TRPs in the multi-TRP system) are also possible, and they should be known to the UE a prior.

In one example of Mechanism-Cb for Option-3b, the resource indicator(s) such as SSBRI(s)/CRI(s) reported in the k-th reporting instance (corresponding to the k-th CSI-report/CSI reporting setting configured in Option-I/II) corresponds to/is determined/selected from the SSB or NZP CSI-RS resources configured in the k-th configured CSI-RS resource subset, e.g., the k-th entry in the higher layer parameter csi-SSB-ResourceSubSetList/nzp-CSI-RS-ResourceSubSetList or provided by the corresponding higher layer parameter CSI-SSB-ResourceSubSet/NZP-CSI-RS-ResourceSubSet, or the configured CSI-RS resource subset with the k-th lowest resource subset ID (e.g., provided by SSB-ResourceSubSetId/NZP-CSI-RS-ResourceSubSetId in the corresponding CSI-SSB-ResourceSubSet/NZP-CSI-RS-ResourceSubSet), which could be further mapped to/associated with the k-th entry or the k-th highest/lowest TRP-specific higher layer signaling index value in the list of network configured TRP-specific higher layer signaling indexes.

Other mapping/association rules between the resource indicators reported in the Nh reporting instances (and therefore, the beam metrics such as L1-RSRPs/L1-SINRs reported in the Nh reporting instances) and the configured CSI-RS resource subsets in the same CSI-RS resource set in Option-3b (and therefore, the corresponding TRPs in the multi-TRP system) are also possible, and they should be known to the UE a prior.

In one example of Mechanism-Cc for Option-3c, the resource indicator(s) such as SSBRI(s)/CRI(s) reported in a different reporting instance (corresponding to a different CSI-report/CSI reporting setting) corresponds to/is determined/selected from one or more SSB or NZP CSI-RS resources configured in a different CSI-RS resource subset. Predefined mapping/association rules between the resource indicators reported in the Nh reporting instances (and therefore, the corresponding beam metrics such as L1-RSRPs/L1-SINRs reported in the Nh reporting instances) and the configured CSI-RS resource subsets are not needed here, which is different from Mechanism-Ca and Mechanism-Cb.

In one example of Mechanism-D for Option-1, for the multi-TRP system comprising of at least two TRPs, the UE could report in Nh≥2 reporting instances (corresponding to Nh CSI-report's/CSI reporting settings) one or more resource indicators such as SSBRIs/CRIs (and therefore, their corresponding beam metrics such as L1-RSRPs/L1-SINRs) with at least one (Mh≥1) resource indicator such as SSBRI and/or CRI (and the corresponding beam metric such as L1-RSRP/L1-SINR) per reporting instance. The resource indicator(s) reported in the same reporting instance (corresponding to the same CSI-report/CSI reporting setting) could be determined/selected from/associated with one or more SSB or NZP CSI-RS resources configured in the same CSI resource setting; different resource indicators reported in different reporting instances (corresponding to different CSI-report's/CSI reporting settings) could be determined/selected from/associated with one or more SSB or NZP CSI-RS resources configured in different CSI resource settings. The UE could also report in Nh reporting instances the beam metrics such as L1-RSRPs/L1-SINRs corresponding to the reported resource indicators such as SSBRIs/CRIs.

In this case, the UE is expected to simultaneously receive the beams/resources corresponding to the resource indicators such as SSBRIs/CRIs reported in separate associated reporting instances (corresponding to separate associated CSI-report's/CSI reporting settings) using either a single RX spatial filter/panel or multiple RX spatial filters/panels; furthermore, the UE is also expected to simultaneously receive the beams/resources corresponding to the resource indicators such as SSBRIs/CRIs reported in the same reporting instance (corresponding to the same CSI-report/CSI reporting setting) using either a single RX spatial filter/panel or multiple RX spatial filters/panels. The mapping/association between the resource indicators reported in the Nh reporting instances (and therefore, the corresponding beam metrics such as L1-RSRPs/L1-SINRs reported in the Nh reporting instances) and the configured CSI resource settings (and therefore, the corresponding TRPs in the multi-TRP system) could follow those discussed in Mechanism-Aa, Mechanism-Ab, Mechanism-Ac and Mechanism-Ad.

In one example of Mechanism-E for Option-2, for the multi-TRP system comprising of at least two TRPs, the UE could report in Nh≥2 reporting instances one or more resource indicators such as SSBRIs/CRIs (and therefore, their corresponding beam metrics such as L1-RSRPs/L1-SINRs) with at least one (Mh≥1) resource indicator such as SSBRI and/or CRI (and the corresponding beam metric such as L1-RSRP/L1-SINR) per reporting instance. The resource indicator(s) reported in the same reporting instance (corresponding to the same CSI-report/CSI reporting setting) could be determined/selected from/associated with one or more SSB or NZP CSI-RS resources configured in the same CSI-RS resource set in the CSI resource setting; different resource indicators reported in different reporting instances (corresponding to different CSI-report's/CSI reporting settings) could be determined/selected from/associated with one or more SSB or NZP CSI-RS resources configured in different CSI-RS resource sets in the CSI resource setting. The UE could also report in Nh reporting instances the beam metrics such as L1-RSRPs/L1-SINRs corresponding to the reported resource indicators such as SSBRIs/CRIs.

In this case, the UE is expected to simultaneously receive the beams/resources corresponding to the resource indicators such as SSBRIs/CRIs reported in separate associated reporting instances (corresponding to separate associated CSI-report's/CSI reporting settings) using either a single RX spatial filter/panel or multiple RX spatial filters/panels; furthermore, the UE is also expected to simultaneously receive the beams/resources corresponding to the resource indicators such as SSBRIs/CRIs reported in the same reporting instance (corresponding to the same CSI-report/CSI reporting setting) using either a single RX spatial filter/panel or multiple RX spatial filters/panels. The mapping/association between the resource indicators reported in the Nh reporting instances (and therefore, the corresponding beam metrics such as L1-RSRPs/L1-SINRs reported in the Nh reporting instances) and the configured CSI-RS resource sets in the same CSI resource setting (and therefore, the corresponding TRPs in the multi-TRP system) could follow those discussed in Mechanism-B a, Mechanism-Bb, Mechanism-Bc and Mechanism-Bd.

In one example of Mechanism-F for Option-3, for the multi-TRP system comprising of at least two TRPs, the UE could report in Nh≥2 reporting instances one or more resource indicators such as SSBRIs/CRIs (and therefore, their corresponding beam metrics such as L1-RSRPs/L1-SINRs) with at least one (Mh≥1) resource indicator such as SSBRI and/or CRI (and the corresponding beam metric such as L1-RSRP/L1-SINR) per reporting instance. The resource indicator(s) reported in the same reporting instance (corresponding to the same CSI-report/CSI reporting setting) could be determined/selected from/associated with one or more SSB or NZP CSI-RS resources configured in the same CSI-RS resource subset configured in the CSI-RS resource set; different resource indicators reported in different reporting instances (corresponding to different CSI-report's/CSI reporting settings) could be determined/selected from/associated with one or more SSB or NZP CSI-RS resources configured in different CSI-RS resource subsets configured in the CSI-RS resource set. The UE could also report in Nh reporting instances the beam metrics such as L1-RSRPs/L1-SINRs corresponding to the reported resource indicators such as SSBRIs/CRIs.

In this case, the UE is expected to simultaneously receive the beams/resources corresponding to the resource indicators such as SSBRIs/CRIs reported in separate associated reporting instances (corresponding to separate associated CSI-report's/CSI reporting settings) using either a single RX spatial filter/panel or multiple RX spatial filters/panels; further, the UE is also expected to simultaneously receive the beams/resources corresponding to the resource indicators such as SSBRIs/CRIs reported in the same reporting instance (corresponding to the same CSI-report/CSI reporting setting) using either a single RX spatial filter/panel or multiple RX spatial filters/panel. The mapping/association between the resource indicators reported in the Nh reporting instances (and therefore, the corresponding beam metrics such as L1-RSRPs/L1-SINRs reported in the Nh reporting instances) and the configured CSI-RS resource subsets in the same CSI-RS resource set (and therefore, the corresponding TRPs in the multi-TRP system) could follow those discussed in Mechanism-Ca, Mechanism-Cb and Mechanism-Cc.

The UE could indicate to the network whether/how separate reporting instances are associated (referred to separate associated reporting instances above). In one example, the UE could indicate to the network that two or more CSI reporting settings are associated. In this case, the reporting instances are associated with each other if they are configured in the CSI reporting settings that are associated with each other. The UE could indicate to the network the association/mapping relationship between different CSI reporting settings.

Alternatively, the UE could report a reporting ID along with the CSI/beam report(s) for each CSI reporting setting (e.g., by incorporating the reporting ID in each reporting instance configured in the corresponding CSI reporting setting). The CSI reporting settings (and therefore, the reporting instances configured therein) are associated if they have the same reporting ID. In another example, the UE could indicate to the network the association/mapping relationship between different reporting instances. Alternatively, the UE could report a reporting ID in a reporting instance along with the CSI/beam report(s). The reporting instances having the same reporting ID are associated.

In another example, the UE could indicate to the network the association/mapping relationship between different reporting instances. Alternatively, the UE could report a reporting ID in a reporting instance along with the CSI/beam report(s). The reporting instances having the same reporting ID are associated.

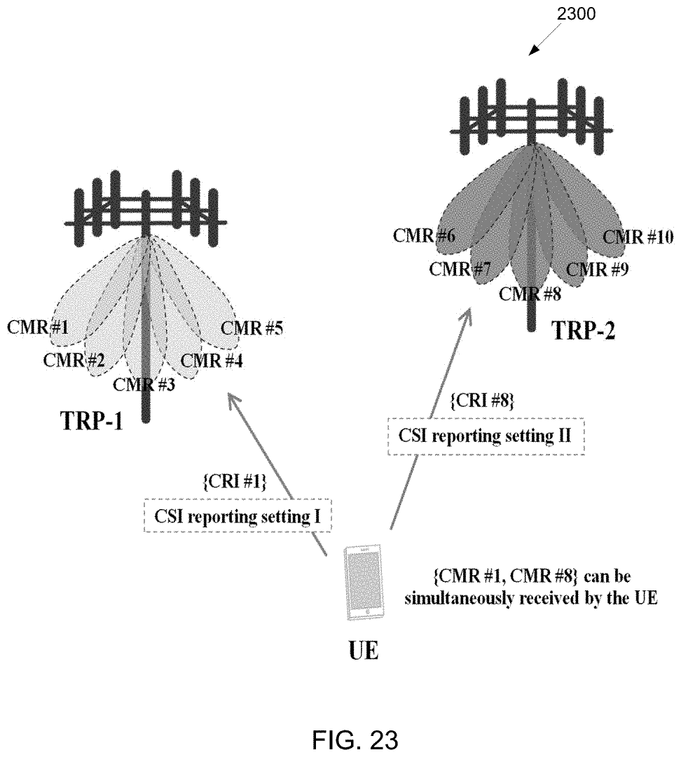

FIG. 23 illustrates another example beam measurement and reporting 2300 according to embodiments of the present disclosure. An embodiment of the beam measurement and reporting 2300 shown in FIG. 23 is for illustration only.

In FIG. 23, an example of non-group based beam reporting for a multi-TRP system comprising of two coordinating TRPs, TRP-1 and TRP-2, is presented. In this example, Nh=2 and Mh=1, i.e., the UE reports in two reporting instances (corresponding to two CSI-report's/CSI reporting settings) a total of two resource indicators with one resource indicator per reporting instance. In this example, the UE is configured by the network two CSI reporting settings, CSI reporting setting I and CSI reporting setting II, associated with TRP-1 and TRP-2, respectively, following the configuration(s) specified in Option-II in the present disclosure.

As the UE could simultaneously receive CMR #1 from TRP-1 and CMR #8 from TRP-2 using either a single RX spatial filter/panel or multiple RX spatial filters/panels, the UE would report CRI #1 to TRP-1 according to CSI reporting setting I, and CRI #8 to TRP-2 according to CSI reporting setting II. The UE could indicate to the network that CSI reporting I and CSI reporting II (and therefore, the reporting instances configured therein) are associated. Alternatively, the UE could directly indicate to the network that the two reporting instances are associated.

The UE could be configured by the network to perform the non-group based beam reporting for the multi-TRP operation. For instance, a new field, nongroupBasedBeamReporting-mTRP could be configured/incorporated in CSI-ReportConfig to turn on/off the above discussed non-group based beam reporting format(s) (Mechanism-A to Mechanism-F in the present disclosure). If groupBasedBeamReporting and groupBasedBeamReporting-mTRP/groupBasedBeamReportingR17 are disabled or not configured while nongroupBasedBeamReporting-mTRP is set to ‘enabled’, the UE would perform the non-group based beam reporting following those specified in Mechanism-A, Mechanism-B, Mechanism-C, Mechanism-D, Mechanism-E or Mechanism-F in the present disclosure.

Furthermore, the UE could choose among Mechanism-A to Mechanism-F to report the SSBRIs/CRIs (and also, the corresponding beam metrics). To avoid any ambiguities between the UE and the network sides, the UE should indicate to the network their selected non-group based beam reporting mechanism(s)/format(s). Alternatively, the UE could be indicated/configured by the network one or more of the non-group based beam reporting mechanism(s)/format(s). This indication could be via higher layer (RRC) or/and MAC CE or/and DCI based signaling or/and any combination of at least two of RRC, MAC CE and DCI based signaling; this indication could be via a separate (dedicated) parameter or joint with another parameter.

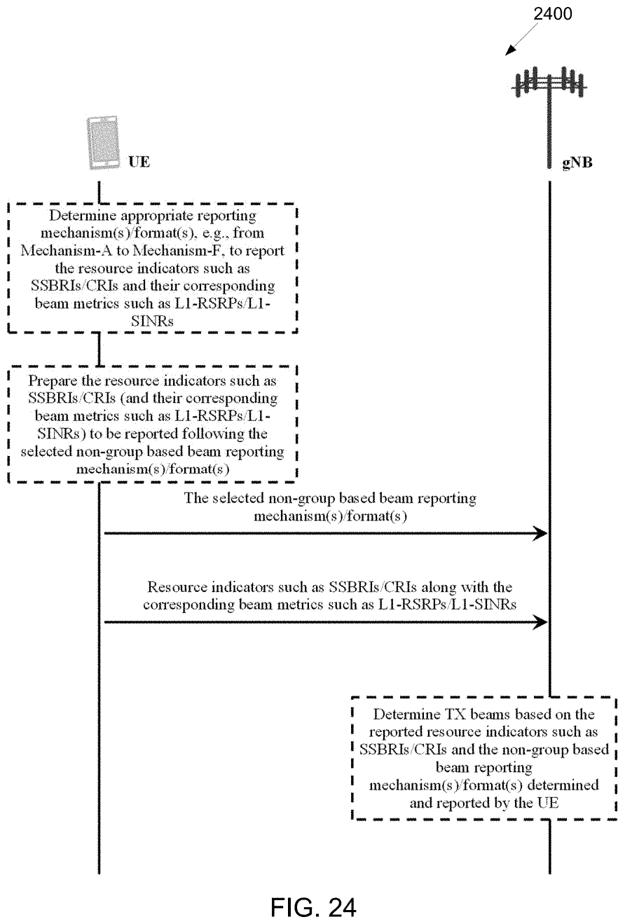

FIG. 24 illustrates a signaling flow 2400 between a UE and gNB for indicating one or more beam reporting formats according to embodiments of the present disclosure. The signaling flow 2400 as may be performed by a UE (e.g., 111-116 as illustrated in FIG. 1) and a base station (e.g., 101-103 as illustrated in FIG. 1) An embodiment of the signaling flow 2400 shown in FIG. 24 is for illustration only. One or more of the components illustrated in FIG. 24 can be implemented in specialized circuitry configured to perform the noted functions or one or more of the components can be implemented by one or more processors executing instructions to perform the noted functions.

In FIG. 24, the UE initiated non-group based beam reporting mechanism(s)/format(s) selection/indication is presented. As illustrated in FIG. 24, the UE initiated non-group based beam reporting mechanism(s)/format(s) selection/indication is presented. The UE determines appropriate reporting mechanism(s)/format(s), e.g., from Mechanism-A to Mechanism-F, to report the resource indicators such as SSBRIs/CRIs and their corresponding beam metrics such as L1-RSRPs/L1-SINRs. The UE then prepares the resource indicators such as SSBRIs/CRIs (and their corresponding beam metrics such as L1-RSRPs/L1-SINRs) to be reported following the selected non-group based beam reporting mechanism(s)/format(s). The UE signals the selected non-group based beam reporting mechanism(s)/format(s) and resource indicators, such as SSBRIs/CRIs, along with the corresponding beam metrics, such as L1-RSRPs/L1-SINRs, to the gNB. The gNB determines TX beams based on the reported resource indicators such as SSBRIs/CRIs and the non-group based beam reporting mechanism(s)/format(s) determined and reported by the UE.

For illustrative purposes the steps of this algorithm are described serially, however, some of these steps may be performed in parallel to each other.

The above flowcharts and signaling flow diagrams illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a parameter indicating whether to report a group of two resource indicators in a same reporting instance;
receive a first set of reference signals (RSs) through a first set of RS resources for determining a first of the two resource indicators; and
receive a second set of RSs through a second set of RS resources for determining a second of the two resource indicators; and
a processor operably coupled to the transceiver, the processor configured to:
measure at least one RS in the first and second sets of RSs; and
determine, based on the measured at least one RS in the first and second sets of RSs, the first and second resource indicators, respectively,
wherein the transceiver is further configured to transmit, in the same reporting instance, the group of two resource indicators including the determined first and second resource indicators,
wherein the first and second sets of RSs are a synchronization signal blocks (SSBs) or non-zero power channel state information RSs (NZP CSI-RSs), and
wherein the first and second resource indicators are SSB resource indicators (SSBRIs) or CSI-RS resource indicators (CRIs).

2. The UE of claim 1, wherein:
the first and second sets of RS resources are configured via a same CSI resource setting; and
the first and second sets of RS resources are indexed according to at least one of:
number of RS resources in the first set,
number of RS resources in the second set, and
total number of RS resources in the first and second sets.

3. The UE of claim 1, wherein the transceiver is further configured to receive:
a third set of reference signals (RSs) through a third set of RS resources configured in a CSI-RS resource set; and
a fourth set of reference signals (RSs) through a fourth set of RS resources configured in the CSI-RS resource set.

4. The UE of claim 3, wherein:
a quantity k₀ of RS resources in the CSI-RS resource set are configured as the third set of RS resources; and
a quantity k₁ of RS resources in the CSI-RS resource set are configured as the fourth set of RS resources.

5. The UE of claim 3, wherein:
the processor is further configured to:
measure the third and fourth sets of RSs; and
determine, based on the measured third and fourth sets of RSs, a first CSI report and a second CSI report, respectively;
the transceiver is further configured to transmit the first and second CSI reports;
the first and second CSI reports include at least one of: a rank indicator (RI), a CRI, a layer indicator (LI), a precoding matrix indicator (PMI), a channel quality indicator (CQI), a layer 1 RS received power (L1-RSRP), and a layer 1 signal to interference plus noise ratio (L1-SINR).

6. The UE of claim 1, wherein:
the transceiver is further configured to receive an indication of a reception hypothesis for determining the group of two resource indicators, and
the reception hypothesis corresponds to one of:
simultaneously measuring the first and second sets of RSs with a same receive spatial filter; or
simultaneously measuring the first and second sets of RSs with a first receive spatial filter and a second spatial receive filter, respectively.

7. The UE of claim 1, wherein:
the transceiver is further configured to receive information indicating a list of groups of two RS resources, the two RS resources in the groups being from the first and second sets of RS resources, respectively; and
the processor is further configured to identify, based on the information, the list of groups of two RS resources.

8. The UE of claim 7, wherein:
the transceiver is further configured to receive a medium access control control element (MAC CE) activation command or a bitmap to indicate one or more candidate groups of two RS resources from the list of groups of two RS resources; and
to measure the at least one RS in the first and second sets of RSs and determine the first and second resource indicators, the processor is configured to:
measure RSs received through the one or more candidate groups of two RS resources, respectively; and
determine, based on the measured RSs, the first and second resource indicators, the determined first and second resource indicators associated with one of the one or more candidate groups of two RS resources.

9. A base station (BS), comprising:
a transceiver configured to:
transmit a parameter indicating whether to report a group of two resource indicators in a same reporting instance;
transmit:
a first set of reference signals (RSs) through a first set of RS resources for determination of a first of the two resource indicators; or
a second set of RSs through a second set of RS resources for determination of a second of the two resource indicators; and
receive, in the same reporting instance, the group of two resource indicators including the first and second resource indicators,
wherein the first and second sets of RSs are a synchronization signal blocks (SSBs) or non-zero power channel state information RSs (NZP CSI-RSs), and
wherein the first and second resource indicators are SSB resource indicators (SSBRIs) or CSI-RS resource indicators (CRIs).

10. The BS of claim 9, wherein:
the first and second sets of RS resources are configured via a same CSI resource setting; and
the first and second sets of RS resources are indexed according to at least one of:
number of RS resources in the first set,
number of RS resources in the second set, and
total number of RS resources in the first and second sets.

11. The BS of claim 9, wherein the transceiver is further configured to transmit:
a third set of reference signals (RSs) through a third set of RS resources configured in a CSI-RS resource set; or
a fourth set of reference signals (RSs) through a fourth set of RS resources configured in the CSI-RS resource set,
wherein a quantity k₀ of RS resources in the CSI-RS resource set are configured as the third set of RS resources, and
wherein a quantity k₁ of RS resources in the CSI-RS resource set are configured as the fourth set of RS resources.

12. The BS of claim 9, wherein the transceiver is further configured to transmit:
information indicating a list of groups of two RS resources, the two RS resources in the groups being from the first and second sets of RS resources, respectively; and
a medium access control control element (MAC CE) activation command or a bitmap to indicate one or more candidate groups of two RS resources from the list of groups of two RS resources from which to determine the first and second resource indicators.

13. A method for operating a user equipment (UE), the method comprising:
receiving a parameter indicating whether to report a group of two resource indicators in a same reporting instance;
receiving a first set of reference signals (RSs) through a first set of RS resources for determining a first of the two resource indicators;
receiving a second set of RSs through a second set of RS resources for determining a second of the two resource indicators;
measuring at least one RS in the first and second sets of RSs;
determining, based on the measured at least one RS in the first and second sets of RSs, the first and second resource indicators, respectively; and
transmitting, in the same reporting instance, the group of two resource indicators including the determined first and second resource indicators,
wherein the first and second sets of RSs are a synchronization signal blocks (SSBs) or non-zero power channel state information RSs (NZP CSI-RSs), and
wherein the first and second resource indicators are SSB resource indicators (SSBRIs) or CSI-RS resource indicators (CRIs).

14. The method of claim 13, wherein:
the first and second sets of RS resources are configured via a same CSI resource setting; and
the first and second sets of RS resources are indexed according to at least one of:
number of RS resources in the first set,
number of RS resources in the second set, and
total number of RS resources in the first and second sets.

15. The method of claim 13, further comprising:
receiving a third set of reference signals (RSs) through a third set of RS resources configured in a CSI-RS resource set; and
receiving a fourth set of reference signals (RSs) through a fourth set of RS resources configured in the CSI-RS resource set.

16. The method of claim 15, wherein:
a quantity k₀ of RS resources in the CSI-RS resource set are configured as the third set of RS resources; and
a quantity k₁ of RS resources in the CSI-RS resource set are configured as the fourth set of RS resources.

17. The method of claim 15, further comprising:
measuring the third and fourth sets of RSs;
determining, based on the measured third and fourth sets of RSs, a first CSI report and a second CSI report, respectively; and
transmitting the first and second CSI reports,
wherein the first and second CSI reports include at least one of: a rank indicator (RI), a CRI, a layer indicator (LI), a precoding matrix indicator (PMI), a channel quality indicator (CQI), a layer 1 RS received power (L1-RSRP), and a layer 1 signal to interference plus noise ratio (L1-SINR).

18. The method of claim 13, further comprising:
receiving an indication of a reception hypothesis for determining the group of two resource indicators,
wherein the reception hypothesis corresponds to one of:
simultaneously measuring the first and second sets of RSs with a same receive spatial filter; or
simultaneously measuring the first and second sets of RSs with a first receive spatial filter and a second spatial receive filter, respectively.

19. The method of claim 13, further comprising:
receiving information indicating a list of groups of two RS resources, the two RS resources in the groups being from the first and second sets of RS resources, respectively; and
identifying, based on the information, the list of groups of two RS resources.

20. The method of claim 19, further comprising:
receiving a medium access control control element (MAC CE) activation command or a bitmap to indicate one or more candidate groups of two RS resources from the list of groups of two RS resources,
wherein measuring the at least one RS in the first and second sets of RSs and determining the first and second resource indicators further comprises:
measuring RSs received through the one or more candidate groups of two RS resources, respectively; and
determining, based on the measured RSs, the first and second resource indicators, the determined first and second resource indicators associated with one of the one or more candidate groups of two RS resources.
